(19) United States
(12) Patent Application Publication
(10) Pub. No.: US 2016/0018426 A1
(43) Pub. Date: Jan. 21, 2016

(54) AUTOMATIC ANALYSIS DEVICE

(71) Applicant: SAKAE CO., LTD., Tokyo (JP)

(72) Inventors: Masamichi MORIYA, Fujioka-shi (JP); Yasumasa OGINO, Fujioka-shi (JP); Takafumi OKAWARA, Fujioka-shi (JP); Koichi MATSUMOTO, Fujioka-shi (JP); Shigeo ASAMI, Fujioka-shi (JP); Yuichi SHITARA, Fujioka-shi (JP); Kenta TAKAHASHI, Fujioka-shi (JP)

(73) Assignee: SAKAE CO., LTD., Tokyo (JP)

(21) Appl. No.: 14/803,519

(22) Filed: Jul. 20, 2015

(30) Foreign Application Priority Data
Jul. 21, 2014 (JP) 2014-148392
Jul. 21, 2014 (JP) 2014-148393

(51) Int. Cl. G01N 35/00; G01N 35/10; G01N 35/02

(52) U.S. Cl. CPC G01N 35/00584; G01N 35/021; G01N 35/1002; G01N 35/0092; G01N 2035/00356

(57) ABSTRACT

To efficiently prevent a decrease in measurement accuracy caused by a change in a test cartridge and an environmental temperature, provided is an automatic analysis device. The automatic analysis device includes: a constant-temperature reservoir (6) to be heated by a heating source (6a) so as to keep a liquid temperature at least in the reaction cell (11c) of the test cartridge (10) in the test stage (KT) at a constant environmental temperature set previously; constant-temperature reservoir control means (7) including a temperature detector (7a), for controlling a set temperature of the heating source (6a) of the constant-temperature reservoir (6) so that the set temperature of the heating source (6a) is higher when the internal environmental temperature is lower than a previously-determined threshold value than when the internal environmental temperature is equal to or higher than the threshold value, based on the internal environmental temperature detected by the temperature detector (7a).

### BACKGROUND OF THE INVENTION

1. Field of the Invention

The present invention relates to an automatic analysis device for analyzing a reaction between a specimen such as blood and a reagent, and more particularly, to an improvement of an automatic analysis device useful for an aspect of measuring a test cartridge under a predetermined constant-temperature condition.

2. Description of the Related Art

Hitherto, as the above-mentioned type of automatic analysis device, for example, automatic analysis devices disclosed in Patent Literature 1 (Japanese Patent No. 4863789) and Patent Literature 2 (Japanese Patent No. 4964518) have been known.

In Patent Literature 1 (see “Means for Solving the Problems” and FIG. 1), there is disclosed an automatic analysis device including: cartridge conveyance means for conveying a test cartridge to be tested to a test stage and conveying the tested test cartridge from the test stage; specimen and reagent dispensing means for dispensing, with respect to the test cartridge in the test stage conveyed by the cartridge conveyance means, a specimen and a reagent in the test cartridge to a reaction cell; measurement means for measuring a reaction between the specimen and the reagent in the reaction cell dispensed by the specimen and reagent dispensing means; a constant-temperature reservoir for keeping at least the reaction cell of the test cartridge conveyed to the test stage by the cartridge conveyance means at a predetermined constant environmental temperature; and auxiliary warming means for previously warming at least a part of the cells of the test cartridge at a temperature higher than the constant environmental temperature before the measurement means is operated.

In Patent Literature 2 (see “Means for Solving the Problems” and FIG. 1), there is disclosed an automatic analysis device including: cartridge selecting means including a cartridge receiving portion in which a plurality of test cartridges can be set, for successively selecting and transferring the test cartridges to a test initial position in a set stage; cartridge conveyance means for linearly conveying the test cartridge to be tested, which has been selected and transferred to the test initial position by the cartridge selecting means, to the test stage and linearly conveying the tested test cartridge to the set stage; specimen and reagent dispensing means for dispensing, with respect to the test cartridge in the test stage conveyed by the cartridge conveyance means, a specimen and a reagent in the test cartridge to a reaction cell; and measurement means for measuring a reaction between the specimen and the reagent in the reaction cell dispensed by the specimen and reagent dispensing means.

### SUMMARY OF THE INVENTION

A technical object to be achieved by the present invention is to provide an automatic analysis device capable of effectively preventing a decrease in measurement accuracy caused by a change in a test cartridge and an environmental temperature.

Another technical object to be achieved by the present invention is to provide an automatic analysis device capable of easily addressing maintenance and inspection and a demand for a change of a device element.

According to a first technical feature of the present invention, there is provided an automatic analysis device for automatically analyzing a reaction between a specimen and a reagent, the automatic analysis device including: at least one test cartridge including at least a specimen cell for accommodating the specimen, a reagent cell for accommodating the reagent, and a reaction cell for allowing the specimen and the reagent to react with each other, the specimen cell, the reagent cell, and the reaction cell being arranged linearly; a device housing including a space portion for a set stage, which is previously determined, and a test stage adjacent to the set stage; cartridge holding means arranged on the set stage and including a cartridge receiving portion for holding the at least one test cartridge; cartridge conveyance means arranged on the test stage, for linearly conveying a test cartridge held by the cartridge holding means to the test stage and conveying the test cartridge in a longitudinal direction along an arrangement direction of respective cells of the conveyed test cartridge in the test stage, and meanwhile, linearly conveying the tested test cartridge from the test stage to the set stage, thereby returning the tested test cartridge to the cartridge receiving portion of the cartridge holding means; specimen and reagent dispensing means arranged so as to correspond to a dispensing position set previously in a part of a conveyance path of the test cartridge in the test stage, for dispensing, with respect to the test cartridge in the test stage conveyed by the cartridge conveyance means, the specimen and the reagent in the test cartridge to the reaction cell in a state in which a dispensing target cell of the test cartridge is conveyed to be arranged at the dispensing position; measurement means arranged so as to correspond to a measurement position set previously in a part of the conveyance path of the test cartridge in the test stage, for measuring the reaction between the specimen and the reagent in the reaction cell dispensed by the specimen and reagent dispensing means in a state in which the reaction cell of the test cartridge in the test stage conveyed by the cartridge conveyance means is conveyed to be arranged at the measurement position; a constant-temperature reservoir to be heated by a heating source so as to keep a liquid temperature at least in the reaction cell of the test cartridge in the test stage conveyed by the cartridge conveyance means at a constant environmental temperature set previously; and constant-temperature reservoir control means including a temperature detector capable of detecting an internal environmental temperature of the test stage, for controlling a set temperature of the heating source of the constant-temperature reservoir so that the set temperature of the heating source is higher when the internal environmental temperature is lower than a previously-determined threshold value than when the internal environmental temperature is equal to or higher than the previously-determined threshold value, based on the internal environmental temperature detected by the temperature detector.

According to a second technical feature of the present invention, in the automatic analysis device having the first technical feature, the constant-temperature reservoir control means further variably sets a heating time of the heating source so that the liquid temperature in the reaction cell of the test cartridge at a time of start of measurement by the measurement means is a previously-determined temperature, based on the internal environmental temperature detected by the temperature detector.

According to a third technical feature of the present invention, in the automatic analysis device having the first technical feature, the constant-temperature reservoir includes: a constant-temperature reservoir main body; a heat insulating cover formed of a heat insulating material covering a periphery of the constant-temperature reservoir main body; the heating source arranged between the constant-temperature reservoir main body and the heat insulating cover and arranged in contact with the constant-temperature reservoir main body; and a heat-resistant heat insulating material interposed between the heating source and the heat insulating cover and having a heat insulating effect higher than a heat insulating effect of the heat insulating cover.

According to a forth technical feature of the present invention, in the automatic analysis device having the first technical feature, the constant-temperature reservoir is installed in a state in which a contact surface between a constant-temperature reservoir main body and a member to be mounted is smaller than a projection plane of the constant-temperature reservoir main body onto the member to be mounted.

According to a fifth technical feature of the present invention, in the automatic analysis device having the first technical feature, the constant-temperature reservoir includes a reservoir temperature detector capable of detecting a temperature in the constant-temperature reservoir, and the reservoir temperature detector is arranged between the reaction cell of the test cartridge and the heating source of the constant-temperature reservoir.

According to a sixth technical feature of the present invention, in the automatic analysis device having the first technical feature, the constant-temperature reservoir includes a contact portion that is brought into contact with a bottom surface of the reaction cell of the test cartridge at least at the measurement position.

According to a seventh technical feature of the present invention, in the automatic analysis device having the first technical feature, further including a biasing member for biasing a bottom surface of the reaction cell of the test cartridge so as to press the bottom surface against the constant-temperature reservoir at the measurement position of the constant-temperature reservoir.

According to an eighth technical feature of the present invention, in the automatic analysis device having the first technical feature, further including: a liquid temperature detector arranged on the set stage, the liquid temperature detector being capable of detecting a liquid temperature of one of the reagent and a diluent for the specimen accommodated in the cell of the test cartridge held by the cartridge holding means; an environmental temperature detector arranged on the set stage, the environmental temperature detector being capable of detecting an internal environmental temperature in the set stage; and drive control means for inhibiting, when a detected temperature of the liquid temperature detector is lower than a detected temperature from the environmental temperature detector, a conveyance operation of the test cartridge to the test stage by the cartridge conveyance means until, based on a difference between the detected temperature of the liquid temperature detector and the detected temperature from the environmental temperature detector, the difference between the detected temperatures becomes a previously-determined threshold value or less.

According to a ninth technical feature of the present invention, in the automatic analysis device having the eighth technical feature, the liquid temperature detector includes a thermopile element.

According to a tenth technical feature of the present invention, in the automatic analysis device having the ninth technical feature, the drive control means is used so as to correct the liquid temperature detected by the liquid temperature detector in accordance with the environmental temperature detected by the environmental temperature detector.

According to a eleventh technical feature of the present invention, in the automatic analysis device having the ninth technical feature, the drive control means indirectly corrects the liquid temperature detected by the liquid temperature detector by variably setting the previously-determined threshold value in accordance with the environmental temperature detected by the environmental temperature detector.

According to a twelfth technical feature of the present invention, in the automatic analysis device having the ninth technical feature, the liquid temperature detector is installed at a standby position at which an ambient temperature changes less in the set stage, and the liquid temperature detector is moved by a moving mechanism capable of moving to a detection position close to the cells of the test cartridge when the test cartridge is held by the cartridge holding means.

According to a thirteenth technical feature of the present invention, in the automatic analysis device having the ninth technical feature, the device housing has a configuration capable of introducing external air to a periphery of the liquid temperature detector.

According to a fourteenth technical feature of the present invention, in the automatic analysis device having the eighth technical feature, the cartridge holding means includes the cartridge receiving portion capable of holding the at least one test cartridge, the cartridge holding means moves the cartridge receiving portion in a direction crossing the arrangement direction of the respective cells of the test cartridge, thereby transferring the test cartridge to a previously-determined test initial position in the set stage and transferring the test cartridge, which is to be first subjected to the test of the at least one test cartridge, to a previously-determined liquid temperature detection position in the set stage, and the automatic analysis device further comprises a guide member capable of guiding the test cartridge so as to keep a positional relationship between the liquid temperature detector and the test cartridge when the test cartridge is transferred to the liquid temperature detection position.

According to a fifteenth technical feature of the present invention, in the automatic analysis device having the eighth technical feature, when the detected temperature of the liquid temperature detector is lower than the detected temperature from the environmental temperature detector, under a condition that, based on the difference between the detected temperatures, the difference between the detected temperatures becomes the previously-determined threshold value or less, the drive control means performs the conveyance operation of the test cartridge to the test stage by the cartridge conveyance means after a previously-determined time period has elapsed.

According to a sixteenth technical feature of the present invention, in the automatic analysis device having the first technical feature, the device housing includes a base member extending from the set stage to the test stage, the cartridge holding means is incorporated as a first unit assembly onto the base member of the set stage, and the cartridge conveyance means, the specimen and reagent dispensing means, and the constant-temperature reservoir are mounted on a common unit base member and incorporated as a second unit assembly onto the base member of the test stage.

According to a seventeenth technical feature of the present invention, in the automatic analysis device having the sixteenth technical feature, further including a fan capable of forcibly exhausting air in the set stage and the test stage of the device housing, the device housing including: a hollow portion formed in a lower portion of the base member; an air intake port formed in a part of the hollow portion; and a through hole formed in the base member, the fan being arranged in an upper corner portion on a back surface side of the device housing, the through hole being arranged at a diagonal position of the device housing with respect to the fan.

According to a eighteenth technical feature of the present invention, in the automatic analysis device having the sixteenth technical feature, further including a fan capable of forcibly exhausting air in the set stage and the test stage of the device housing, the device housing including: a hollow portion formed in a lower portion of the base member; an air intake port formed in apart of the hollow portion; and a through hole formed in the base member in which, in accordance with a heat generation amount from a device element in the set stage and the test stage, an opening area is larger in a portion having a large heat generation amount than in a portion having a small heat generation amount.

According to a nineteenth technical feature of the present invention, in the automatic analysis device having the sixteenth technical feature, further including a fan capable of forcibly exhausting air in the set stage and the test stage of the device housing, the device housing including: a hollow portion formed in a lower portion of the base member; an air intake port formed in a part of the hollow portion; and a through hole formed in the base member, at least one of the air intake port or the through hole having a dust removing filter.

According to a twentieth technical feature of the present invention, in the automatic analysis device having the sixteenth technical feature, further including a fan capable of forcibly exhausting air in the set stage and the test stage of the device housing, the device housing including: a hollow portion formed in a lower portion of the base member; an air intake port formed in a part of the hollow portion; a through hole formed in the base member; and a partition member for partitioning an interior space portion in accordance with a heat generation amount from a device element in the set stage and the test stage.

According to the first technical feature of the present invention, the decrease in measurement accuracy caused by the change in the test cartridge and the environmental temperature can be prevented effectively.

According to the second technical feature of the present invention, compared to an aspect not having the configuration of the present invention, a constant-temperature environmental condition of the constant-temperature reservoir can be realized accurately.

According to the third technical feature of the present invention, compared to the aspect not having the configuration of the present invention, the heating efficiency of the heating source of the constant-temperature reservoir can be enhanced.

According to the fourth technical feature of the present invention, compared to the aspect not having the configuration of the present invention, the loss of heat that is thermally conducted from the constant-temperature reservoir to the member to be mounted can be reduced.

According to the fifth technical feature of the present invention, compared to the aspect not having the configuration of the present invention, temperature control of the constant-temperature reservoir can be performed efficiently.

According to the sixth technical feature of the present invention, compared to the aspect not having the configuration of the present invention, a constant-temperature effect on the reaction cell of the test cartridge can be further stabilized.

According to the seventh technical feature of the present invention, compared to the aspect not having the configuration of the present invention, the constant-temperature effect on the reaction cell of the test cartridge can be stabilized, and the measurement position of the reaction cell can be stabilized.

According to the eighth technical feature of the present invention, compared to the aspect not having the configuration of the present invention, the test cartridge can be subjected to test in a state of an appropriate temperature.

According to the ninth technical feature of the present invention, the liquid temperature in the cells of the test cartridge can be detected easily in a non-contact state.

According to the tenth technical feature of the present invention, even when the internal environmental temperature in the set stage changes, the liquid temperature in the cells of the test cartridge can be detected accurately with a thermopile.

According to the eleventh technical feature of the present invention, even when the internal environmental temperature in the set stage changes, the liquid temperature in the cells of the test cartridge can be detected accurately with the thermopile.

According to the twelfth technical feature of the present invention, a change in an ambient temperature of the liquid temperature detector can be suppressed.

According to the thirteenth technical feature of the present invention, a change in a surrounding environment of the liquid temperature detector can be kept in an external air environment.

According to the fourteenth technical feature of the present invention, even when the movable cartridge holding means is used, the positional relationship between the target cell of the test cartridge and the liquid temperature detector can be kept satisfactory.

According to the fifteenth technical feature of the present invention, compared to the aspect not having the configuration of the present invention, the test cartridge can be conveyed to the test stage in a state in which a difference between the liquid temperature in the cells of the test cartridge and the internal environmental temperature is further suppressed.

According to the sixteenth technical feature of the present invention, the maintenance and inspection and the demand for the change of the device element can be addressed easily.

According to the seventeenth technical feature of the present invention, the air introduced into the device housing can be efficiently formed as an air stream directed to the fan.

According to the eighteenth technical feature of the present invention, even when there is a difference in heat generation amount from the device element, the environmental temperature in the device housing can be adjusted substantially uniformly.

According to the nineteenth technical feature of the present invention, clean air can be introduced into the device housing, and analysis accuracy can be kept satisfactory.

According to the twentieth technical feature of the present invention, compared to the aspect not having the partition member, the diffusion of a ventilation amount distribution of air passing through the device housing can be prevented.

### BRIEF DESCRIPTION OF THE DRAWINGS

FIG. 1A is an explanatory diagram for illustrating an overview of an automatic analysis device according to an embodiment of the present invention.

FIG. 1B is a schematic view for illustrating an example of a test cartridge seen from the direction B of FIG. 1A.

FIG. 2A is an explanatory diagram for illustrating an overview of constant-temperature reservoir temperature control processing of the automatic analysis device illustrated in FIG. 1A.

FIG. 2B is an explanatory diagram for illustrating an overview of constant-temperature reservoir heating time control processing of the automatic analysis device illustrated in FIG. 1A.

FIG. 2C is an explanatory diagram for illustrating an assembly configuration example of an automatic analysis device according to an embodiment of the present invention.

FIG. 2D is a schematic view for illustrating an example of a test cartridge seen from the direction D of FIG. 2C.

FIG. 2E is an explanatory diagram for illustrating an example of air path design in a device housing of the automatic analysis device illustrated in FIG. 2C.

FIG. 2F is an explanatory view for illustrating another example of air path design in the device housing.

FIG. 3 is an explanatory view for illustrating an external appearance of an automatic analysis device according to a first embodiment of the present invention.

FIG. 4A is an explanatory view for illustrating a state in which a front door and a printer door of the automatic analysis device according to the first embodiment are opened.

FIG. 4B is an explanatory view for illustrating a state in which a test cartridge is held by a cartridge rack.

FIG. 4C is an explanatory view for illustrating an overview of the test cartridge.

FIG. 5A is a perspective view of the test cartridge to be set on the automatic analysis device.

FIG. 5B is a front view of the set test cartridge seen from a front side.

FIG. 5C is a plan view of the set test cartridge.

FIG. 5D is a sectional view taken along the line D-D of FIG. 5B.

FIG. 6A is a perspective explanatory view for illustrating a capillary serving as a blood collector to be used in the first embodiment.

FIG. 6B is a plan view of the capillary.

FIG. 6C is a front view of the capillary.

FIG. 6D is a sectional view taken along the line D-D of FIG. 6C.

FIG. 7A to FIG. 7E are explanatory views for illustrating a preparation process of causing the test cartridge to hold a nozzle tip and the capillary.

FIG. 8 is an explanatory view for illustrating each component of the automatic analysis device according to the first embodiment in an exploded manner.

FIG. 9 is an explanatory diagram for illustrating a control system of the automatic analysis device according to the first embodiment.

FIG. 10 is an explanatory view for illustrating an overview of an internal structure of the automatic analysis device according to the first embodiment.

FIG. 11 is a schematic plan view of the automatic analysis device according to the first embodiment.

FIG. 12A is a perspective view for illustrating a cartridge holding mechanism corresponding to an X unit to be used in the first embodiment.

FIG. 12B is a front view of the cartridge holding mechanism.

FIG. 13 is a perspective view for illustrating a YZ unit to be used in the first embodiment.

FIG. 14 is an explanatory view of the YZ unit of FIG. 13 exploded into each component.

FIG. 15 is an explanatory view for illustrating a cartridge moving mechanism corresponding to a Y unit serving as one element of the YZ unit.

FIG. 16A is an explanatory view of the cartridge moving mechanism seen from a right side in FIG. 15.

FIG. 16B is a sectional view taken along the line B-B of FIG. 16A.

FIG. 17A is an explanatory view for illustrating a specimen and reagent dispensing mechanism corresponding a Z unit serving as one element of the YZ unit.

FIG. 17B is a side view of the specimen and reagent dispensing mechanism seen from a right side.

FIG. 18A is a perspective view for illustrating a basic configuration of a constant-temperature reservoir to be incorporated as one element of the YZ unit.

FIG. 18B is a front view of the constant-temperature reservoir.

FIG. 18C is a sectional view taken along the line C-C of FIG. 18B.

FIG. 19A is a sectional view taken along the line A-A of FIG. 18B.

FIG. 19B is a sectional view taken along the line B-B of FIG. 19A.

FIG. 19C is a sectional view taken along the line C-C of FIG. 19A.

FIG. 20A is a perspective view for illustrating a constant-temperature reservoir to be incorporated as one element of the YZ unit.

FIG. 20B is a front view of the constant-temperature reservoir.

FIG. 20C is a sectional view taken along the line C-C of FIG. 20B.

FIG. 21A is a sectional view taken along the line A-A of FIG. 20B.

FIG. 21B is a sectional view taken along the line B-B of FIG. 21A.

FIG. 21C is a sectional view taken along the line C-C of FIG. 21A.

FIG. 22 is an explanatory view for illustrating an entire configuration of a device housing to be used in the first embodiment.

FIG. 23A is a perspective view for illustrating a bottom plate unit of the device housing of FIG. 22.

FIG. 23B is a right side view of the bottom plate unit.

FIG. 24A is a perspective view for illustrating an undercover of the bottom plate unit.

FIG. 24B is a right side view of the undercover.

FIG. 25A is an explanatory view for illustrating an air introducing state of the bottom plate unit.

FIG. 25B is an explanatory view for illustrating a flow direction of air introduced into the bottom plate unit.

FIG. 26 is an explanatory view for illustrating a state in which the air introduced from the bottom plate unit enters the device housing.

FIG. 27 is an explanatory view for illustrating a heat generation area in the device housing.

FIG. 28 is an explanatory view for illustrating a flow of the air having entered the device housing.

FIG. 29 is an explanatory diagram for illustrating sensors of the control system to be used in the first embodiment.

FIG. 30A is an explanatory view for illustrating a positional relationship between a thermopile and a reagent cell of the test cartridge to be used in the first embodiment.

FIG. 30B is an explanatory view for illustrating a configuration example of the thermopile.

FIG. 30C is an explanatory view for illustrating an exemplary aspect of a target cell for measurement by the thermopile.

FIG. 31 is an explanatory diagram for illustrating a control processing process of the test cartridge by the control system to be used in the first embodiment.

FIG. 32 is an explanatory diagram for illustrating a user operation and an equipment operation of the automatic analysis device according to the first embodiment.

FIG. 33 is an explanatory diagram for illustrating a timing chart of a device internal operation of the automatic analysis device according to the first embodiment.

FIG. 34 is an explanatory view for illustrating an operation process (1) of the automatic analysis device.

FIG. 35 is an explanatory view for illustrating an operation process (2) of the automatic analysis device.

FIG. 36 is an explanatory view for illustrating an operation process (3) of the automatic analysis device.

FIG. 37 is an explanatory view for illustrating an operation process (4) of the automatic analysis device.

FIG. 38 is an explanatory view for illustrating an operation process (5) of the automatic analysis device.

FIG. 39 is an explanatory view for illustrating an operation process (6) of the automatic analysis device.

FIG. 40 is an explanatory view for illustrating an operation process (7) of the automatic analysis device.

FIG. 41 is an explanatory view for illustrating an operation process (8) of the automatic analysis device.

FIG. 42 is an explanatory view for illustrating an operation process (9) of the automatic analysis device.

FIG. 43 is an explanatory view for illustrating an operation process (10) of the automatic analysis device.

FIG. 44 is an explanatory view for illustrating a state change (1) of the test cartridge in the operation process of the automatic analysis device.

FIG. 45 is an explanatory view for illustrating a state change (2) of the test cartridge in the operation process of the automatic analysis device.

FIG. 46 is an explanatory view for illustrating a state change (3) of the test cartridge in the operation process of the automatic analysis device.

FIG. 47 is an explanatory view for illustrating a state change (4) of the test cartridge in the operation process of the automatic analysis device.

FIG. 48 is an explanatory view for illustrating a state change (5) of the test cartridge in the operation process of the automatic analysis device.

FIG. 49 is an explanatory view for illustrating a state change (6) of the test cartridge in the operation process of the automatic analysis device.

FIG. 50A is an explanatory view for illustrating a modified embodiment of a guide mechanism of the X unit and the Y unit.

FIG. 50B is a view seen from the direction of the arrow B of FIG. 50A.

FIG. 50C is a view seen from the direction of the arrow C of FIG. 50A.

FIG. 51A is an explanatory view for illustrating a modified embodiment of a drive mechanism of the Z unit.

FIG. 51B is a view seen from the direction of the arrow B of FIG. 51A.

FIG. 52A is an explanatory diagram for illustrating a modified embodiment of the YZ unit of the automatic analysis device.

FIG. 52B is an explanatory diagram for illustrating another modified embodiment of the YZ unit of the automatic analysis device.

FIG. 53A is an explanatory diagram for illustrating a modified embodiment of the device housing of the automatic analysis device.

FIG. 53B is an explanatory diagram for illustrating a flow of air in the device housing.

FIG. 53C is an explanatory diagram for illustrating air holes formed in bottom plates of respective rooms of the device housing.

FIG. 54A and FIG. 54B are explanatory diagrams for illustrating a modified embodiment of the device housing of the automatic analysis device.

FIG. 55A and FIG. 55B are explanatory views for illustrating a modified embodiment involved in installation of the thermopile.

FIG. 56A is an explanatory view for schematically illustrating an aspect of detecting a liquid temperature after the test cartridge is moved to a liquid temperature detection position.

FIG. 56B is an explanatory view for illustrating a modified embodiment of a guide mechanism for moving the test cartridge to the liquid temperature detection position.

FIG. 57A is an explanatory view for illustrating a modified embodiment of a heat insulating structure of the constant-temperature reservoir.

FIG. 57B is an explanatory view for illustrating a modified embodiment of a mounting structure of the constant-temperature reservoir.

FIG. 57C is an explanatory view for illustrating a modified embodiment of the mounting structure of the constant-temperature reservoir.

FIG. 58 is an explanatory view for illustrating a modified embodiment around the test cartridge at a measurement position of the constant-temperature reservoir.

FIG. 59 is an explanatory graph for showing a temperature change in a reaction cell of a test cartridge of an automatic analysis device according to Example 1.

FIG. 60 is an explanatory graph for showing a temperature change in a constant-temperature reservoir caused by a difference in internal environmental temperature through use of an automatic analysis device according to Comparative Example 1.

FIG. 61 is an explanatory graph for showing a temperature change in a constant-temperature reservoir caused by a difference in internal environmental temperature through use of an automatic analysis device according to Comparative Example 2.

FIG. 62 is an explanatory graph for showing a change in a liquid temperature of a reagent cell after a time when the liquid temperature reaches a threshold value in checking of the liquid temperature of the test cartridge through use of an automatic analysis device according to Example 2.

### DETAILED DESCRIPTION OF THE PREFERRED EMBODIMENTS

### Overview of Embodiment

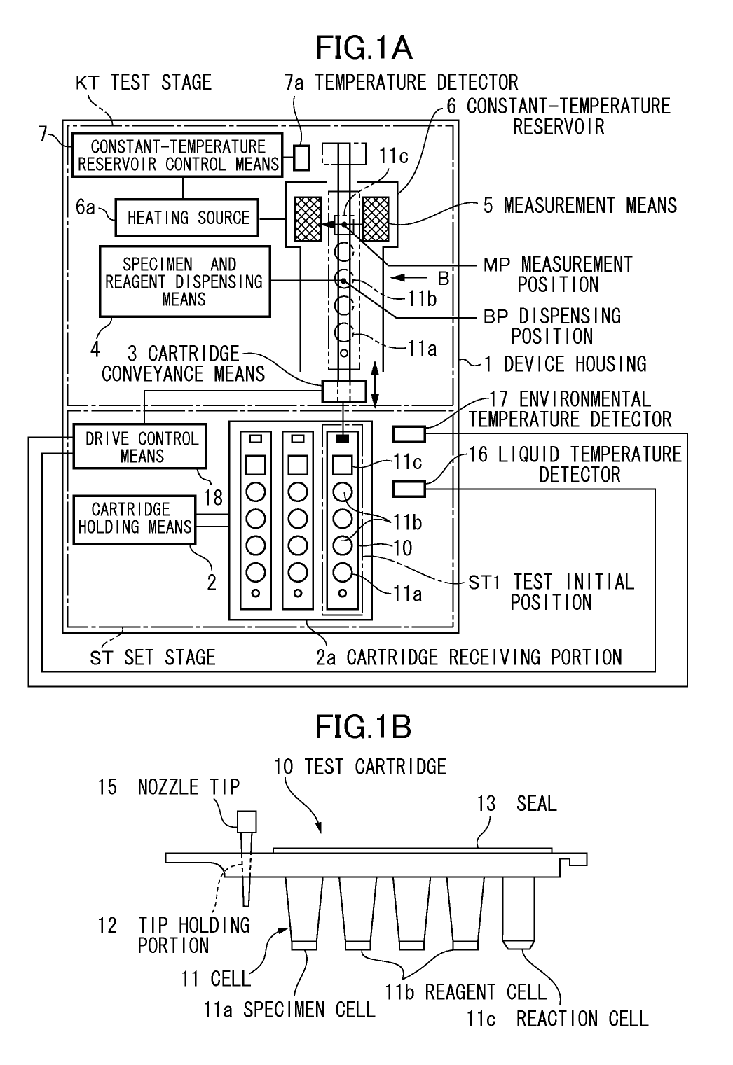

FIG. 1A is an illustration of an overview of an automatic analysis device according to an embodiment of the present invention, and FIG. 1B is an illustration of an overview of a test cartridge to be used in the automatic analysis device.

In FIG. 1A and FIG. 1B, the automatic analysis device is an automatic analysis device for automatically analyzing a reaction between a specimen and a reagent. The device includes: at least one test cartridge 10 including at least a specimen cell 11a for accommodating the specimen, a reagent cell 11b for accommodating the reagent, and a reaction cell 11c for allowing the specimen and the reagent to react with each other, the respective cells 11 being arranged linearly; a device housing 1 including a space portion for a previously-determined set stage ST and test stage KT adjacent to the set stage ST; a cartridge holding means 2 arranged on the set stage ST and including a cartridge receiving portion 2a for holding the at least one test cartridge 10; cartridge conveyance means 3 arranged on the test stage KT, for linearly conveying the test cartridge 10 held by the cartridge holding means 2 to the test stage KT and conveying the test cartridge 10 in a longitudinal direction along an arrangement direction of the respective cells 11 of the conveyed test cartridge 10 in the test stage KT, and meanwhile, linearly conveying the tested test cartridge 10 from the test stage KT to the set stage ST, thereby returning the test cartridge 10 to the cartridge receiving portion 2a of the cartridge holding means 2; specimen and reagent dispensing means 4 arranged so as to correspond to a dispensing position BP set previously in a part of a conveyance path of the test cartridge 10 in the test stage KT, for dispensing, with respect to the test cartridge in the test stage KT conveyed by the cartridge conveyance means 3, the specimen and the reagent in the test cartridge 10 to the reaction cell 11c in a state in which a dispensing target cell 11 of the test cartridge 10 is conveyed to be arranged at the dispensing position BP; measurement means 5 arranged so as to correspond to a measurement position MP set previously in apart of the conveyance path of the test cartridge 10 in the test stage KT, for measuring the reaction between the specimen and the reagent in the reaction cell 11c dispensed by the specimen and reagent dispensing means 4 in a state in which the reaction cell 11c of the test cartridge 10 in the test stage KT conveyed by the cartridge conveyance means 3 is conveyed to be arranged at the measurement position MP; a constant-temperature reservoir 6 to be heated by a heating source 6a so as to keep a liquid temperature at least in the reaction cell 11c of the test cartridge 10 in the test stage KT conveyed by the cartridge conveyance means 3 at a constant environmental temperature set previously; and constant-temperature reservoir control means 7 including a temperature detector 7a capable of detecting an internal environmental temperature of the test stage KT, for controlling a set temperature of the heating source 6a of the constant-temperature reservoir 6 so that the set temperature of the heating source 6a is higher when the internal environmental temperature is lower than a previously-determined threshold value than when the internal environmental temperature is equal to or higher than the threshold value, based on the internal environmental temperature detected by the temperature detector 7a.

In the above-mentioned technical means, the configuration of the test cartridge 10 is based on an aspect in which the cells 11 are arranged linearly. The defined number of the cells 11 may be appropriately selected, and other functional portions (for example, other cells, a tip holding portion 12 of a detachable nozzle tip 15, etc.) may be provided. Further, in an aspect in which each cell 11 of the test cartridge 10 previously accommodates the reagent, a diluent for the specimen, or the like, it is preferred that each cell 11 be covered with a seal 13 so that the reagent, the diluent for the specimen, or the like does not leak, and that the specimen and the reagent be dispensed by the specimen and reagent dispensing means 4 after forming a hole in the seal 13 when used.

Further, it is sufficient that the device housing 1 include at least a space capable of accommodating the set stage ST and the test stage KT arranged to be adjacent to each other.

Further, it is sufficient that the cartridge holding means 2 hold at least one test cartridge 10. In this example, the cartridge holding means 2 is not limited to a system of moving the cartridge receiving portion 2a and also encompasses a system of holding the test cartridge 10 in a fixed manner, for example, in the case where there is one test cartridge 10.

Still further, it is sufficient that the cartridge conveyance means 3 linearly convey the test cartridge 10 to the test stage KT and linearly convey the test cartridge 10 from the test stage KT. Therefore, the installation space of the test stage KT can be minimized.

Further, the specimen and reagent dispensing means 4 may be configured to dispense the specimen and the reagent by a common device or by separate devices. Further, the specimen and reagent dispensing means 4 is not limited to an aspect of using the detachable nozzle tip 15, and the specimen and reagent dispensing means 4 may be cleaned by cleaning means without using the nozzle tip 15. Further, the specimen of the present invention also includes a diluted specimen.

Further, the measurement means 5 may uniquely measure a previously-determined reaction or may measure a plurality of kinds of reactions.

Further, it is sufficient that the constant-temperature reservoir 6 be heated by the heating source 6a so as to keep at least the reaction cell 11c at the constant environmental temperature, and from the viewpoint of suppressing the influence from an external environment, it is preferred that the constant-temperature reservoir 6 be covered with a heat insulating material. In this case, the constant environmental temperature may be appropriately selected based on a preferred reaction condition.

Further, it is sufficient that the constant-temperature reservoir control 7 detect the internal environmental temperature of the test stage KT, and the set temperature of the heating source 6a be controlled with the detection result being a parameter. In this case, one or a plurality of threshold values of the internal environmental temperature may be used.

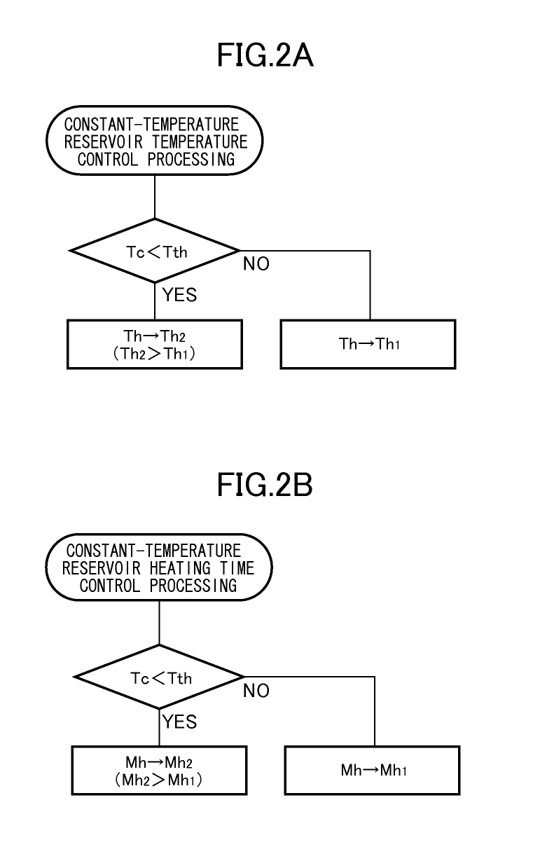

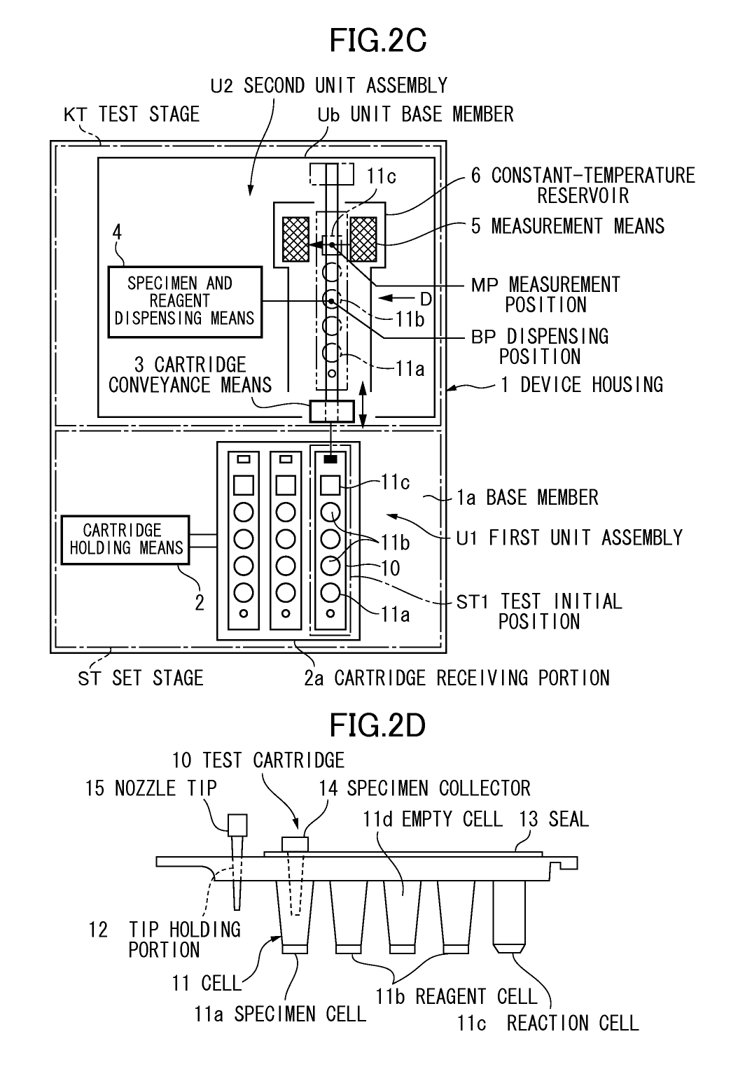

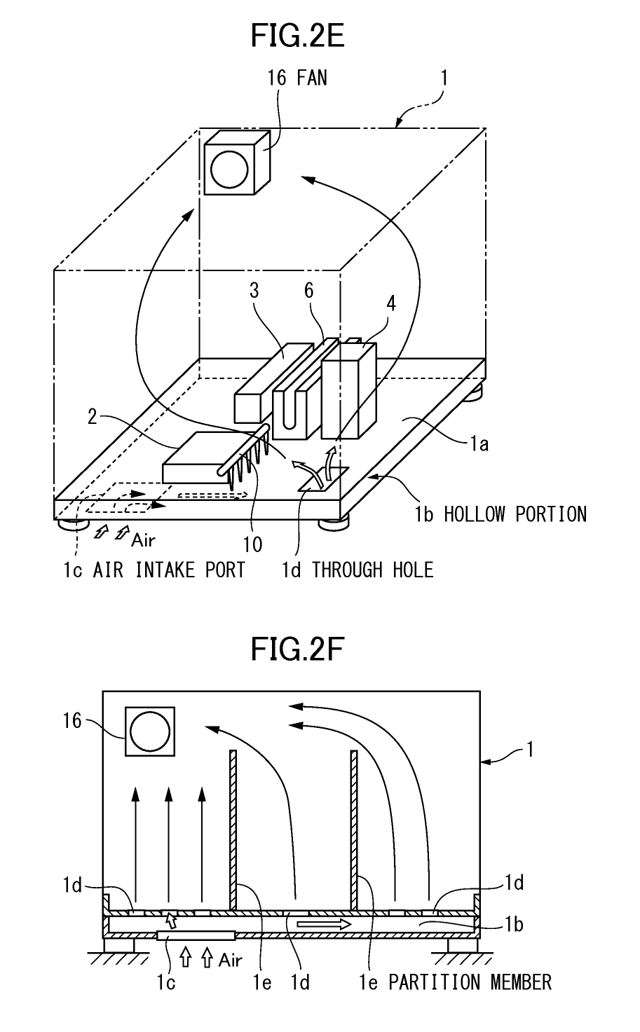

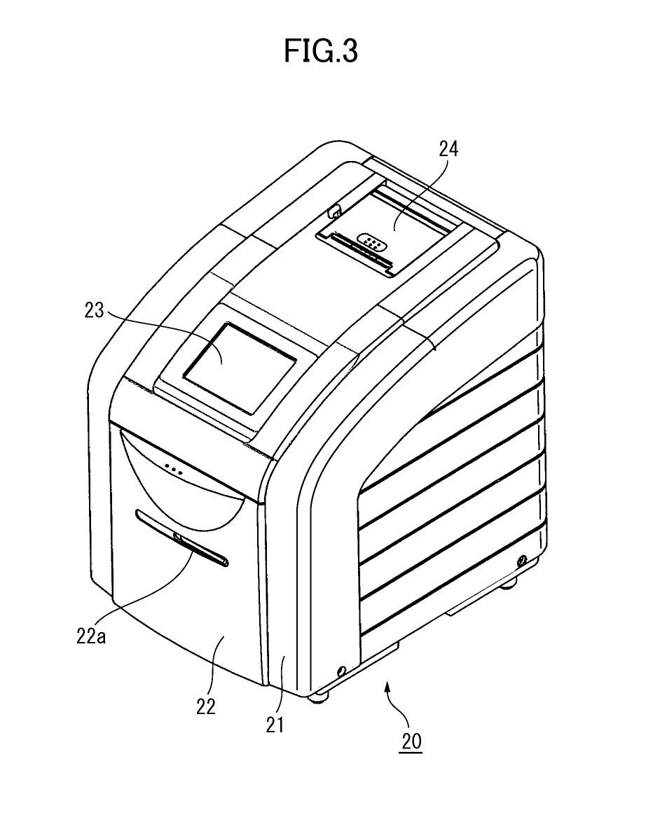

In this example, the constant-temperature reservoir control means 7 performs constant-temperature reservoir temperature control processing as illustrated in FIG. 2A. When an internal environmental temperature Tc is lower than a predetermined threshold value Tth, the constant-temperature reservoir control means 7 increases a set temperature Th of the heating source 6a to Th2 so as to increase the heating amount for the constant-temperature reservoir 6, thereby keeping the constant environmental temperature condition constant, and thus the liquid temperature of the test cartridge 10 can be kept at an appropriate temperature. Note that, when the internal environmental temperature Tc is equal to or higher than the predetermined threshold value Tth, the set temperature Th of the heating source 6a is set at a previously-determined Th1 (Th2>Th1).

Next, a typical aspect or an exemplary aspect in this embodiment is described.

First, as an exemplary aspect of the constant-temperature reservoir control means 7, there is given an aspect in which the constant-temperature reservoir control means 7 further variably sets a heating time of the heating source 6a so that the liquid temperature in the reaction cell 11c of the test cartridge 10 at a time of start of measurement by the measurement means 5 is a previously-determined temperature, based on the internal environmental temperature detected by the temperature detector 7a.

This aspect corresponds to a system of controlling the heating time of the heating source 6a, and it is sufficient that the internal environmental temperature of the test stage KT be detected, and that the heating time of the heating source 6a be controlled with the detection result being a parameter. In this case, the threshold value of the internal environmental temperature may or may not be the same as that in the case of controlling the set temperature of the heating source 6a. Further, one temperature detector 7a may be provided, but a plurality of the temperature detectors 7a may be provided from the viewpoint of enhancing safety and reliability.

This example focuses on the following. Even when the internal environmental temperature varies, it is necessary to keep the liquid temperature in the reaction cell 11c of the test cartridge 10 at the constant environmental temperature, and the heating temperature of the heating source 6a is controlled. However, the temperature condition at a time of start of measurement by the measurement means 5 can be kept constant easily by further variably setting the heating time with the internal environmental temperature being a parameter.

That is, in this example, the constant-temperature reservoir control means 7 performs constant-temperature reservoir heating time control processing as illustrated in FIG. 2B. When the internal environmental temperature Tc is lower than the predetermined threshold value Tth, the constant-temperature reservoir control means 7 extends a heating time Mh of the heating source 6a to Mh2 so as to increase the heating amount for the constant-temperature reservoir 6 up to a time when the measurement by the measurement means 5 is started, thereby keeping the constant environmental temperature condition constant, and thus the liquid temperature of the test cartridge 10 can be kept at an appropriate temperature. Note that, when the internal environmental temperature Tc is equal to or higher than the predetermined threshold value Tth, the heating time Mh of the heating source 6a is set at a previously-determined Mh1 (Mh2>Mh1).

Further, as an aspect of the constant-temperature reservoir 6, there is given an aspect in which the constant-temperature reservoir 6 includes: a constant-temperature reservoir main body; a heat insulating cover formed of a heat insulating material covering a periphery of the constant-temperature reservoir main body; the heating source 6a arranged between the constant-temperature reservoir main body and the heat insulating cover and arranged in contact with the constant-temperature reservoir main body; and a heat-resistant heat insulating material interposed between the heating source 6a and the heat insulating cover and having a heat insulating effect higher than that of the heat insulating cover.

In this example, an aspect in which the heat insulating cover covers at least a part of the periphery of the constant-temperature reservoir main body is sufficient, and typically there is given an aspect in which the heat insulating cover covers a side peripheral wall and a bottom wall of the constant-temperature reservoir main body. From the viewpoint of further enhancing a heat insulating property, an upper wall of the constant-temperature reservoir main body may be covered with a heat retaining cover. Further, it is sufficient that the heat-resistant heat insulating material be a heat insulating material having a heat insulating property with the heat insulating effect higher than that of the heat insulating cover, and due to the presence of the heat-resistant heat insulating material, the loss of heat radiated from the heating source to the heat insulating cover is suppressed.

Further, as an aspect of the constant-temperature reservoir 6, there is given an aspect in which the constant-temperature reservoir is installed in a state in which a contact surface between the constant-temperature reservoir main body and a member to be mounted is smaller than a projection plane of the constant-temperature reservoir main body onto the member to be mounted.

In this example, for example, there is given an aspect in which a mounting portion having a small contact surface is formed on the constant-temperature reservoir main body, an opening is formed in the member to be mounted, or a heat insulating material is interposed between the constant-temperature reservoir main body and the member to be mounted. In this case, when the contact area between the constant-temperature reservoir main body and the member to be mounted is small, the loss of heat that is thermally conducted from the constant-temperature reservoir 6 to the member to be mounted decreases.

Further, in order to control the constant environmental temperature of the constant-temperature reservoir 6, the constant-temperature reservoir 6 generally includes a reservoir temperature detector (not shown) capable of detecting the temperature of the constant-temperature reservoir 6.

As a typical installation example of the reservoir temperature detector, there is given an aspect in which the reservoir temperature detector is arranged between the reaction cell 11c of the test cartridge 10 and the heating source 6a of the constant-temperature reservoir 6.

In this case, the reservoir temperature detector detects the constant environmental temperature of the constant-temperature reservoir 6, and this example is preferred in that the influence of the heating source can be detected accurately in the ambient temperature of the reaction cell 11c. Further, one reservoir temperature detector may be provided, but a plurality of reservoir temperature detectors may be provided from the viewpoint of enhancing safety and reliability.

Further, as an aspect of the constant-temperature reservoir 6, there is given an aspect in which the constant-temperature reservoir 6 includes a contact portion that is brought into contact with a bottom surface of the reaction cell 11c of the test cartridge 10 at least at the measurement position MP.

In this example, the contact portion of the constant-temperature reservoir 6 is brought into contact with the bottom surface of the reaction cell 11c of the test cartridge 10 at the measurement position MP of the measurement means 5, and hence the heat of the constant-temperature reservoir 6 is stably transmitted to the reaction cell 11c.

Further, as a preferred holding structure at the measurement position MP of the test cartridge 10, there is given an aspect in which the automatic analysis device further includes a biasing member (not shown) for biasing the bottom surface of the reaction cell 11c of the test cartridge 10 so as to press the bottom surface against the constant-temperature reservoir 6 at the measurement position MP of the constant-temperature reservoir 6.

In order to stabilize the contact state between the constant-temperature reservoir 6 and the reaction cell 11c of the test cartridge 10, a system of biasing the test cartridge 10 with the biasing member such as a plate spring is preferred.

Further, as a preferred system of monitoring a temperature at the time of setting the test cartridge 10 to the set stage ST, there is given an aspect in which the automatic analysis device further includes: a liquid temperature detector 16 arranged on the set stage ST, the liquid temperature detector being capable of detecting a liquid temperature of one of the reagent and a diluent for the specimen accommodated in the cell 11 of the test cartridge 10 held by the cartridge holding means 2; an environmental temperature detector 17 arranged on the set stage ST, the environmental temperature detector being capable of detecting an internal environmental temperature in the set stage ST; and drive control means 18 for inhibiting, when a detected temperature of the liquid temperature detector 16 is lower than a detected temperature from the environmental temperature detector 17, a conveyance operation of the test cartridge 10 to the test stage KT by the cartridge conveyance means 3 until, based on a difference between the detected temperatures, the difference between the detected temperatures becomes a previously-determined threshold value or less.

In this example, the liquid temperature detector 16 may be appropriately selected as long as the liquid temperature detector 16 is capable of detecting the liquid temperature of the reagent or the diluent for the specimen, for example, in a non-contact state.

The environmental temperature detector 17 may be provided separately from the liquid temperature detector 16 or may be contained in the liquid temperature detector 16.

Further, the test cartridge 10 is refrigerated and stored in a refrigerator inmost cases. Therefore, it is desired that, when used, the test cartridge 10 taken out from the refrigerator be left in a surrounding environment for a predetermined period of time and be subjected to test after the reagent and the like of the test cartridge 10 reach substantially the same temperature as that of the surrounding environment.

However, the test cartridge 10 may be subjected to the test without satisfying the above-mentioned use condition. The above-mentioned aspect is preferred for addressing such a situation.

Even if the stored test cartridge 10 is subjected to the test with earlier timing, the test cartridge 10 in which the liquid temperature is too low is put in a standby state in the set stage ST and conveyed to the test stage KT in a state in which the liquid temperature reaches an appropriate temperature, by monitoring the liquid temperature of the reagent or the diluent for the specimen in the cells 11 of the test cartridge 10.

Further, as a typical aspect of the liquid temperature detector 16, there is given the liquid temperature detector 16 including a thermopile element.

In this example, it is preferred that a lens having a small view angle be arranged on a front side of the thermopile element. Further, it is preferred that a shielding member or the like for intercepting heat ray information from members other than the detection target be arranged in the device housing 1 and on the periphery of the liquid temperature detector 16.

Further, as an exemplary aspect of the drive control means 18 in the case of using a thermopile as the liquid temperature detector 16, there is given an aspect in which the drive control means 18 is used so as to correct the liquid temperature detected by the liquid temperature detector 16 in accordance with the environmental temperature detected by the environmental temperature detector 17.

In this example, the output of the thermopile element varies depending on the environmental temperature, and hence it is preferred that the output be corrected in accordance with the environmental temperature in order to detect the liquid temperature accurately.

Still further, as another exemplary aspect of the drive control means 18 in the case of using the thermopile as the liquid temperature detector 16, there is given an aspect in which the drive control means 18 indirectly corrects the liquid temperature detected by the liquid temperature detector 16 by variably setting the threshold value in accordance with the environmental temperature detected by the environmental temperature detector 17.

In this example, even when the liquid temperature to be detected by the liquid temperature detector 16 changes depending on the environmental temperature, the liquid temperature can be corrected indirectly by variably setting the threshold value. In this case, a system of varying the threshold value may be appropriately selected from previously setting an environmental temperature and a threshold value into a table, applying a threshold value to a predetermined numerical expression, and the like.

Further, as an exemplary aspect in the case of using the thermopile as the liquid temperature detector 16, there is given an aspect in which the liquid temperature detector 16 is installed at a standby position at which an ambient temperature changes less in the set stage ST, and the liquid temperature detector 16 is moved by a moving mechanism (not shown) capable of moving to a detection position close to the cells 11 of the test cartridge 10 when the test cartridge 10 is held by the cartridge holding means 2.

Further, as another exemplary aspect, there is given an aspect in which the device housing 1 has a configuration capable of introducing external air into the periphery of the liquid temperature detector 16. This example corresponds to a system of keeping the use condition of the liquid temperature detector 16 in an external air environment.

Still further, as movable cartridge holding means 2, there is given a configuration in which the cartridge holding means 2 includes the cartridge receiving portion 2a capable of holding the at least one test cartridge 10, and the cartridge holding means 2 moves the cartridge receiving portion 2a in a direction crossing the arrangement direction of the cells 11 of the test cartridge 10, thereby transferring the test cartridge 10 to a previously-determined test initial position in the set stage ST and transferring the test cartridge 10, which is to be first subjected to the test of the at least one test cartridge 10, to a previously-determined liquid temperature detection position in the set stage ST.

In an aspect of using the above-mentioned type of the movable cartridge holding means 2, it is preferred to provide a guide member (not shown) capable of guiding the test cartridge 10 so that the positional relationship between the liquid temperature detector 16 and the test cartridge 10 is kept when the test cartridge 10 is transferred to the liquid temperature detection position.

This example can handle one test cartridge 10 but is mainly directed to an aspect in which a plurality of the test cartridges 10 are moved.

In the case where the plurality of the test cartridges 10 are held, it is sufficient that the test cartridges 10 be arranged successively and selectively at the test initial position, and thus the selection operation of the plurality of the test cartridges 10 to the test initial position can be realized.

Then, the guide member can keep the positional relationship between the target cell 11 of the test cartridge 10 and the liquid temperature detector 16 constant.

Further, as an exemplary aspect of the drive control means 18, there is given an aspect in which, when the detected temperature of the liquid temperature detector 16 is lower than the detected temperature from the environmental temperature detector 17, under a condition that, based on the difference between the detected temperatures, the difference between the detected temperatures becomes the previously-determined threshold value or less, the drive control means 18 performs the conveyance operation of the test cartridge 10 to the test stage KT by the cartridge conveyance means 3 after a previously-determined time period has elapsed.

When the detected temperature difference is as small as possible, the reaction becomes stable. In this case, when the threshold value is previously set in a narrow range, there may be a case in which the detected temperature difference does not reach the threshold value due to the variation in tolerance. In view of this, the threshold value larger than the variation in tolerance to some degree is selected, and a predetermined period of time is allowed to elapse after the detected temperature difference reaches the threshold value. Therefore, the liquid temperature in the cells 11 of the test cartridge 10 further approaches the internal environmental temperature.

FIG. 2C is an illustration of an assembly configuration example of an automatic analysis device according to an embodiment of the present invention, and FIG. 2D is an illustration of an overview of a test cartridge to be used in the automatic analysis device.

In FIG. 2C and FIG. 2D, the automatic analysis device is an automatic analysis device for automatically analyzing a reaction between a specimen and a reagent. The automatic analysis device includes: at least one test cartridge 10 including at least a specimen cell 11a for accommodating the specimen, a reagent cell 11b for accommodating the reagent, and a reaction cell 11c for allowing the specimen and the reagent to react with each other, the respective cells 11 being arranged linearly; a device housing 1 securing a space portion for a previously-determined set stage ST and a test stage KT adjacent to the set stage ST and including a base member 1a extending from the set stage ST to the test stage KT; cartridge holding means 2 arranged on the set stage ST and including a cartridge receiving portion 2a for holding the at least one test cartridge 10; cartridge conveyance means 3 arranged on the test stage KT, for linearly conveying the test cartridge 10 held by the cartridge holding means 2 to the test stage KT and conveying the test cartridge 10 in a longitudinal direction along an arrangement direction of the respective cells 11 of the conveyed test cartridge 10 in the test stage KT, and meanwhile, linearly conveying the tested test cartridge 10 from the test stage KT to the set stage ST, thereby returning the test cartridge 10 to the cartridge receiving portion 2a of the cartridge holding means 2; specimen and reagent dispensing means 4 arranged so as to correspond to a dispensing position BP set previously in a part of a conveyance path of the test cartridge 10 in the test stage KT, for dispensing, with respect to the test cartridge 10, the specimen and the reagent in the test cartridge 10 to the reaction cell 11c in a state in which a dispensing target cell 11 of the test cartridge 10 in the test stage KT conveyed by the cartridge conveyance means 3 is conveyed to be arranged at the dispensing position BP; measurement means 5 arranged so as to correspond to a measurement position MP set previously in a part of the conveyance path of the test cartridge 10 in the test stage KT, for measuring the reaction between the specimen and the reagent in the reaction cell 11c dispensed by the specimen and reagent dispensing means 4 in a state in which the reaction cell 11c of the test cartridge 10 in the test stage KT conveyed by the cartridge conveyance means 3 is conveyed to be arranged at the measurement position MP; and a constant-temperature reservoir 6 having the measurement means 5 mounted thereon, for keeping at least the reaction cell 11c of the test cartridge 10 in the test stage KT conveyed by the cartridge conveyance means 3 at a constant environmental temperature set previously. The cartridge holding means 2 is incorporated as a first unit assembly U1 onto the base member 1a of the set stage ST, and the cartridge conveyance means 3, the specimen and reagent dispensing means 4, and the constant-temperature reservoir 6 are mounted on a common unit base member Ub and incorporated as a second unit assembly U2 onto the base member 1a of the test stage KT.

In the above-mentioned technical means, the configuration of the test cartridge 10 is based on an aspect in which the cells 11 are arranged linearly. The defined number of the cells 11 may be appropriately selected, and other functional portions (for example, other cells, a tip holding portion 12 of a detachable nozzle tip 15, etc.) may be provided.

Further, the device housing 1 requires at least a space capable of accommodating the set stage ST and the test stage KT arranged to be adjacent to each other, and it is sufficient that there be provided the base member 1a extending from the set stage ST to the test stage KT. The base member 1a is not limited to a plate shape and may have a folded plate shape having a step difference.

Further, it is sufficient that the cartridge holding means 2 hold at least one test cartridge 10. In this example, the cartridge holding means 2 is not limited to a system of moving the cartridge receiving portion 2a and also encompasses a system of holding the test cartridge 10 in a fixed manner, for example, in the case where there is one test cartridge 10.

Still further, it is sufficient that the cartridge conveyance means 3 linearly convey the test cartridge 10 to the test stage KT and linearly convey the test cartridge 10 from the test stage KT. Therefore, the installation space of the test stage KT can be minimized.

Further, the specimen and reagent dispensing means 4 may be configured to dispense the specimen and the reagent by a common device or by separate devices. Further, the specimen and reagent dispensing means 4 is not limited to an aspect of using the detachable nozzle tip 15, and the specimen and reagent dispensing means 4 may be cleaned by cleaning means without using the nozzle tip 15. Further, the specimen of the present invention also includes a diluted specimen.

Further, the measurement means 5 may uniquely measure a previously-determined reaction or may measure a plurality of kinds of reactions.

Further, the reaction between the specimen and the reagent can be measured while the reaction condition is kept constant in the constant-temperature reservoir 6. In this case, the constant environmental temperature may be appropriately selected based on a preferred reaction condition.

In this case, device elements are incorporated as a two-system unit assembly (the first unit assembly U1, the second unit assembly U2), and particularly in the second unit assembly U2, a plurality of device elements are mounted on the common unit base member Ub.

Therefore, in the case of replacing, for example, the specimen and reagent dispensing means 4 when subjecting the device elements to maintenance and inspection, the specimen and reagent dispensing means 4 is replaced as one element of the second unit assembly U2, and the replaced unit is mounted again on the common unit base member Ub. Therefore, the positional relationship between the device elements on the second unit assembly U2 is kept satisfactory.

Further, in the case of changing, for example, the number of the held test cartridges 10 when changing the device specification, it is sufficient that the first unit assembly U1 be changed. In the case of increasing the number of test items, the test items can be increased easily by installing a plurality of the second unit assemblies U2 or the like.

In general, one first unit assembly U1 and one second unit assembly U2 are provided, but at least one of the first unit assembly U1 or the second unit assembly U2 may be provided in a plural number.

Next, a typical aspect or an exemplary aspect in this embodiment is described.

First, as an exemplary aspect of the cartridge holding means 2, there is given a configuration in which the cartridge holding means 2 includes a plurality of the cartridge receiving portions 2a capable of holding a plurality of the test cartridges 10, and all the cartridge receiving portions 2a are moved along a direction crossing the arrangement direction of the cells 11 of the test cartridge 10 so that the test cartridges 10 are successively transferred to the previously-determined test initial position ST1 in the set stage ST. In this aspect, in the case where the plurality of the test cartridges 10 are held, the test cartridges 10 are arranged successively and selectively at the test initial position ST1.

Further, as an exemplary aspect of the test cartridge 10, there is given the following aspect. The test cartridge 10 includes an empty cell 11d capable of accommodating a used specimen collector 14. The test cartridge 10 is used in a state in which the specimen collector 14 having collected a specimen is set in the specimen cell 11a before the test. The specimen and reagent dispensing means 4 dispenses the specimen collected in the specimen collector 14 into the specimen cell 11a. The used specimen collector 14 is disposed of into the empty cell 11d. In this aspect, the test cartridge 10 is used in a state in which the specimen collector 14 is set, and the empty cell 11d is secured in the test cartridge 10 and used as a disposal place for the used specimen collector 14.

Further, as another typical aspect of the test cartridge 10, there is given the following. The test cartridge 10 includes the tip holding portion 12 for detachably holding the nozzle tip 15. The specimen and reagent dispensing means 4 uses the detachable nozzle tip 15 for each test cartridge 10. In this case, the tip holding portion 12 may hold a novel nozzle tip 15, or hold a used nozzle tip 15 and dispose of the nozzle tip 15 together with the tested test cartridge 10. Further, the nozzle tip 15 is used by the specimen and reagent dispensing means 4 when the specimen and reagent dispensing means 4 dispenses the specimen and the reagent.

Further, as another typical aspect of the test cartridge 10, there is given the following aspect. The test cartridge 10 has a mark for confirming an insertion direction in a part thereof. The cartridge holding means 2 includes a detector that allows the mark to be detected at a time of one of the case in which the test cartridge 10 is inserted into the cartridge receiving portion 2a in the correct direction and the case in which the test cartridge 10 is inserted into the cartridge receiving portion 2a in the wrong direction and that allows the mark not to be detected at a time of the other.

In this example, the test cartridge 10 has a mark (a barcode, etc.), and the position of the mark varies depending on the insertion direction of the test cartridge 10. Using this configuration, it is understood whether the insertion direction of the test cartridge 10 is correct or not based on the detection result of the detector for detecting the mark. Further, it is preferred to provide a display for notifying that the insertion direction of the test cartridge 10 is correct or wrong based on the detected signal by the detector.

Next, as a typical aspect of the cartridge conveyance means 3, there is given an aspect in which, during a dispensing operation of the specimen and the reagent by the specimen and reagent dispensing means 4, the test cartridge 10 is conveyed so that a part of the test cartridge 10 can appear or disappear on the set stage ST side.

In this example, when a part of the test cartridge 10 returns to the set stage ST side, the test cartridge 10 temporarily comes out from the constant-temperature reservoir 6, which is considered to be disadvantageous in terms of a temperature. In this case, it is preferred to take measures to control the temperature of the constant-temperature reservoir 6, previously increase the temperature of the test cartridge 10, and the like.

Next, as a typical aspect of air path design in the device housing 1, as illustrated in FIG. 2E, there is given the following aspect. The automatic analysis device further includes a fan 16 capable of forcibly exhausting air in the set stage ST and the test stage KT of the device housing 1. The device housing 1 includes: a hollow portion 1b provided in a lower portion of the base member 1a; an air intake port 1c formed in a part of the hollow portion 1b; and a through hole 1d formed in the base member 1a; the fan 16 is arranged in an upper corner portion on a back surface side of the device housing 1; and the through hole 1d is arranged at a diagonal position of the device housing 1 with respect to the fan 16.

In this aspect, the positional relationship between the fan 16 and the through hole 1d in the device housing 1 is focused on, and air introduced through the through hole 1d is directed to the fan 16 together with unnecessary warm air generated in the device housing 1 so as to form an air stream efficiently.

Further, as another typical aspect of the air path design, as illustrated in FIG. 2F, there is given the following aspect. The automatic analysis device further includes a fan 16 capable of forcibly exhausting air in the set stage ST and the test stage KT of the device housing 1. The device housing 1 includes: a hollow portion 1b formed in a lower portion of the base member 1a; an air intake port is formed in a part of the hollow portion 1b; and a through hole 1d formed in the base member 1a in which, in accordance with a heat generation amount from a device element in the set stage ST and the test stage KT, an opening area is larger in a portion having a large heat generation amount than in a portion having a small heat generation amount. In this example, when an exhaust operation by the fan 16 is performed, air is taken into the hollow portion 1b through the air intake port is and guided into the set stage ST and the test stage KT through the through hole 1d to be exhausted by the fan 16. In this case, a ventilation amount varies depending on the size of the opening area of the through hole 1d, and the ventilation amount is large in the portion having a large heat generation amount from the device elements and is small in the portion having a small heat generation amount from the device elements. Therefore, the environmental temperature in the device housing 1 decreases substantially to the same degree.

Further, as an exemplary aspect of the air path design, there is given an aspect in which at least one of the air intake port 1c or the through hole 1d has a dust removing filter (not shown).

Further, as another exemplary aspect of the air path design, there is given an aspect in which the device housing 1 includes a partition member 1e (see FIG. 2F) for partitioning an interior space portion in accordance with the heat generation amount from the device elements in the set stage ST and the test stage KT.

In this example, by partitioning the interior space portion with the partition member 1e, the ventilation amount in accordance with the heat generation amount from the device elements is enabled to pass in a form narrowed to the partitioned interior space portion.

Further, as another exemplary aspect of the air path design, there is given an aspect in which the fan 16 is arranged closely to the device element having a large heat generation amount among the device elements in the device housing 1.

Now, the present invention is described in detail based on the embodiments illustrated in the attached drawings.

### First Embodiment

### Entire Configuration

FIG. 3 is an explanatory view for illustrating an external appearance of an automatic analysis device according to a first embodiment of the present invention.

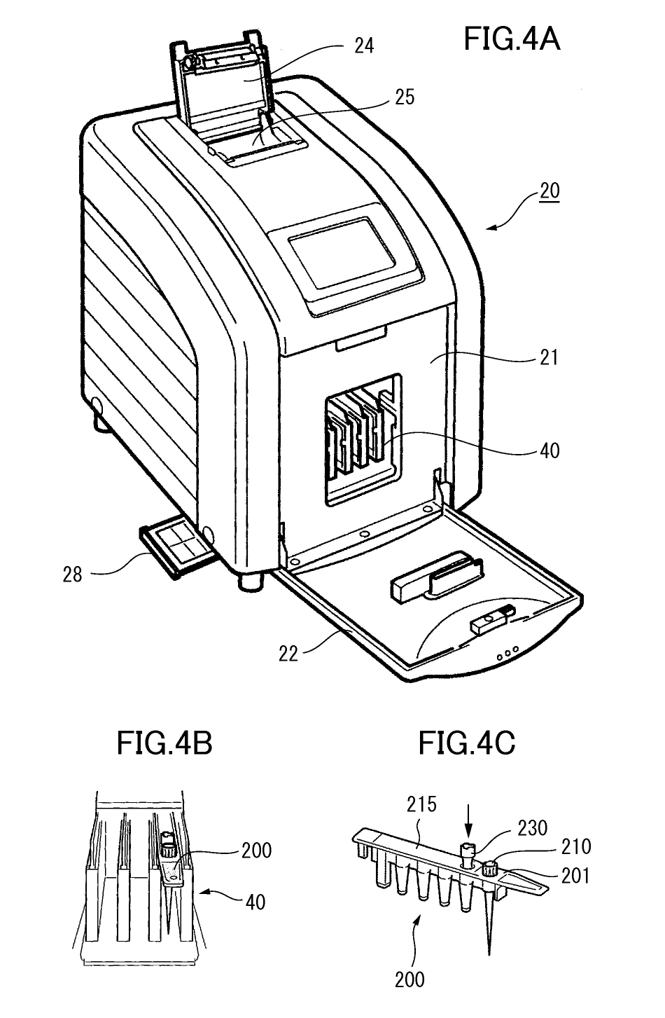

In FIG. 3, an automatic analysis device 20 includes a door 22 capable of being opened and closed on a front surface side (an operation side of a user) of a device housing 21. An operation panel 23 (a touch key panel using a color LCD is used in this example) serving as an operation portion is arranged on a top surface side positioned above the door 22, and a printer 25 (see FIG. 4A) is embedded in a printer cover 24 capable of being opened and closed above the operation panel 23. As illustrated in FIG. 4A to FIG. 4C, the user sets at least one (for example, three) test cartridge 200, in which a specimen to be tested has been dispensed, in the device housing 21 in a state in which the door 22 is opened. After that, the user operates a start button of the operation panel 23, and thus the specimen in the at least one test cartridge 200 is successively analyzed automatically.

Note that, in FIG. 4A and FIG. 4B, the automatic analysis device 20 includes a cartridge rack 40 for holding at least one test cartridge 200 and a cleaning filter 28 for cleaning air to be taken into the device housing 21.

<Test Cartridge>

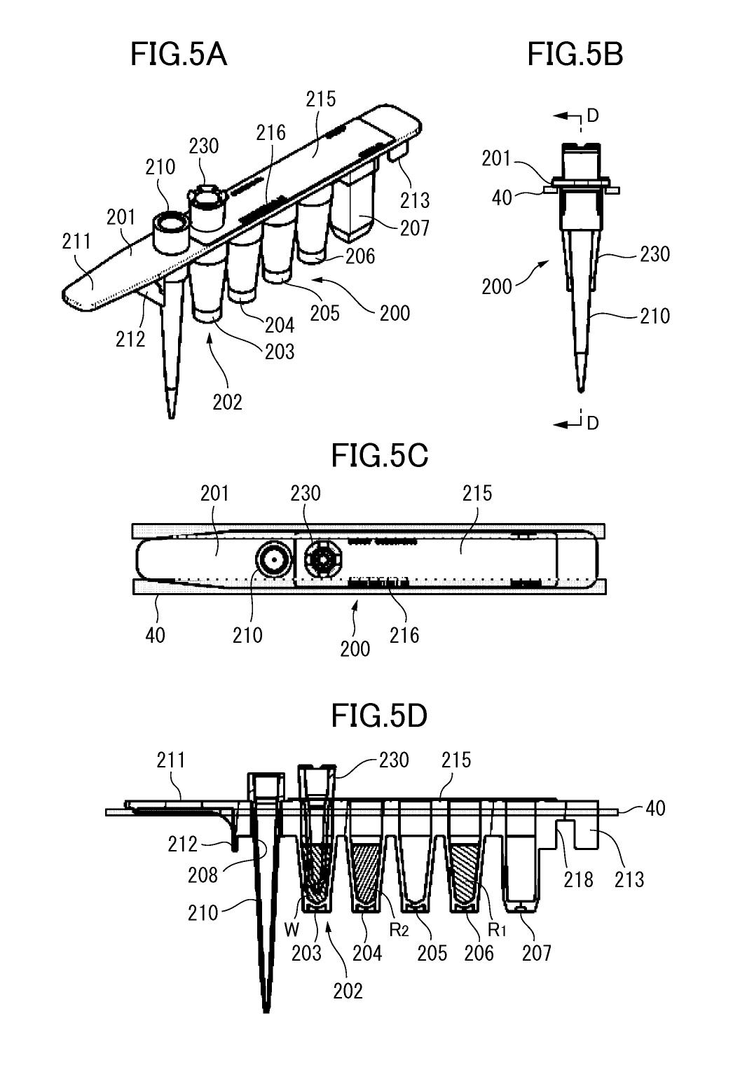

In this embodiment, as illustrated in FIG. 5A to FIG. 5D, for example, the test cartridge 200 includes a cartridge main body 201 formed of a synthetic resin such as polypropylene and extending linearly, and a plurality of bottomed cells 202 are arranged integrally and linearly in the cartridge main body 201.

In this embodiment, the cells 202 include one specimen cell 203 for accommodating a specimen, a plurality of (for example, three) reagent cells 204 to 206 capable of accommodating reagents, and one reaction cell 207 for allowing the specimen and the reagents to be dispensed to react with each other, in the order from a side away from an insertion direction end of the cartridge main body 201. Note that, needless to say, the configuration can be appropriately selected, and for example, a plurality of the specimen cells 203 and a plurality of the reaction cells 207 can be provided.

In particular, in this embodiment, of the cells 202, the reaction cell 207 is a container having a substantially rectangular tubular cross section, and cell outer wall surfaces thereof are formed as planes along an X-axis direction (a direction orthogonal to a longitudinal direction of the test cartridge 200) and a Y-axis direction (a direction along the longitudinal direction of the test cartridge 200). The other cells 202, specifically, the specimen cell 203 and the reagent cells 204 to 206 are formed into a shape having a cylindrical cross section. Further, in this embodiment, of the plurality of the reagent cells 204 to 206, one reagent cell 205 is unused, and reagents R1 and R2 are previously dispensed in a predetermined amount into the other two reagent cells 206 and 204. On the other hand, in this embodiment, a diluent W is previously dispensed in a predetermined amount into the specimen cell 203.

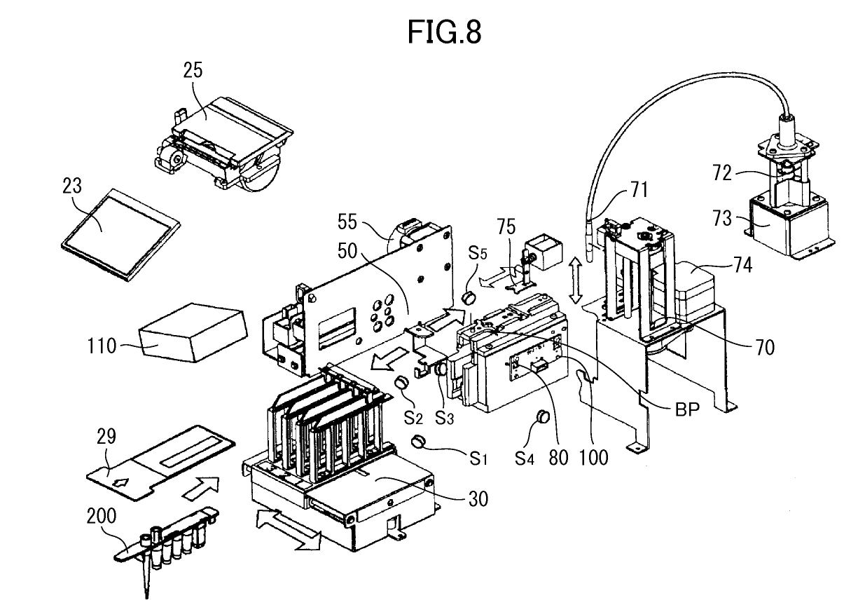

Further, in this embodiment, a tip holding hole 208 is formed in a state of passing through the cartridge main body 201 so as to be adjacent to the specimen cell 203 on the side away from the insertion direction end of the cartridge main body 201, and a nozzle tip 210 capable of being detachably mounted on a specimen and reagent dispensing mechanism 70 (see FIG. 8) is removably locked and held in the tip holding hole 208 from above.

Further, a gripping portion 211 is formed so as to protrude from a side opposite to the insertion direction end of the cartridge main body 201, and a finger pressing part 212 is formed so as to protrude from a rear surface of the gripping portion 211.

On the other hand, a piece 213 to be engaged protruding downward is formed on the side of the insertion direction end of the cartridge main body 201.

Still further, in this embodiment, a protruding edge (not shown) protruding upward is formed at an opening edge of each of the cells 202 (203 to 207) of the cartridge main body 201, and an opening of each of the cells 202 (203 to 207) is covered with a seal 215 from above. In this case, the protruding edge of each of the cells 202 is brought into contact with the seal 215, and hence each of the cells 202 is partitioned in a completely sealed state through intermediation of the protruding edge, with the result that the risk of the flow of the reagents and the diluent in the cells 202 to the other cells can be effectively avoided.

Further, the specimen cell 203 is sealed with the seal 215, and a capillary 230 serving as a specimen collector capable of collecting the specimen is previously held in a state of being immersed in the diluent Win the specimen cell 203 through the seal 215.

Further, a barcode 216 serving as positional information for confirming the set direction of the test cartridge 200 is engraved on one side edge along a longitudinal direction of the seal 215.

Note that, required information such as a reagent lot, an expiration date, and a management number as well as the barcode 216 is engraved on the seal 215.

<Capillary (Specimen Collector)>

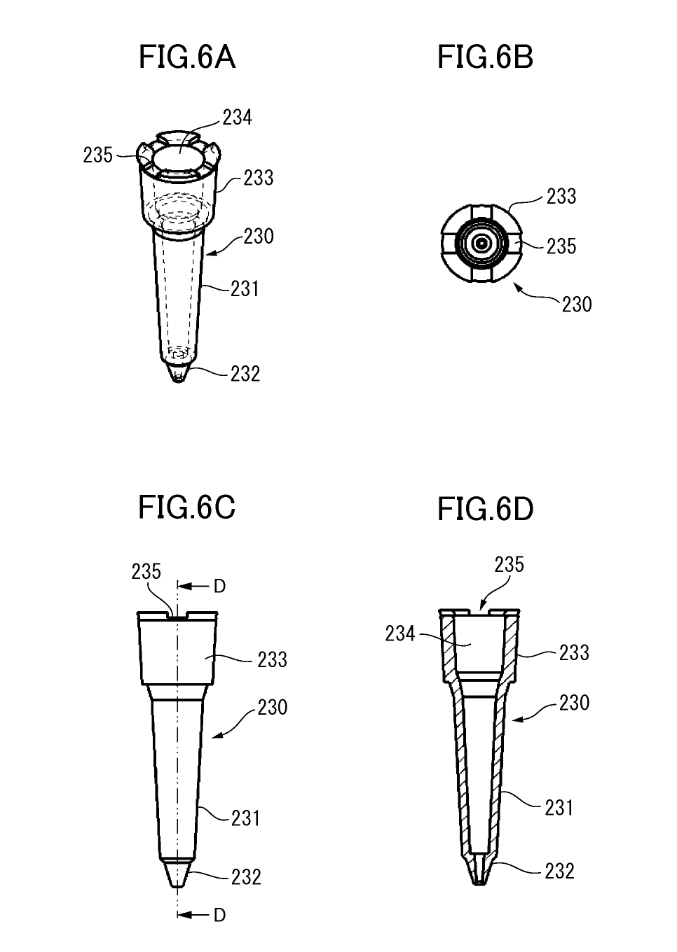

Further, in this embodiment, as illustrated in FIG. 6A to FIG. 6D, a specimen (blood in this example) collected by the capillary 230 serving as a specimen collector (a blood collector in this example) is to be dispensed into the specimen cell 203 of the test cartridge 200.

In this embodiment, the capillary 230 includes a collector body 231 formed of a synthetic resin having an opening on both ends so as to pass therethrough, a capillary portion 232 that is integrally formed on one end side of the collector body 231 and is capable of collecting a specimen formed of blood through a capillary phenomenon, and a holding portion 233 that is formed on the other end side of the collector body 231 so as to have an outer diameter larger than that of the collector body 231 and has a portion protruding outward from the collector body 231 to be held by the specimen cell 203.

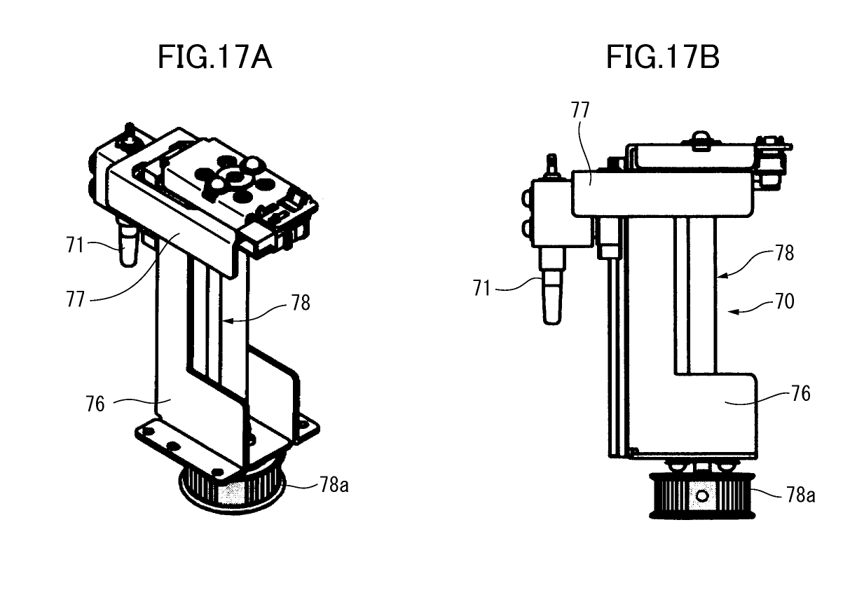

In this case, an outer peripheral shape of the capillary portion 232 has a shape of a circular truncated cone that is narrowed toward a tip end. Further, the holding portion 233 has a fitting hole 234 in which a nozzle head 71 (see FIGS. 17A and 17B) of the specimen and reagent dispensing mechanism 70 can be fitted, and groove portions 235 are formed at four positions at each angle of about 90° on a top portion of a peripheral wall of the fitting hole 234 of the holding portion 233. The groove portions 235 serve as air escape grooves between the capillary 230 and the specimen cell 203 when the capillary 230 is held by the specimen cell 203.

<Preliminary Preparation of Test Cartridge>

Before the test cartridge 200 is set on the automatic analysis device, it is necessary to perform preliminary preparation of previously setting the nozzle tip 210 and the capillary 230 having collected a specimen on the test cartridge 200.

In this example, a plurality of the test cartridges 200 are integrated as a reagent kit together with the dedicated nozzle tip 210 and the dedicated capillary 230, and this type of the reagent kit is generally refrigerated and stored in a refrigerator or the like.

It is preferred that the refrigerated and stored reagent kit be left at room temperature (from 15° C. to 30° C.) for 30 minutes or more and thereafter be used.

As the preliminary preparation to be performed to use the test cartridge 200, for example, the following operations are required.

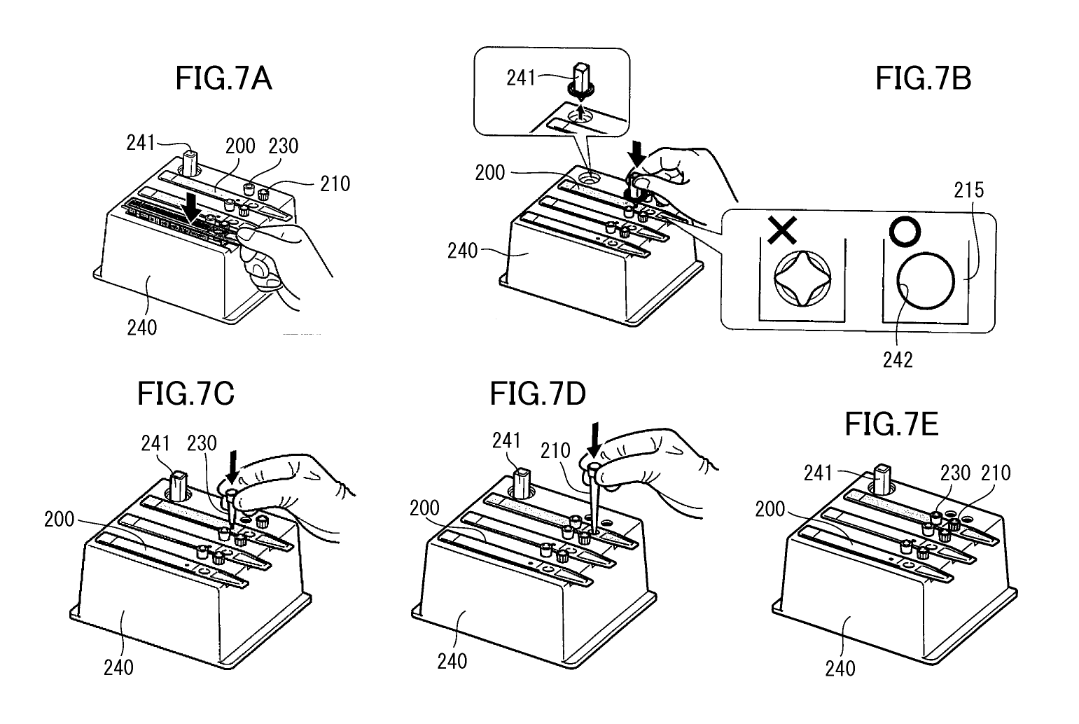

(1) A cartridge holder 240 includes each holding portion (a cartridge holding groove, a nozzle tip holding hole, and a capillary holding hole in this example) for the test cartridge 200, the nozzle tip 210, and the capillary 230, and the test cartridge 200, the nozzle tip 210, and the capillary 230 required to be used are held in the respective holding portions of the cartridge holder 240 (see FIG. 7A).

(2) Hole Formation of Test Cartridge 200

A hole-forming pin 241 is temporarily placed and accommodated in a part of the cartridge holder 240, and a temporary hole 242 is formed in a portion of the seal 215 corresponding to the specimen cell 203 of the test cartridge 200 through use of the hole-forming pin 241. In this case, a pin having a cross-shaped cross section is used as the hole-forming pin 241, and hence it is sufficient to rotate the hole-forming pin 241 so that the hole 242 has a circular shape after sticking and inserting the hole-forming pin 241 into the seal 215 (see FIG. 7B).

Note that, a mark indicating an insertion position of the hole-forming pin 241 is formed on a region corresponding to the specimen cell 203 of the seal 215 of the test cartridge 200, and thus the user can easily form a hole with the hole-forming pin 241.

(3) Capillary Set

Then, in order to collect a specimen, for example, the finger or the like is punctured with a puncturing tool (not shown), and the capillary portion 232 of the capillary 230 is brought into contact with a blood collection portion to collect a predetermined amount (from 1 μL to 2 μL) of the blood into the capillary portion 232 through a capillary phenomenon.

After that, it is sufficient that the capillary 230 having collected the specimen be inserted into the hole 242 formed in the seal 215 of the test cartridge 200 without delay, and the capillary 230 be inserted to be set until the holding portion 233 abuts against the seal 215 on the periphery of the specimen cell 203 of the test cartridge 200 (see FIG. 7C).

(4) Nozzle Tip Set

Then, it is sufficient that the nozzle tip 210 be inserted to be held into the tip holding hole 208 of the test cartridge 200 (see FIG. 7D).

(5) Completion of Preliminary Preparation of Test Cartridge

In this state, the nozzle tip 210 and the capillary 230 are set on the test cartridge 200, and thus the preliminary preparation of the test cartridge 200 is completed (see FIG. 7E).

The other test cartridges 200 may also be subjected to the preliminary preparation described in (1) to (4).

<Overview of Component of Automatic Analysis Device>

FIG. 8 is an explanatory view for illustrating main components of the automatic analysis device.

In FIG. 8, there are illustrated the operation panel 23; the printer 25; the test cartridge 200; a cartridge holding mechanism 30 (corresponding to an X unit) in which a plurality of (three in this example) the test cartridges 200 are set, which moves along a width direction (X-axis direction) seen from a front side of the device housing 21 and transfers the test cartridge 200 to a predetermined position in accordance with the start and the end of measurement; a cartridge conveyance mechanism 50 (corresponding to a Y unit) that conveys the test cartridge 200 held by the cartridge holding mechanism 30 along a Y-axis direction (corresponding to the front-back direction of the device housing 21) orthogonal to the X-axis direction; a specimen and reagent dispensing mechanism 70 that dispenses a specimen and a reagent to the test cartridge 200; a constant-temperature reservoir 80 that keeps at least a part of the test cartridge 200 (corresponding to the reaction cell 207 in this example) under a constant-temperature condition; and a measurement device 100 that is arranged inside the constant-temperature reservoir 80 and measures the reaction between the specimen and the reagent dispensed into the reaction cell of the test cartridge 200.

In this example, the cartridge holding mechanism 30 enables the test cartridge 200 to be moved along the X-axis direction with an X-motor (not shown) (a stepping motor is used in this example).

Further, the cartridge conveyance mechanism 50 enables the test cartridge 200 to be moved along the Y-axis direction with a Y-motor 55 (a stepping motor is used in this example).

Further, the specimen and reagent dispensing mechanism 70 (corresponding to a Z unit) includes the nozzle head 71 that moves upward or downward along a Z-axis direction orthogonal to the X-axis direction and the Y-axis direction and is configured to suck and discharge the reagent and the specimen to a previously-determined dispensing position BP. Herein, a syringe pump 72 is driven by a pump motor 73 to perform sucking and discharging operations with the nozzle head 71. A Z-motor 74 moves the nozzle head 71 upward or downward along the Z-axis direction. A nozzle remover 75 is used for removing the nozzle tip 210 mounted on the nozzle head 71.

Further, in this embodiment, a barcode reader 110 is mounted in the device housing 21, and further various sensors S1 to S5 (described later in detail) and the like are arranged therein.

Note that, a master curve card 29 storing calibration curve information on each reagent lot is inserted into the device housing 21, for example, through an insertion port 22a formed in the door 22 of FIG. 3 and the barcode reader 110 previously mounted in the device housing 21 is caused to read the information on each reagent lot to perform calibration.

<Control System of Automatic Analysis Device>

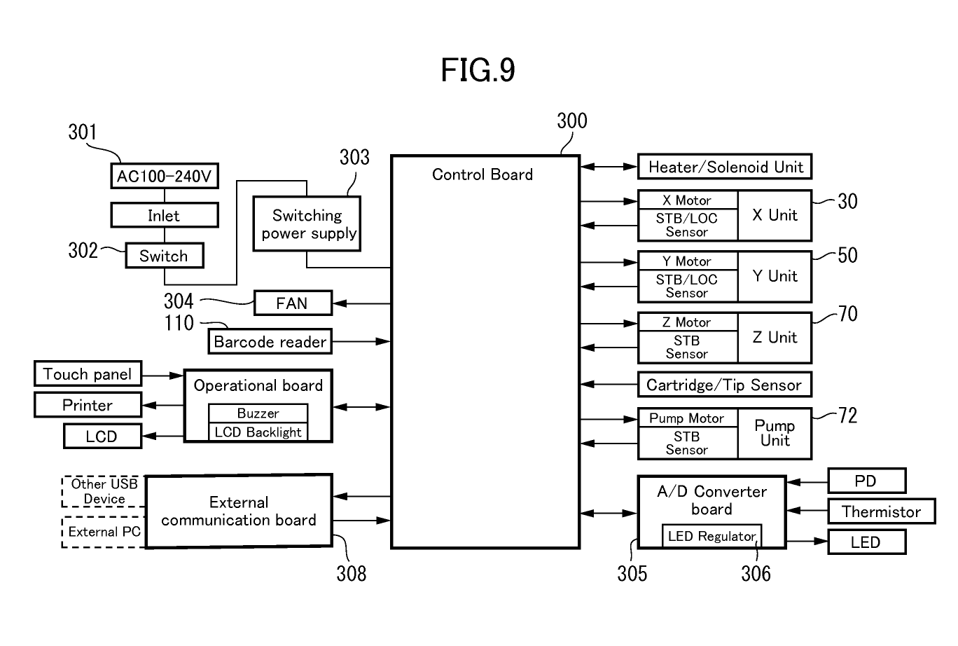

FIG. 9 is a view for illustrating a control system of the automatic analysis device.

In FIG. 9, a control board 300 serving as a control portion of a control device is illustrated. When a power source switch 302 is turned on in response to electric power from a commercial power source 301, a DC voltage is supplied to the control board 300 through a switching power supply 303.

Further, the operation panel 23 (including a touch key panel and an LCD) and the printer 25 communicate information with the control board 300 through an operational board, and the information read by the barcode reader 110 and information from a cartridge/tip sensor for detecting the presence/absence of the test cartridge 200 and the nozzle tip 210 are input to the control board 300. The control board 300 is configured to send a drive control signal to a fan 304 mounted in the device housing 21 during operation of the automatic analysis device 20.

Further, analog information from a thermistor, a photodiode (PD), and the like is input to the control board 300 through an A/D converter board 305, and a control signal from the control board 300 is sent to a light source such as an LED through an LED regulator 306.

Further, the control board 300 and a solenoid (a heater/solenoid unit) that drives a heater serving as a heating source of the constant-temperature reservoir 80 and the nozzle remover 75 interact with each other in accordance with a constant-temperature reservoir control program and a test processing program by the test cartridge 200.

Further, in the control board 300, the X unit (corresponding to the cartridge holding mechanism 30), the Y unit (corresponding to the cartridge conveyance mechanism 50), the Z unit (corresponding to the specimen and reagent dispensing mechanism 70), and a pump unit (corresponding to the syringe pump 72), information from the sensors incorporated in the respective units is input, and the drive control signal is sent to the motors (corresponding to the X-motor (not shown), the Y-motor 55, the Z-motor 74, and the pump motor 73 in FIG. 8) for driving the respective units in accordance with the test processing program of the test cartridge 200.

Note that, in FIG. 9, “STB” is an abbreviation of “Standby Sensor”, and “LOC” is an abbreviation of “Location Sensor”. Further, an external communication board 308 enables information communication with a USE (Other USE Device) and an external personal computer (External PC).

<Formation of Device Configuration into Unit>

In this embodiment, the main components of the automatic analysis device 20 are formed into a unit.

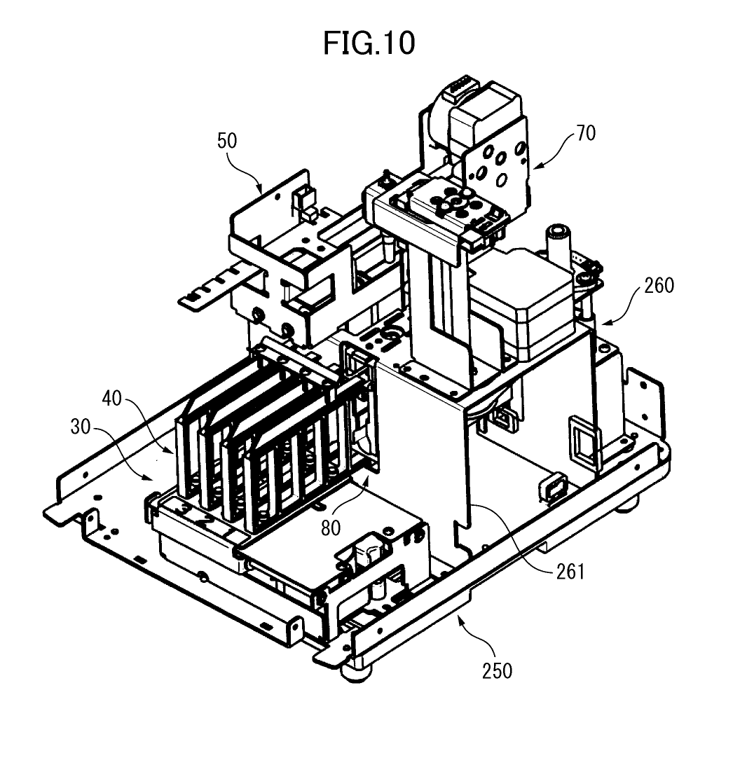

That is, in this example, as illustrated in FIG. 10, the automatic analysis device 20 includes the X unit (corresponding to the cartridge holding mechanism 30) and a YZ unit 260 incorporated onto a bottom plate unit 250 of the device housing 21.

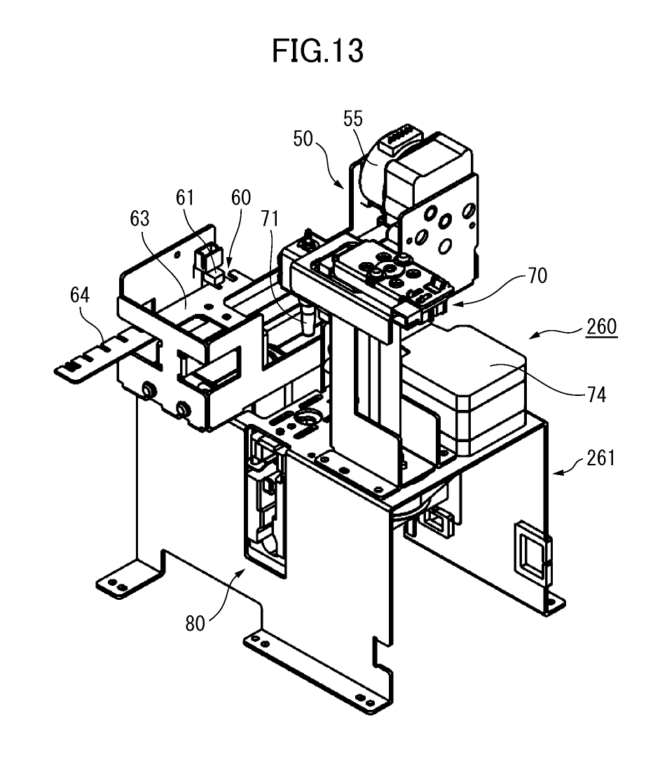

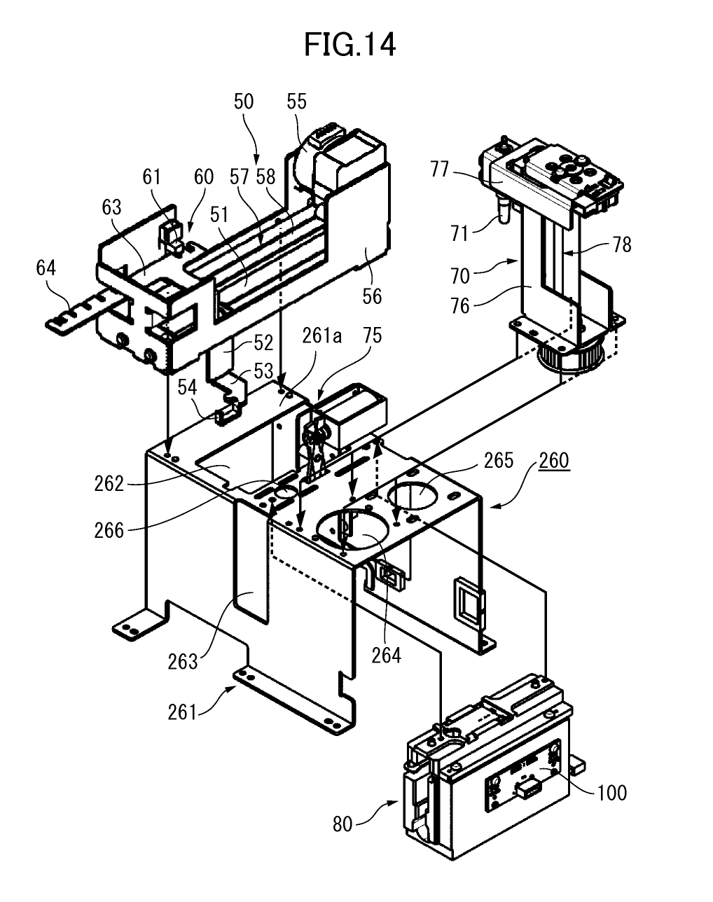

In this case, as illustrated in FIG. 13 and FIG. 14, the YZ unit 260 is formed into a unit by incorporating the cartridge conveyance mechanism 50 serving as the Y unit, the specimen and reagent dispensing mechanism 70 serving as the Z unit, and the constant-temperature reservoir 80 (including the measurement device 100 in this example).

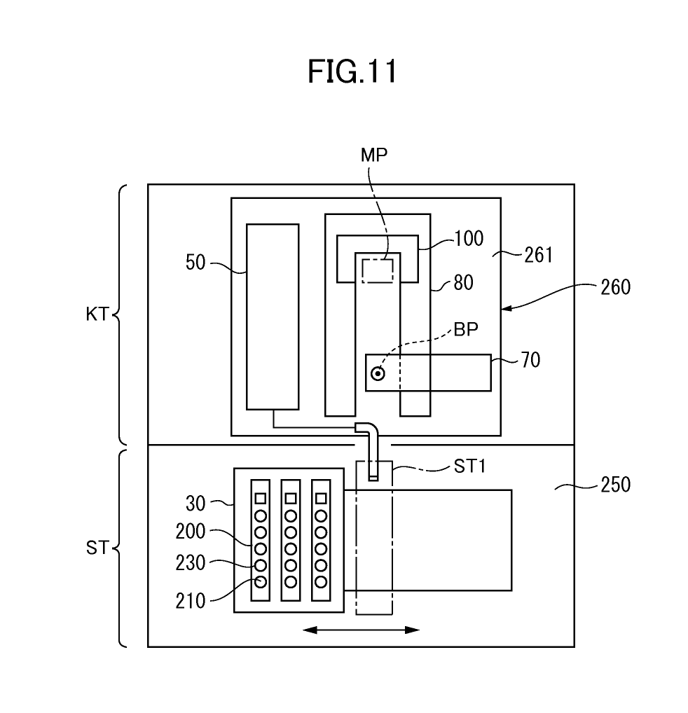

Then, in this example, as illustrated in FIG. 11, the automatic analysis device 20 includes, in the device housing 21, a set stage ST in which the test cartridge 200 is to be set, and a test stage KT, which is arranged so as to be adjacent to the set stage ST, for analyzing and testing the specimen of the test cartridge 200, and the bottom plate unit 250 is integrated so as to extend from the set stage ST to the test stage KT.

<X Unit>

As illustrated in FIG. 10 to FIG. 12B, the cartridge holding mechanism 30 serving as the X unit includes an X-table 31 that moves along the width direction (X-direction) of the device housing 21 on the bottom plate unit 250 of the device housing 21, and the cartridge rack 40 capable of holding the test cartridge 200 is arranged on the X-table 31. Thus, the test cartridge 200 is successively moved to a previously-determined test initial position ST1.

In this case, the X-table 31 has such a support structure that a support frame 32 is mounted on a bottom portion of the device housing 21, and a guide rail 33 extending in the X-direction is bridged over the support frame 32 so that the X-table 31 is slidably supported along the guide rail 33. Further, the position of the X-table 31 is regulated by a known procedure using a positional sensor (not shown) or positional control using a drive motor (corresponding to the X-motor) such as a stepping motor.

—Cartridge Rack—

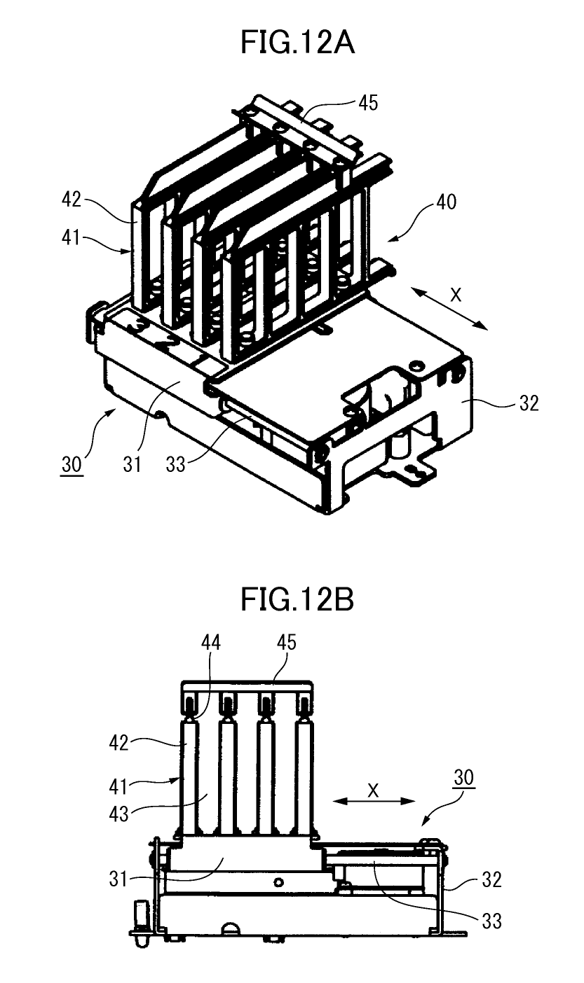

Further, in this embodiment, as illustrated in FIG. 10, FIG. 12A, and FIG. 12B, the cartridge rack 40 has a plurality of rack holders 41 capable of holding a plurality of (three in this example) the test cartridges 200. The rack holder 41 has a slit 43 extending in the Y-direction orthogonal to the X-direction between a pair of holder legs 42, and slit edge portions serve as support surfaces 44. The support surfaces 44 support both side edge portions in a width direction of the cartridge main body 201 of the test cartridge 200.

In this example, the direction of the test cartridge 200 with respect to the cartridge rack 40 is uniquely determined. Therefore, from the viewpoint of preventing erroneous insertion of the test cartridge 200, the barcode 216 for confirming the insertion direction is engraved on one side edge along a longitudinal direction of the cartridge main body 201 in the seal 215 of the test cartridge 200.

Thus, in this example, in the case where the test cartridge 200 is inserted in a correct insertion direction, the barcode 216 can be read accurately by the barcode reader 110. In contrast, if the test cartridge 200 is erroneously inserted into the cartridge rack 40, the barcode 216 of the test cartridge 200 moves to a side edge on an opposite side of the cartridge main body 201, and hence the barcode 216 cannot be read by the barcode reader 110. Therefore, based on the fact that the barcode 216 cannot be read by the barcode reader 110, it is understood that the insertion direction of the test cartridge 200 is opposite.

Note that, a gap adjusting member 45 for keeping a gap between the holder legs 42 of the cartridge rack 40 is bridged over a plurality of the holder legs 42 of the cartridge rack 40 so as to be orthogonal to the holder legs 42.

<YZ Unit>

As illustrated in FIG. 10, the YZ unit 260 includes a unit frame 261 formed of a channel material having a substantially inverse U-shape in cross section, and mounted on the bottom plate unit 250, and the Y unit, the Z unit, and the constant-temperature reservoir 80 (including the measurement device 100) are mounted on the unit frame 261 so as to have a predetermined positional relationship.

### <Y Unit (Cartridge Conveyance Mechanism)>

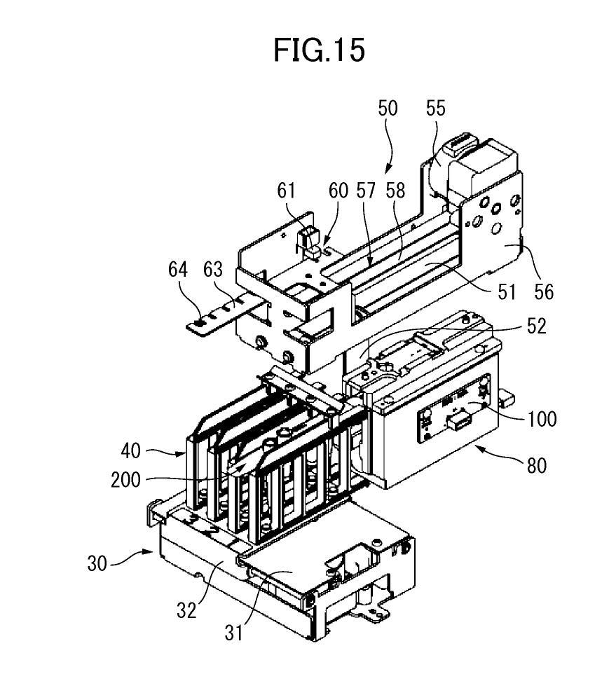

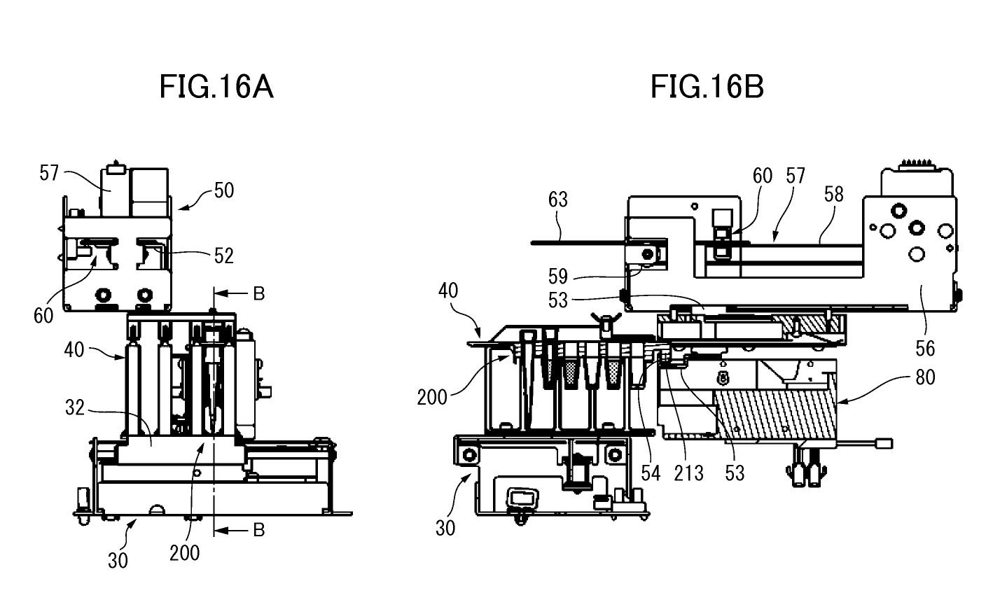

As illustrated in FIG. 14 to FIG. 16B, the cartridge conveyance mechanism 50 serving as the Y unit includes a support bracket 56 that is to be mounted on the unit frame 261 through use of a stopper (not shown), and the support bracket 56 has a guide track 51 extending in the Y-direction and a Y-table 52 movable along the guide track 51. The Y-table 52 includes a locking arm 53 extending toward the set stage ST side, and a locking piece 54 protruding upward is arranged at a tip end of the locking arm 53. The locking piece 54 is removably engaged with the piece 213 to be engaged of the test cartridge 200.

In this example, an opening portion 262 is formed in a top portion 261a of the unit frame 261 so that a part of the Y-table 52, the locking arm 53, and the locking piece 54 of the cartridge conveyance mechanism 50 are arranged in the top portion. Further, a passage port 263 through which the test cartridge 200 can pass is formed in a vertical wall portion close to the set stage ST of the unit frame 261. The locking arm 53 and the locking piece 54 of the cartridge conveyance mechanism 50 are arranged so as to protrude toward the set stage ST side from the passage port 263 and engaged with the test cartridge 200 positioned on the set stage ST. Thus, the test cartridge 200 is pulled into the test stage KT side.

In particular, in this embodiment, the piece 213 to be engaged of the test cartridge 200 has a recessed portion 218 (see FIG. 5D) passing therethrough in the X-direction. Thus, the X-table 31 moves to an appropriate position without the interference between the piece 213 to be engaged of the test cartridge 200 and the locking piece 54 of the cartridge conveyance mechanism 50 along with the movement of the X-table 31, and the test cartridge 200 moved and set to the test initial position ST1 has a positional relationship in which the piece 213 to be engaged is engaged with the locking piece 54 of the cartridge holding mechanism 50.

Further, a drive system of the Y-table 52 is configured as follows. The Y-motor 55 serving as a drive source is fixed to the support bracket 56, and a drive force from the Y-motor 55 is transmitted to the Y-table 52 through a drive transmission mechanism 57. Thus, the Y-table 52 is allowed to move forward or backward along the guide track 51.

In this case, the drive force transmission mechanism 57 may be appropriately selected. For example, there is given the following. A moving belt 58 that circulates and rotates along a movement direction of the Y-table 52 is bridged over pulleys 59, and one end portion of the locking arm 53 is fixed to the moving belt 58. A drive force from the Y-motor 55 is transmitted to the moving belt 58 through a drive pulley (not shown), and the moving belt 58 is moved forward or backward to allow the Y-table 52 to move forward or backward.

Note that, as the drive system of the Y-table 52, the Y-motor 55 is arranged on the support bracket 56 in a fixed manner, but needless to say, the Y-table 52 having the Y-motor 55 and the support bracket 56 mounted thereon may be configured in a self-propelled manner.

Further, for example, as illustrated in FIG. 14 to FIG. 16B, a position stop mechanism 60 of the Y-table 52 is configured as follows. A positioning detector 61 formed of, for example, a photo coupler is arranged in a predetermined region of the support bracket 56. A sensor plate 63 extending in a direction of forward/backward movement is mounted on the Y-table 52, and sensor slits 64 for positioning are formed at a predetermined pitch on the sensor plate 63. A predetermined position of the sensor plate 63 is detected by the positioning detector 61, and thus the forward/backward movement of the Y-table 52 is regulated to control the pull-in position of the test cartridge 200.

<Z Unit (Specimen and Reagent Dispensing Mechanism)>

As the specimen and reagent dispensing mechanism 70 serving as the Z unit, any known mechanism may be appropriately selected as long as the mechanism dispenses a specimen and a reagent. For example, as illustrated in FIG. 14, FIG. 17A, and FIG. 17B, the following configuration can be used. A support platform 76 extending in the Z-direction orthogonal to the X-direction and the Y-direction is fixed to the top portion of the unit frame 261 through use of a stopper (not shown), and a lifting platform 77 that moves forward or backward along the Z-direction is arranged on the support platform 76 through intermediation of a drive transmission mechanism 78. The nozzle head 71 is mounted on the lifting platform 77, and the nozzle tip 210 is detachably mounted on the nozzle head 71.

Note that, a drive gear 78a that is a part of the drive transmission mechanism 78 and the Z-motor 74 (see FIG. 8) are arranged on a rear side of the top portion of the unit frame 261, and mounting holes 264 and 265 required for arranging the drive gear 78a and the Z-motor 74 (see FIG. 8) are formed in the top portion of the unit frame 261. Further, in the top portion of the unit frame 261, a circular dispensing opening 266 through which the nozzle tip 210 and the capillary 230 can pass is formed at a previously-determined dispensing position BP.

In this embodiment, as illustrated in FIG. 8, FIG. 17A, and FIG. 17B, the specimen and reagent dispensing mechanism 70 is configured as follows. The test cartridge 200 is pulled into a predetermined position by the cartridge conveyance mechanism 50 serving as the Y unit so as to arrange the dispensing target cell 202 of the test cartridge 200 at the dispensing position BP of the specimen and reagent dispensing mechanism 70. After that, by switching the syringe pump 72 to a negative pressure or a positive pressure, a predetermined amount of the specimen and the reagents is sucked and held from the predetermined cells 202 (the specimen cell 203 and the reagent cells 204 and 206) in the test cartridge 200, and thus a predetermined amount of the specimen and the reagents is discharged into the reaction cell 207 to be measured.

In this case, needless to say, the specimen and reagent dispensing mechanism 70 may adopt a system of sucking and discharging the specimen or the reagents individually. Alternatively, an air layer may be interposed in the nozzle tip 210 so that the specimen and the reagents or a plurality of the reagents are simultaneously sucked and held and then discharged.

Note that, in this embodiment, the specimen and reagent dispensing mechanism 70 serves to perform both a specimen dispensing operation and a reagent dispensing operation, but a specimen dispensing mechanism and a reagent dispensing mechanism may be arranged separately. Further, in this embodiment, although the disposable nozzle tip 210 is used, the nozzle tip 210 is not limited thereto, and needless to say, a system of using a dedicated nozzle and cleaning the dedicated nozzle without using the nozzle tip 210 may be adopted.

<Z Unit (Hole-Forming Device)>

In this embodiment, each cell 202 of the test cartridge 200 is covered with the seal 215. Therefore, before the specimen and reagent dispensing operation is performed by the specimen and reagent dispensing mechanism 70, holes for insertion are formed in the seal 215 so that the nozzle tip 210 of the specimen and reagent dispensing mechanism 70 can be inserted into the test cartridge 200.

Under such a demand, this embodiment adopts a procedure of using the specimen and reagent dispensing mechanism 70 serving as the Z unit also as a hole-forming device.

That is, during a hole-forming operation, the specimen and reagent dispensing mechanism 70 forms a hole in the seal 215 through use of the nozzle tip 210 as a hole-forming tool with respect to positions of the seal 215 corresponding to the cells 202 (the specimen cell 203, the reagent cells 204 and 206, and the reaction cell 207) that can be used among the respective cells 202 of the test cartridge 200.

In this embodiment, a hole-forming method and the like of the specimen and reagent dispensing mechanism 70 also serving as the hole-forming device may be appropriately selected as long as the mechanism forms a hole in the seal 215. In this embodiment, the hole-forming device forms a plurality of holes in each of the seal 215 portions corresponding to the cells 202 to be used. A detailed description is made later.

Note that, in this embodiment, the specimen and reagent dispensing mechanism 70 also serves as the hole-forming device, but the specimen and reagent dispensing mechanism 70 is not necessarily limited to an aspect of using the nozzle tip 210 as the hole-forming tool. For example, the following may be performed. A hole-forming tool is mounted in a part of the lifting platform 77 of the specimen and reagent dispensing mechanism 70, and a hole is formed in the seal 215 of the test cartridge 200 through use of the hole-forming tool. Further, the following may also be performed. A dedicated hole-forming device is arranged separately from the specimen and reagent dispensing mechanism 70, and a hole is formed in the seal 215 of the test cartridge 200 by the hole-forming device.

<Constant-Temperature Reservoir>

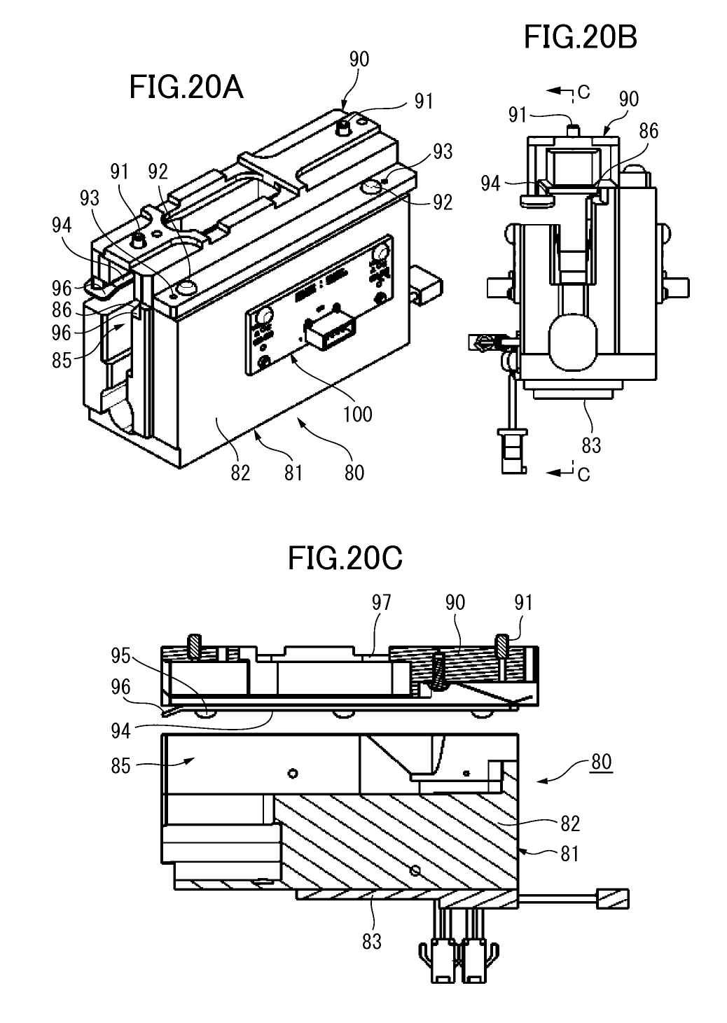

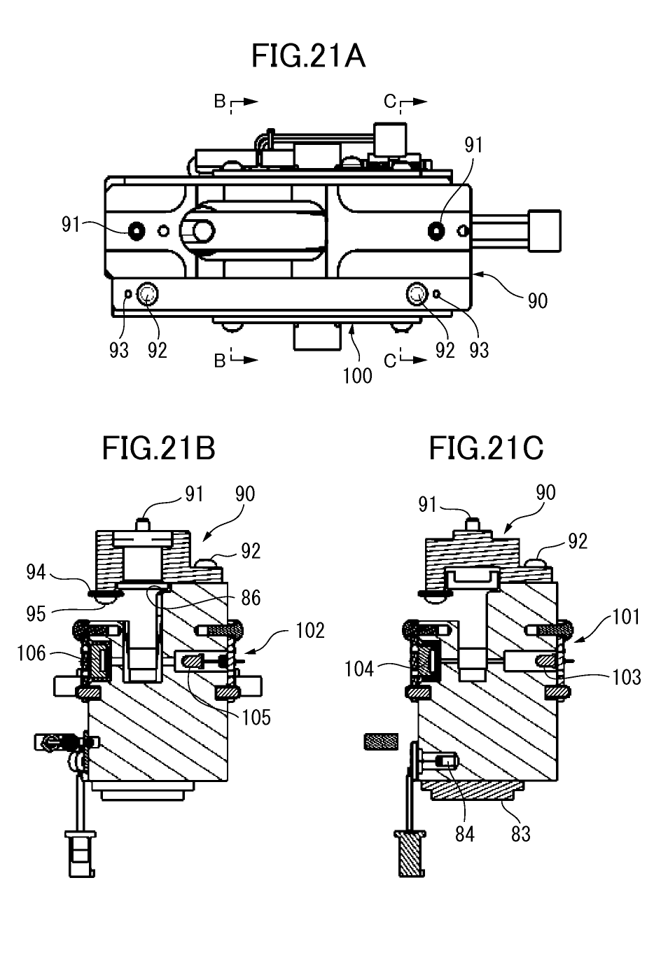

In this embodiment, as illustrated in FIG. 14, FIG. 20A to FIG. 20C, and FIG. 21A to FIG. 21C, the constant-temperature reservoir 80 is fixed to the rear side of the top portion of the unit frame 261 through use of a stopper (not shown).

In this example, the constant-temperature reservoir 80 includes, for example, a constant-temperature block 81 formed of aluminum and a heat retaining cover 90 covering an upper portion of the constant-temperature block 81.

### —Constant-Temperature Block—

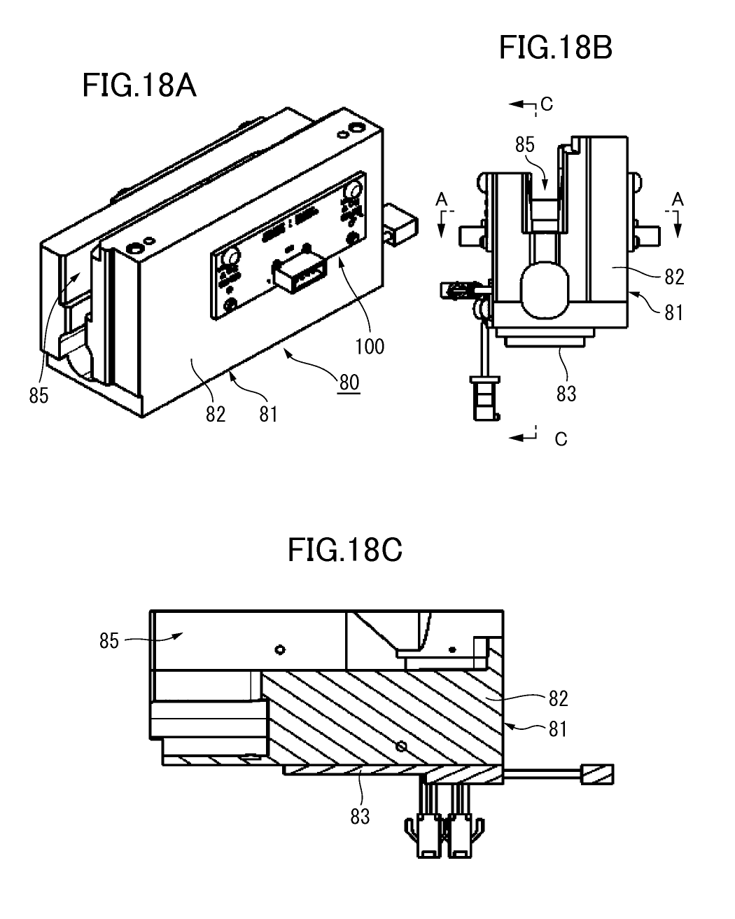

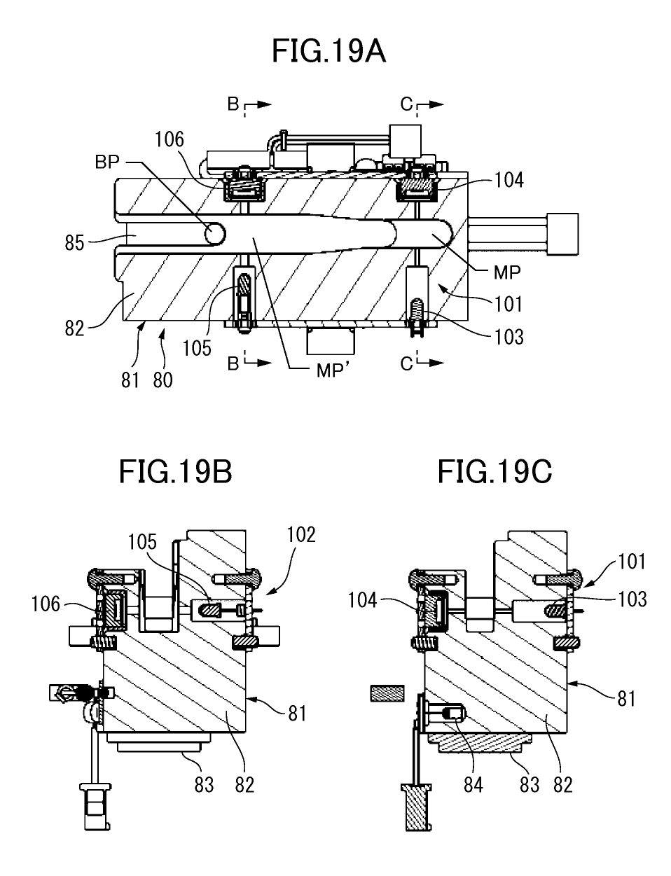

In this example, the basic configuration of the constant-temperature block 81 is as follows. As illustrated in FIG. 18A to FIG. 18C and FIG. 19A to FIG. 19C, the constant-temperature block 81 has a conveyance path 85 having a substantially U-shape in cross section, and includes a block main body 82 in which the test cartridge 200 can move forward or backward in the Y-direction along the conveyance path 85, a heater (for example, a silicone rubber heater) 83 that is mounted on a bottom surface of the block main body 82 and heats the block main body 82, and a temperature detector 84 formed of, for example, a thermistor arranged in a part of the block main body 82. The heater 83 is controlled to be turned on/off so as to keep a predetermined constant-temperature condition (for example, 37° C.) by monitoring the temperature information from the temperature detector 84.

In this case, the arrangement position of the temperature detector 84 may be appropriately selected. In this example, as illustrated in FIG. 19C, the temperature detector 84 is arranged in the vicinity of a measurement position MP of the measurement device 100 in the block main body 82 and is arranged between the reaction cell 207 of the test cartridge 200 and the heater 83. This arrangement position is preferred because the heat from the heater 83 is transmitted to the reaction cell 207 through the block main body 82, with the result that the temperature close to the constant temperature on the periphery of the reaction cell 207 at the measurement position MP is detected.

Note that, it is preferred that the constant-temperature block 81 be designed so that the periphery of the block main body 82 be covered with a heat insulating material as necessary to suppress the unnecessary release of heat from the constant-temperature block 81.

—Heat Retaining Cover and Constant-Temperature Reservoir—

In this example, the heat retaining cover 90 is fixed to the rear side of the top portion 261a of the unit frame 261 through use of a plurality of stoppers 91 at a position covering an upper portion of the constant-temperature block 81.

The heat retaining cover 90 has a size corresponding to a longitudinal direction and a width direction of the constant-temperature block 81, and is positioned in one top portion of the constant-temperature block 81 through use of positioning pins 92, and fixed thereto through use of a plurality of stoppers 93.

Further, in a region of the heat retaining cover 90 opposed to the other top portion of the constant-temperature block 81, a cartridge receiving plate 94 extending in the Y-direction is fixed through use of a stopper 95, and a guide groove 86 extending in the Y-direction is formed at an inner side edge of the top portion on the opposite side of the constant-temperature block 81. Thus, both side edges extending in the Y-direction of the cartridge main body 201 of the test cartridge 200 are guided while sliding along the cartridge receiving plate 94 and the guide groove 86 of the constant-temperature reservoir 80.

In this case, considering that there is a step difference between the cartridge receiving plate 94 of the constant-temperature reservoir 80 and the cartridge rack 40 and between the guide groove 86 of the constant-temperature reservoir 80 and the cartridge rack 40, chamfered portions 96 are formed in end portions close to the set stage ST side of the cartridge receiving plate 94 and the guide groove 86 of the constant-temperature reservoir 80. Thus, both side edges of the cartridge main body 201 of the test cartridge 200 conveyed to the test stage KT side by the cartridge conveyance mechanism 50 are guided smoothly through the chamfered portions 96 to the cartridge receiving plate 94 and the guide groove 86 of the constant-temperature reservoir 80.

Note that, the dispensing position BP and a long hole 97 for enabling the removal of the nozzle tip 210 by the nozzle remover 75 are formed in the heat retaining cover 90.

<Measurement Device>

Further, in this embodiment, as illustrated in FIG. 19A to FIG. 19C, FIG. 20A to FIG. 20C, and FIG. 21A to FIG. 21C, the measurement device 100 is incorporated into the constant-temperature block 81 of the constant-temperature reservoir 80. When the reaction cell 207 of the test cartridge 200 is arranged at the previously-determined measurement position MP, the measurement device 100 measures the reaction between the specimen and the reagents in the reaction cell 207.

The measurement device 100 includes a first measurement portion 101 arranged at positions interposing the previously-determined measurement position MP therebetween, and a second measurement portion 102 that is arranged at a measurement position MP′ different from the measurement position MP and measures, for example, Hb of the diluted solution of the specimen in the specimen cell 202 of the test cartridge 200 conveyed to the test stage KT.

In this case, the first measurement portion 101 includes a light-emitting element 103 formed of, for example, an infrared LED and a light-receiving element 104 formed of, for example, a photodetector arranged in a region opposed to the light-emitting element 103 with the measurement position MP interposed therebetween. Further, the second measurement portion 102 has such a configuration that a light-emitting element 105 and a light-receiving element 106 are arranged so as to be opposed to each other with the measurement position MP′ interposed therebetween substantially in the same way as in the first measurement portion 101.

In this example, the second measurement portion 102 is arranged besides the first measurement portion 101. Therefore, when the cell 202 other than the reaction cell 207 is also measured, this example is preferred in that the movement span of the test cartridge 200 in the Y-direction can be shortened compared to the case of measuring the reaction between a specimen and a reagent in the cell 202 and the state (for example, absorbance) of the reagent and the specimen at one measurement position MP.

<Configuration of Device Housing>

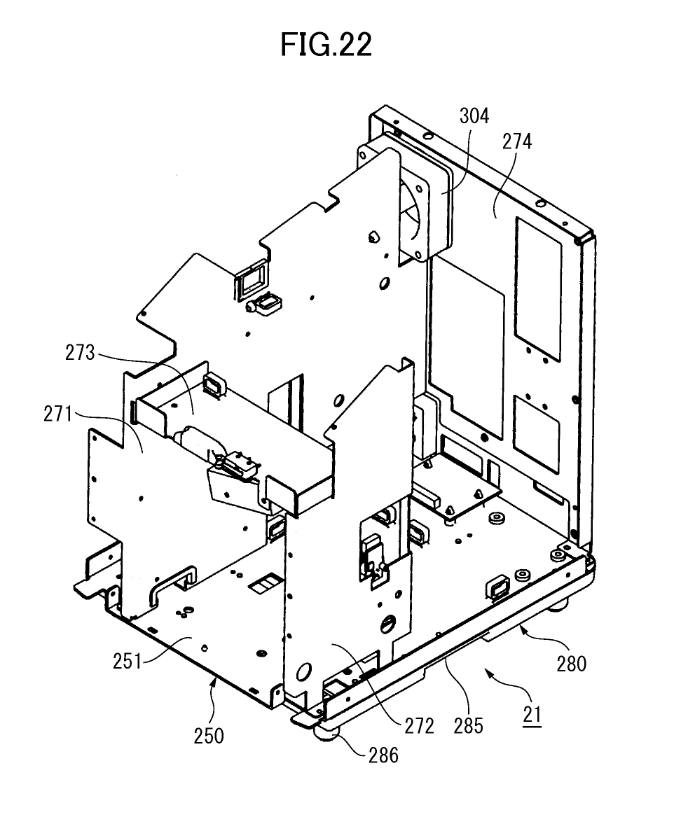

In this embodiment, as illustrated in FIG. 22, the device housing 21 includes the bottom plate unit 250, a left side plate 271 incorporated into a left side of the bottom plate unit 250, a right side plate 272 incorporated into a right side of the bottom plate unit 250, a door holding plate 273 that is bridged over the left side plate 271 and the right side plate 271 and holds the door 22 (see FIG. 4A, FIG. 4B, and FIG. 4C) when closed, and a back plate 274 incorporated into a back surface of the bottom plate unit 250, and an exterior decorative plate is arranged on the periphery of those members.

In this example, the fan 304 for exhaust is mounted in an upper portion of the back plate 274 close to the left side plate 271.

Further, in this embodiment, the left side plate 271 is arranged so as to be displaced to an inner side from a left side end of the bottom plate unit 250, and the control board 300, a power source board, and the like are arranged in an area outside of the left side plate 271.

<Bottom Plate Unit>

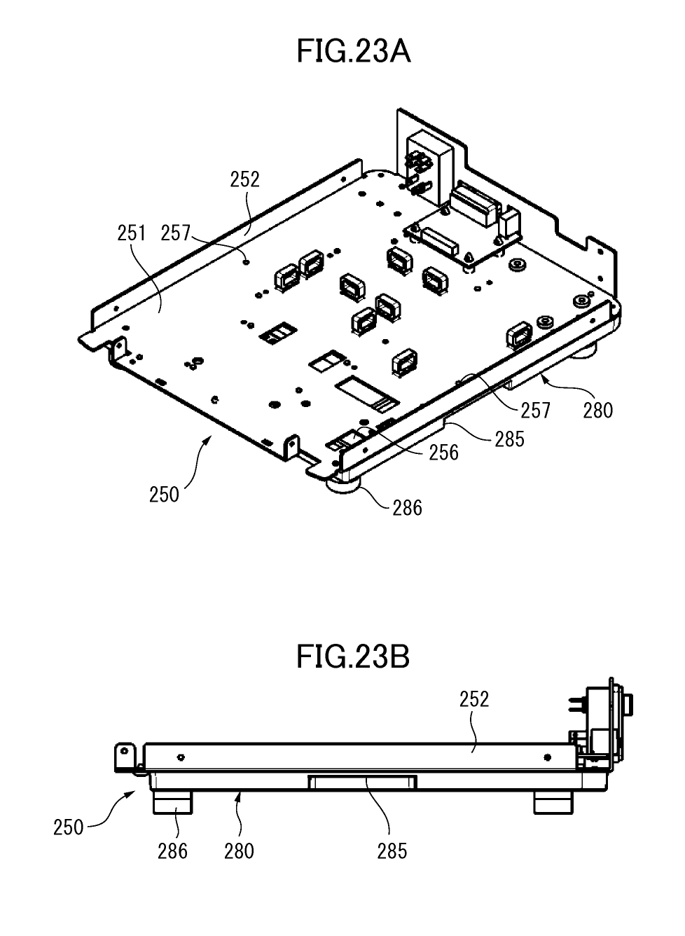

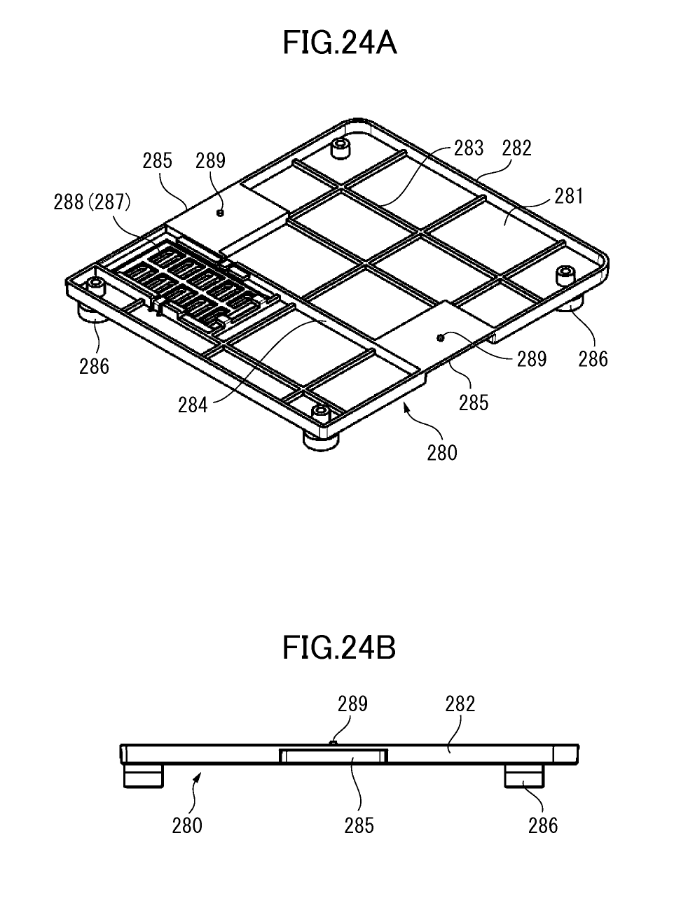

In this embodiment, as illustrated in FIG. 23A, FIG. 23B, FIG. 24A, and FIG. 24B, the bottom plate unit 250 includes a metallic bottom plate base member 251. Each flange portion 252 is formed so as to be bent on the right and left sides and the back side of the bottom plate base member 251, and an undercover 280 formed of a resin is arranged in a lower portion of the bottom plate base member 251.

In this case, as illustrated in FIG. 24A and FIG. 24B, the undercover 280 includes a bottom wall portion 281 having a substantially rectangular shape. The periphery of the bottom wall portion 281 is covered with a peripheral wall portion 282 having a low height, and a grid-like reinforcing rib 283 having a height lower than that of the peripheral wall portion 282 is formed on the bottom wall portion 281. Further, a partition wall 284, which has a height similar to that of the peripheral wall portion 282 and extends in the X-direction, is formed in a portion close to a front side of the bottom wall portion 281, and recessed portions 285 having an inverse U-shape in cross section are formed on both sides adjacent to the partition wall 284 in an area on a back side of the bottom wall portion 281 partitioned by the partition wall 284. Thus, the recessed portions 285 serve as gripping portions for lifting the automatic analysis device 20.

Further, support pads 286 formed of a synthetic resin or rubber are mounted at four corners of the undercover 280, and an air intake hole 287 is formed in a left portion of an area on the front side of the bottom wall portion 281 partitioned by the partition wall 284. A cleaning filter 288 is mounted in the air intake hole 287, and thus clean air can be taken in.

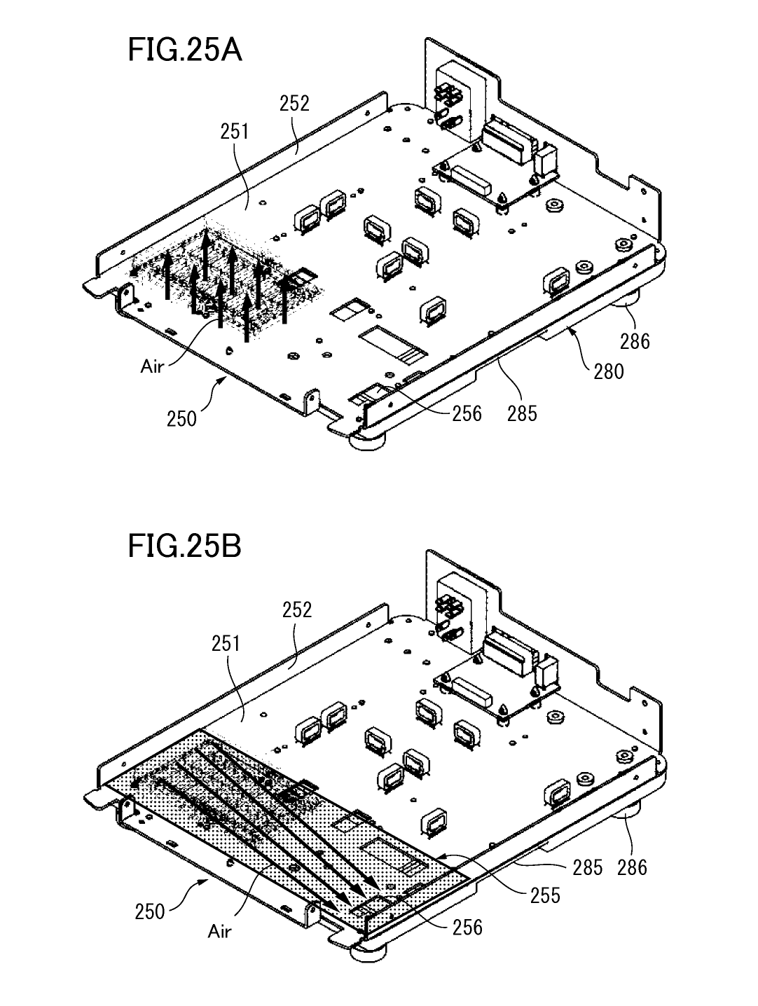

In this example, the bottom plate unit 250 has an air supply chamber 255 (see FIG. 25B) between the bottom plate base member 251 and the undercover 280, and an air introducing hole 256 is formed in a portion on the front side of the bottom plate base member 251 partitioned by the partition wall 284 of the undercover 280 and on the right side opposite to the air intake hole 287.

Herein, in this example, although the cleaning filter 288 is arranged in the air intake hole 287, a cleaning filter may be arranged as necessary in the air introducing hole 256 in addition to or in place of the cleaning filter 288.

Note that, a positioning hole 257 is formed in the bottom plate base member 251, and a positioning protrusion 289 is formed on the undercover 280 so as to be positioned in the positioning hole 257 of the bottom plate base member 251.

According to this embodiment, when the test cartridge 200 is set on the automatic analysis device 20, the fan 304 starts being driven.

In this state, in the bottom plate unit 250, external air is taken into the air supply chamber 255 from the air intake hole 287 through the cleaning filter 288, as illustrated in FIG. 25A.

After that, as illustrated in FIG. 25B, the air taken into the air supply chamber 255 flows in the X-direction through a space portion (an area denoted by the dots in FIG. 25B) on the front side of the partition wall 284 of the undercover 280. At this time, fine dust having passed through the cleaning filter 288 is stopped by the reinforcing rib 283 of the undercover 280. Therefore, the dust is accumulated in the undercover 280 and is unlikely to enter the device housing 21 from the bottom plate unit 250.

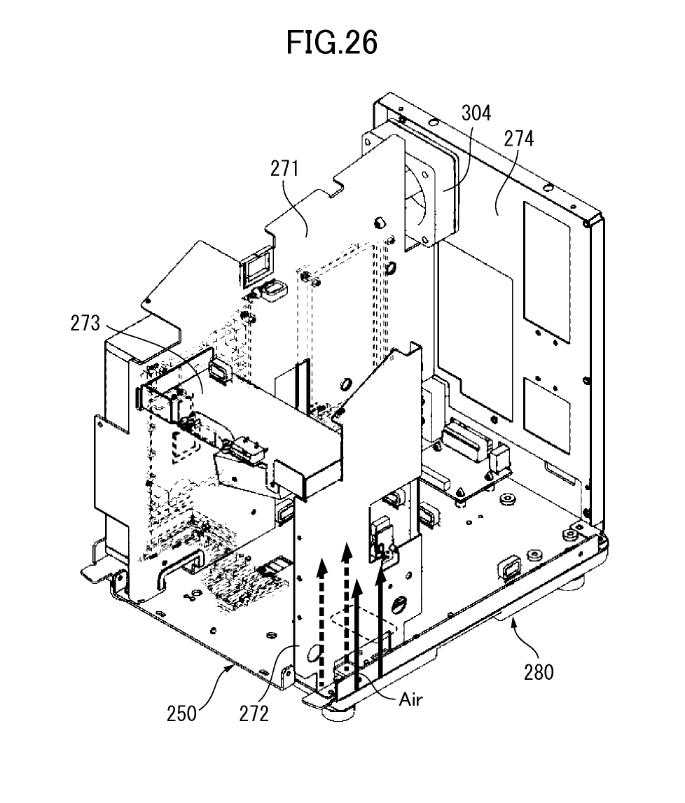

The air having passed through the inside of the undercover 280 of the air supply chamber 255 is introduced into the device housing 21 from the air introducing hole 256 of the bottom plate base member 251, as illustrated in FIG. 26.

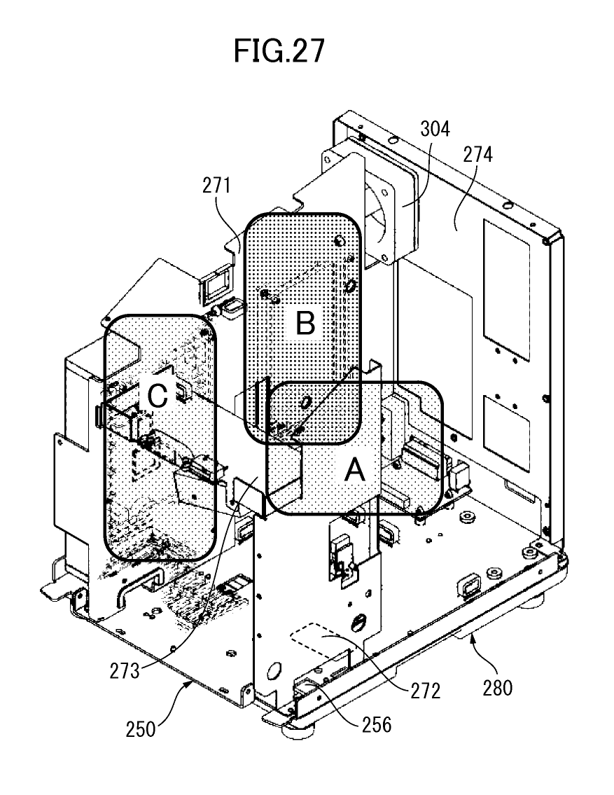

In this state, in the device housing 21, an arrangement area of the constant-temperature reservoir 80 (A-area), an arrangement area of the power source board (B-area), and an arrangement area of the control board (C-area) mainly serve as a heat source, as illustrated in FIG. 27, and hence warm air tends to be accumulated in an upper portion of the device housing 21 from those areas due to natural convection.

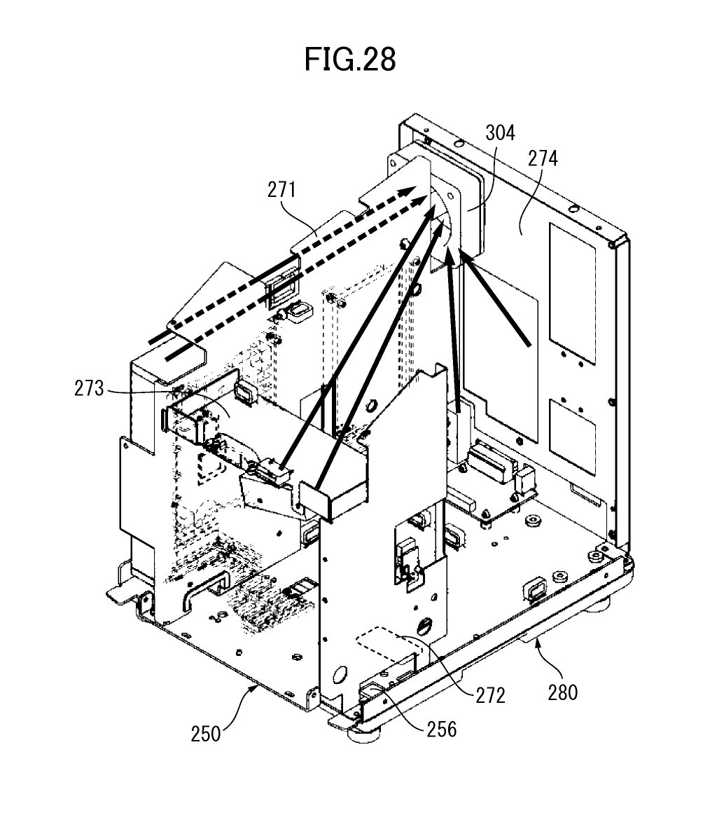

On the other hand, as illustrated in FIG. 28, the air in the device housing 21 is forcibly discharged by the fan 304.

In this state, in the device housing 21, the fan 304 and the air introducing hole 256 of the bottom plate unit 250 are arranged diagonally, and hence the air having been introduced into the device housing 21 from the air introducing hole 256 is separated into a flow component that flows from the set stage ST side via the left side plate 271 (denoted by the medium dotted line of FIG. 28) and a flow component that flows from the test stage KT side via an area between the left sideplate 271 and the right sideplate 272 (denoted by the solid line of FIG. 28). Thus, warm air is discharged substantially in a half-and-half ratio.

In this case, an area of the X unit 30 occupying the space portion in the device housing 21 is relatively small in the set stage ST, and hence an air stream passing through an outer area of the left side plate 271 via the set stage ST is ensured in a reasonably large amount.

In contrast, an area of the YZ unit 260 occupying the space portion in the device housing 21 is relatively large in the test stage KT. Therefore, the amount of an air stream directly passing through an arrangement area of the YZ unit 260 via the test stage KT is relatively small, and an air stream directed to the fan 304 along the right side plate 272 and the back plate 274 in the test stage KT is ensured in a reasonably large amount.

Therefore, in this embodiment, the environmental temperature in the set stage ST is controlled, and the warm air from the power source board and the control board is efficiently exhausted. Thus, there is a low risk in that the warm air in the vicinity of the constant-temperature reservoir 80 is exhausted unnecessarily.

<Sensors to be Used in Control System>

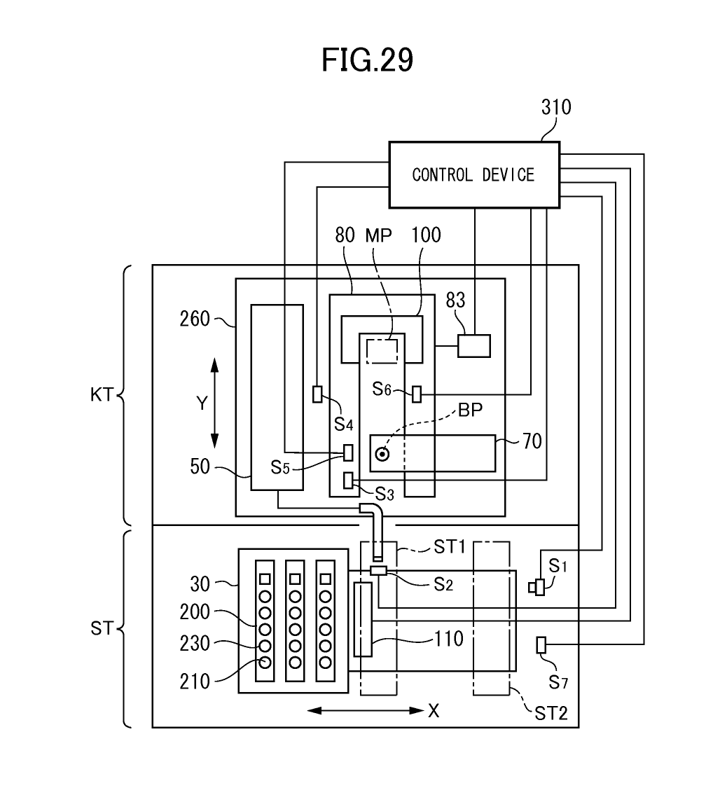

FIG. 29 is an explanatory diagram for illustrating sensors to be used in the control system of the automatic analysis device according to this embodiment.

In FIG. 29, a control device 310 is formed of a microcomputer. The control device 310 captures information from the power source switch, various operation sensors (the operation panel 23, a position detector, a state detector, etc.), and various temperature sensors, and performs control processing of the constant-temperature reservoir 80 with the heater 83. The control device 310 also performs operation control processing by various operation sources (drive control processing of the X unit and the Y unit, drive control and dispensing control processing of the Z unit, and measurement processing by the measurement device), and further performs printing control processing by the printer 25.

Now, the typical sensors S1 to S7 (the temperature detector and the state detector in this case) to be used in this embodiment are described. Note that, the sensors S1 to S5 are the same as those illustrated in FIG. 8.

S1: A liquid temperature detector that is arranged on the set stage ST and detects a liquid temperature of a reagent (or a diluent for a specimen) of the test cartridge 200

S2: A cartridge presence/absence detector for detecting the presence/absence of the test cartridge 200 at the test initial position ST1

S3: A tip presence/absence detector for detecting the presence/absence of the nozzle tip 210 of the test cartridge 200

S4: A temperature detector for detecting an internal environmental temperature in the test stage KT

S5: A presence/absence detector for detecting whether or not the capillary 230 or the nozzle tip 210 has been removed from the nozzle head 71 of the specimen and reagent dispensing mechanism 70 serving as the Z unit

S6: A temperature detector for detecting a temperature of the constant-temperature reservoir 80 (corresponding to reference symbol 84 in FIG. 19C and FIG. 21C)

S7: A temperature detector for detecting an internal environmental temperature in the set stage ST

<Liquid Temperature Detector S1>

In this example, the liquid temperature detector S1 detects, for example, a temperature of a reagent or a diluent previously accommodated in the reagent cell 206 (or the reagent cell 204 or the specimen cell 203) of the test cartridge 200, and for example, a thermopile 400 is used.

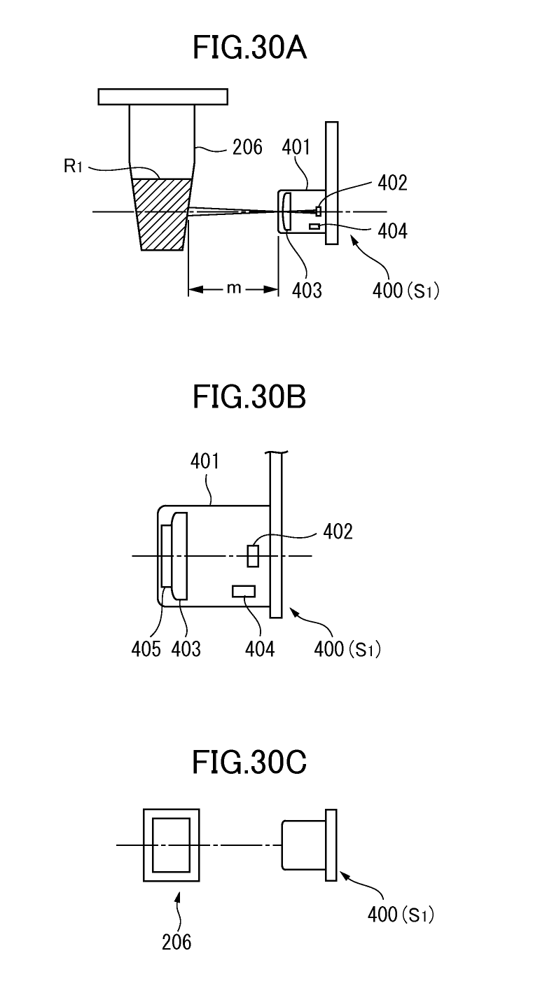

It is sufficient that the thermopile 400 be set, for example, at a position away from the reagent cell 206 by a predetermined distance m (for example, about 5 mm) as illustrated in FIG. 30A.

In this case, a liquid temperature detection position ST2 of the thermopile 400 may be the same as the test initial position ST1 or may be set separately from the test initial position ST1. The liquid temperature detection position ST2 of the thermopile 400 may be appropriately set. For example, as illustrated in FIG. 29, the liquid temperature detection position ST2 of the thermopile 400 may be set at a position located further away from the test initial position ST1 in the X-direction. In particular, when the liquid temperature detection position ST2 is set in a region close to the air introducing hole 256 of the bottom plate unit 250, the air taken into the vicinity of the thermopile 400 flows while forming an air stream, and hence the temperature in the vicinity of the thermopile 400 is kept around at the external air temperature (see FIG. 26).

In general, as illustrated in FIG. 30B, the thermopile 400 includes a thermopile element 402 in a sensor housing 401, and detects, for example, a heat ray radiated from the reagent (or the diluent) with the thermopile element 402. In this example, a focusing lens 403 having a small view angle (for example, a lens having a view angle of 5° is used) is arranged in the vicinity of a heat ray inlet of the sensor housing 401, and the radiated heat ray is focused onto the thermopile element 402 through the focusing lens 403.

Further, in this example, a temperature detection element 404 formed of a thermistor is included in the thermopile 400, and the temperature detection element 404 can also serve as the temperature detector S7.

Further, the frequency (wavelength) of the heat ray radiated from the reagent (for example, R1) in the reagent cell 206 varies depending on temperature, and hence a filter 405 allowing only a required frequency (wavelength) to pass may be arranged.

Herein, the relationship between the temperature and the wavelength radiated from an object is represented by Wien's law.

λmax=2897.8/K

where Δmax: peak wavelength (μm)

K: absolute temperature (kelvin)

2897.8: constant

According to Wien's law, the wavelength is 10.4 μm at 278 K (5° C.), and the wavelength is 9.6 μm at 303 K (30° C.). Therefore, in order to prevent the passage of a heat ray other than that at the measurement temperature (from 5° C. to 30° C.) of the test cartridge 200, it is sufficient that the filter 405 be arranged in front of the focusing lens 403 of the thermopile 400.

Further, the reagent cell 206 of the test cartridge 200 has a shape of a substantially inverse circular truncated cone in cross section, and hence there is a risk in that the heat ray from the reagent (for example, R1) in the reagent cell 206 may be irregularly reflected from a wall surface of the reagent cell 206. From the viewpoint of suppressing such irregular reflection, it is preferred that the shape of the reagent cell 206 have, for example, a rectangular shape, and at least a peripheral wall of the reagent cell 206 be arranged so as to be opposed to the thermopile 400, as illustrated in FIG. 30C.

<Test Cartridge Control Processing>

Next, the test cartridge control processing to be used in this embodiment is described.

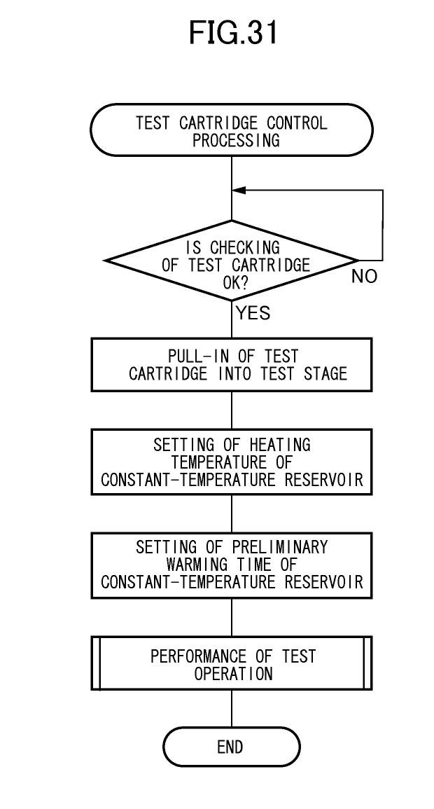

In this example, as illustrated in FIG. 29 and FIG. 31, the control device 310 first checks whether or not the test cartridge 200 set on the set stage ST is in a state of being subjected to the test.

If it is determined that the test cartridge 200 is in a state of being subjected to test, the control device 310 pulls the test cartridge 200 set on the set stage ST into the test stage KT by the cartridge conveyance mechanism 50.

In this state, the control device 310 performs (1) heating temperature setting of the constant-temperature reservoir 80 and (2) preliminary warming time setting of the constant-temperature reservoir 80.

When the above-mentioned settings are completed, the control device 310 performs a series of test operations with respect to the test cartridge 200.

Now, the control details thereof are described.

<Checking of Test Cartridge>

The test cartridge is checked by the following procedure.

### [1] Checking of the Setting of the Test Cartridge 200 on the Cartridge Rack 40

First, a user arrays the test cartridges 200 in a predetermined direction and sets the test cartridges 200 on the cartridge rack 40.

In this state, the cartridge holding mechanism 30 moves the cartridge rack 40 in the X-direction, and for example, moves the test cartridge 200 set in the first lane to the test initial position ST.

At this time, the barcode 216 of the test cartridge 200 is read by the barcode reader 110, and it is determined whether or not the test cartridge 200 has been inserted in a correct direction.

### [2] Checking of Liquid Temperature of Reagent R1

In general, the test cartridge 200 is refrigerated and stored in a refrigerator in most cases. Therefore, it is preferred that, when the test cartridge 200 is used, the test cartridge 200 be left in a surrounding environment for a predetermined period of time after being taken out from the refrigerator, and the test cartridge 200 be subjected to the test after the temperature of a reagent and the like in the test cartridge 200 reaches a temperature substantially equal to the temperature of the surrounding environment.

However, the following situation may occur: the test cartridge 200 is set on the cartridge rack 40 of the cartridge holding mechanism 30 without satisfying the above-mentioned use condition.

In this embodiment, the control device 310 checks the test cartridge 200 as follows.

That is, after the test cartridge 200 is set on the cartridge rack 40, the cartridge holding mechanism 30 serving as the X unit moves the first test cartridge 200 to the test initial position ST1 and then to the liquid temperature detection position ST2.

In this case, the thermopile 400 (liquid temperature detector S1) detects, for example, a liquid temperature of the reagent R1 in the reagent cell 206 at the liquid temperature detection position ST2.

If the cartridge holding mechanism 30 is moved without leaving the refrigerated and stored test cartridge 200 sufficiently at the temperature of the surrounding environment, the liquid temperature detected by the thermopile 400 is lower than the internal environmental temperature Tc.

In this example, an “R1 liquid temperature” and an “internal environmental temperature” are detected by the thermopile 400, and it is determined whether or not the following arithmetic expression (1) is satisfied.

(R1 liquid temperature−Internal environmental temperature Tc)<0, and

|R1 liquid temperature−Internal environmental temperature Tc|≦|α|(α=−4° C. in this example) (1)

When the condition of the arithmetic expression (1) is satisfied, the control device 310 determines that the temperature of the reagent R1 in the test cartridge 200 is close to the internal environmental temperature Tc. Then, the control device 310 returns the test cartridge 200 to the test initial position ST1 and shifts to a conveyance operation of the test cartridge 200 to the test stage KT by the cartridge conveyance mechanism 50 serving as the Y unit.

On the other hand, when the arithmetic expression (1) is not satisfied, the control device 310 determines that the temperature of the reagent R1 in the test cartridge 200 is still too low compared to the internal environmental temperature Tc and causes the test cartridge 200 to stand by at the liquid temperature detection position ST2. When the condition of the arithmetic expression (1) is satisfied, the control device 310 returns the test cartridge 200 to the test initial position ST1 and shifts to a conveyance operation of the test cartridge 200 to the test stage KT by the cartridge conveyance mechanism 50 serving as the Y unit.

Note that, when the precondition of the arithmetic expression (1) is different, that is, when (R1 liquid temperature−Internal environmental temperature Tc)≦0, it can be said that the R1 liquid temperature is sufficiently close to the internal environmental temperature Tc. Therefore, it is sufficient that, in the same way as in the case where the arithmetic expression (1) is satisfied, the control device 310 return the test cartridge 200 to the test initial position ST1 and shift to a conveyance operation of the test cartridge 200 to the test stage KT by the cartridge conveyance mechanism 50 serving as the Y unit.

—Checking of Preferred Liquid Temperature of Test Cartridge—

In this embodiment, when the liquid temperature of the test cartridge 200 is checked, and |R1 liquid temperature−Internal environmental temperature Tc| becomes a threshold value or less, the control device 310 immediately returns the test cartridge 200 to the test initial position ST1 and shifts to a pull-in operation of the test cartridge 200 to the test stage KT. However, the present invention is not limited thereto. After |R1 liquid temperature−Internal environmental temperature Tc| becomes a threshold value or less, the control device 310 may cause the test cartridge 200 to stand by at the liquid temperature detection position ST2 for a predetermined period of time. After an elapse of the predetermined period of time, the control device 310 may return the test cartridge 200 to the test initial position ST1 and shift to a pull-in operation of the test cartridge 200 to the test stage KT.

It is preferred to adopt the above-mentioned system in that the test condition of the test cartridge 200 becomes further suitable because the liquid temperature of the test cartridge 200 becomes closer to the internal environmental temperature.

—Coping Method for Detection of Liquid Temperature by Thermopile—

### (A) Correction of Thermopile Based on Internal Environmental Temperature

It is difficult for the thermopile 400 to directly detect the liquid temperature of the reagent R1, and when the internal environmental temperature Tc of the set stage ST changes, the detected temperature from the thermopile element 402 tends to change.

Then, in this example, a thermopile element output and a temperature detection element output are obtained from the thermopile element 402 and the temperature detection element 404 of the thermopile 400, and a correction value is applied to the thermopile element output with the temperature detection element output to indirectly determine the liquid temperature of the reagent R1. The internal environmental temperature Tc is directly obtained based on the temperature detection element output, and the condition is determined by the arithmetic expression (1).

Note that, there is a variation in the thermopile element 402, and hence it is necessary to previously adjust a voltage output as a thermopile output so that the thermopile output becomes constant when the thermopile element 402 receives a heat ray from the same heat source.

### (B) Correction of Threshold Value α

The output of the thermopile element 402 of the thermopile 400 changes depending on the internal environmental temperature Tc, and hence a threshold value α may be corrected with the internal environmental temperature Tc.

For example, the relationship between the internal environmental temperature Tc and the threshold value α is defined as shown in the following table by, for example, an experiment, and a detected output from the thermopile element 402 is determined as the liquid temperature of the reagent R1 without being corrected. On the other hand, the threshold value α may be corrected based on the internal environmental temperature Tc detected from the temperature detection element 404 to determine whether or not the arithmetic expression (1) is satisfied.

| Internal environmental temperature Tc | Threshold value α |
|---|---|
| 15° C. | −14.5 |
| 20° C. | −12.0 |
| 25° C. | −9.5 |
| 30° C. | −8.0 |

### (C) the Threshold Value α is Represented by a Numerical Expression and Changed Automatically.

An arithmetic expression (2) is previously created by an experiment or the like, and a variable x of the internal environmental temperature Tc is input to the arithmetic expression (2) to calculate an output y of the thermopile 400.

y=−0.00009269x²+2.836x-10480 (2)

where x and y are decimal numbers.

### [3] Checking of Presence/Absence of Test Cartridge

After completing the checking of a liquid temperature of the reagent R1 in the test cartridge 200, the control device 310 returns the test cartridge 200 to the test initial position ST1. Then, the control device 310 confirms the presence of the test cartridge 200 with the cartridge presence/absence detector S2, and thereafter shifts to a conveyance operation of the test cartridge 200 by the cartridge conveyance mechanism 50 serving as the Y unit.

<Temperature Control Processing of Constant-Temperature Reservoir>

The control device 310 detects the temperature of the constant-temperature reservoir 80 with the temperature detector S6 (temperature detector 84), and controls to turn on/off the heater 83 so that a target constant environmental temperature (for example, 37° C.) is achieved.

In this embodiment, as illustrated in FIG. 29, the control device 310 detects the internal environmental temperature Tc in the test stage KT with the temperature detector S4 as the temperature control processing of the constant-temperature reservoir 80, and variably sets the setting temperature of the heater 83 based on the internal environmental temperature Tc.

In this case, when the internal environmental temperature Tc is lower than a previously-determined threshold value, it is sufficient that the setting temperature of the heater 83 be set to be higher than that of the case of the temperature equal to or more than the threshold value so as to keep a certain constant environmental temperature (for example, 37° C.) constant.

It is preferred that the variation degree be previously determined by an experiment or the like.

The detail thereof is described later in Examples.

<Preliminary Warming of Constant-Temperature Reservoir>

In this embodiment, the control device 310 variably sets the setting temperature of the heater 83 with the internal environmental temperature Tc in the test stage KT being a parameter. In addition to this, the control device 310 variably sets the preliminary warming time of the heater 83 with the internal environmental temperature Tc being a parameter, so that the liquid temperature in the reaction cell 207 at a time of the start of measurement by the measurement device 100 is set to be a previously-determined temperature.

In this case, when the internal environmental temperature Tc is lower than the previously-determined threshold value, it is sufficient that the preliminary warming time of the heater 83 be extended compared to the case of the temperature equal to or more than the threshold value.

It is preferred that the variation degree be previously determined by an experiment or the like.

The detail thereof is described later in Examples.

<Operation of Automatic Analysis Device>

Next, an operation of the automatic analysis device according to this embodiment is described.

In order to use the automatic analysis device, it is sufficient to perform (1) a setting operation of a test cartridge and (2) an executing operation of a measurement sequence.

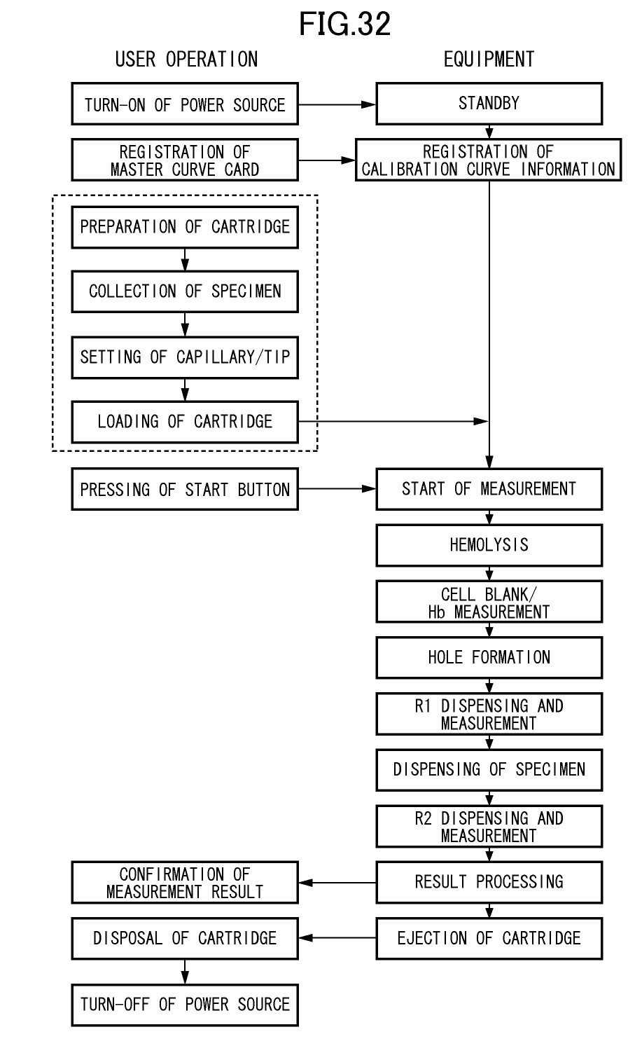

Specifically, a series of operations illustrated in FIG. 32 are performed in the automatic analysis device (equipment) with respect to a user operation as illustrated in FIG. 32.

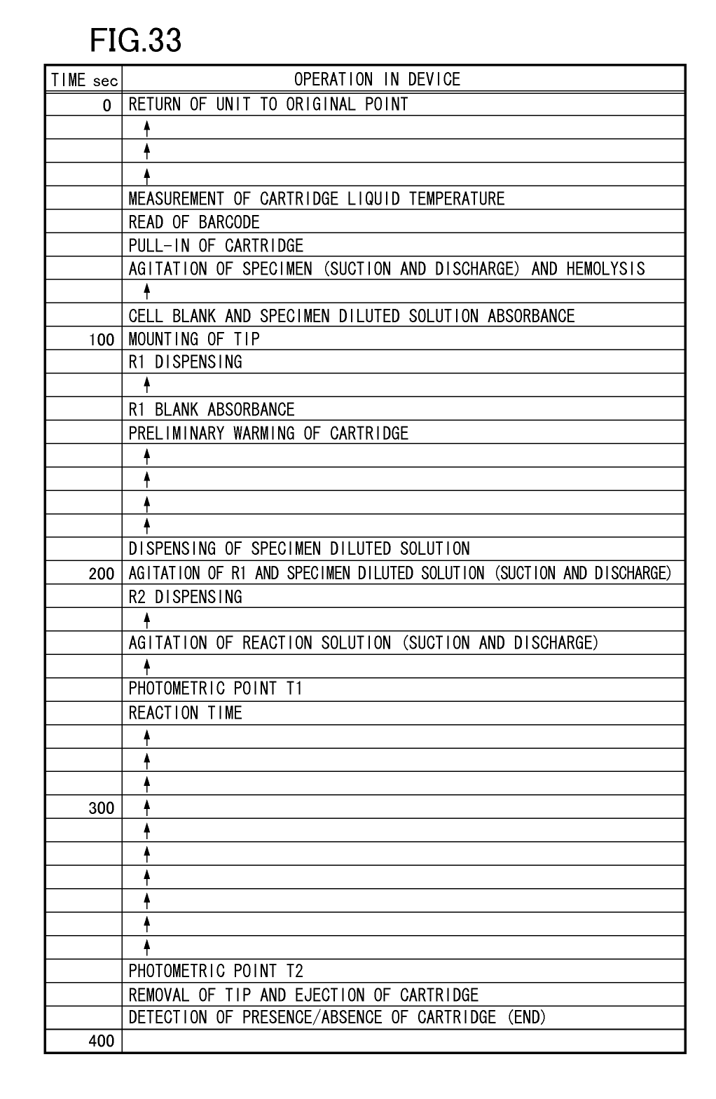

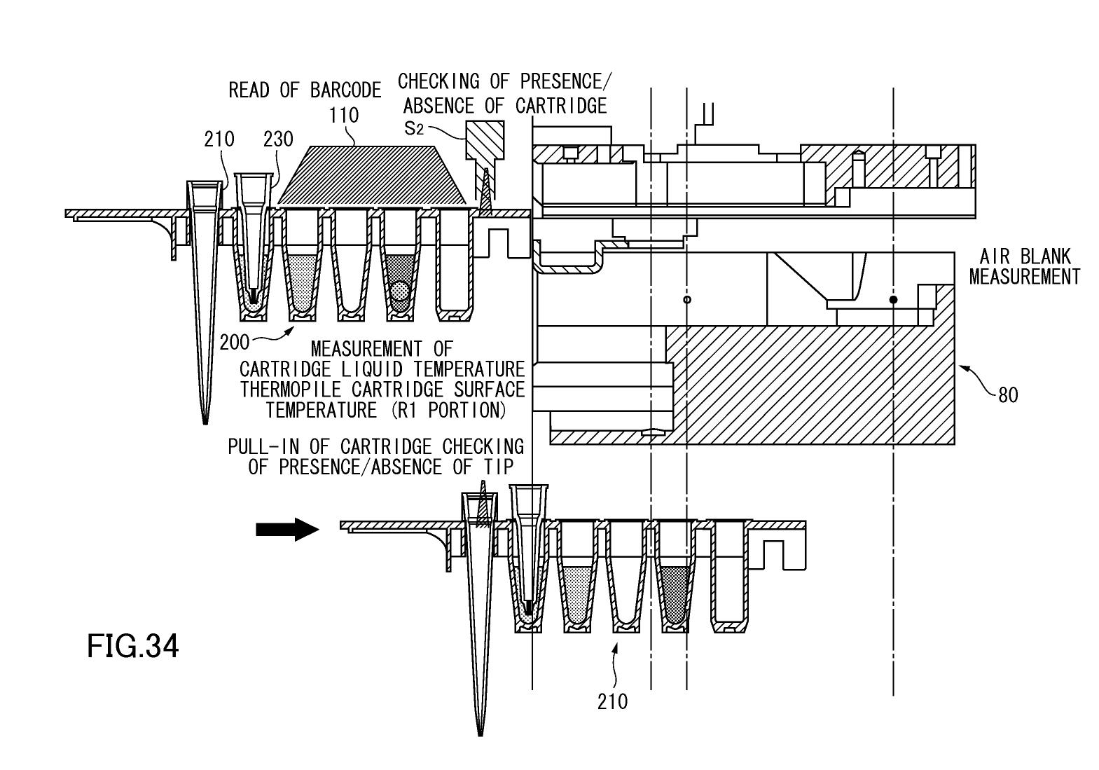

Further, FIG. 33 is a timing chart for illustrating a process of the series of operations of the automatic analysis device according to this embodiment with time series.

Now, the operations are specifically described.

—Setting Operation of Test Cartridge—

First, a user needs to open the door 22 of the automatic analysis device 20 as illustrated in FIG. 4A, and then set a plurality of the test cartridges 200 required for the test on the cartridge rack 40 in the set stage ST of the automatic analysis device 20 successively from a right side seen from a user operation side.

In this case, as the preparation with respect to the test cartridges 200 to be set, it is necessary to set the capillary 230 having collected a specimen and the nozzle tip 210 (see FIG. 7A, FIG. 7B, FIG. 7C, FIG. 7D, and FIG. 7E).

Further, as illustrated in FIG. 8, it is necessary that the test cartridges 200 be set in a predetermined direction with respect to the cartridge rack 40. It is sufficient that the user insert the test cartridges 200 to a predetermined position along the slit 43 of the rack holder 41 of the cartridge rack 40.

—Execution of Measurement Sequence—

After the setting operation of the test cartridges 200 is completed, the door 22 of the automatic analysis device 20 is closed. Then, a start button of the operation panel 23 is operated, and thus the measurement sequence is automatically executed.

### (1) Setting of Test Cartridge at Test Initial Position

As illustrated in FIG. 12A and FIG. 12B, the control device 310 moves the X-table 31 of the cartridge holding mechanism 30 serving as the X unit, and sets the test cartridge 200 to be tested first (corresponding to the test cartridge at a right end seen from a user side in this example) at the test initial position ST1.

### (2) Checking of Erroneous Insertion of Test Cartridge (See FIG. 34)

In this example, the barcode reader 110 is arranged, for example, in an upper portion corresponding to the test initial position ST1, and if the insertion direction of the test cartridge 200 is opposite, the test operation of the test cartridge 200 is inhibited.

That is, in the test cartridge 200, the barcode 216 for preventing erroneous insertion is engraved on the seal 215. When the barcode 216 is read by the barcode reader 110, it is understood that the test cartridge 200 has been correctly inserted into the cartridge rack 40. In contrast, if the insertion direction of the test cartridge 200 is opposite, the barcode 216 of the test cartridge 200 cannot be read by the barcode reader 110, and thus it is understood that the test cartridge 200 has been erroneously inserted into the cartridge rack 40.

### (3) Detection of Liquid Temperature of Test Cartridge (See FIG. 34)

When it is confirmed that the test cartridge 200 has been correctly inserted into the cartridge rack 40, in the case of the test cartridge 200 to be tested first among the plurality of the test cartridges 200, as described above, the cartridge holding mechanism 30 serving as the X unit transfers the test cartridge 200 to the liquid temperature detection position ST2, and the temperature detector S1 (thermopile 400) detects the liquid temperature of the reagent R1 in the reagent cell 206 and checks whether or not the liquid temperature of the test cartridge 200 is suitable.

### (4) Resetting of Test Cartridge at Test Initial Position (See FIG. 34)

When the liquid temperature of the test cartridge 200 is suitable, the cartridge holding mechanism 30 serving as the X unit returns the test cartridge 200 to the test initial position ST1.

Then, the cartridge presence/absence detector S2 confirms the presence of the test cartridge 200.

In this case, the measurement device 100 performs air blank measurement in the absence of the test cartridge 200 at the measurement position MP to obtain information on absorbance of only an air layer in the absence of the test cartridge 200.

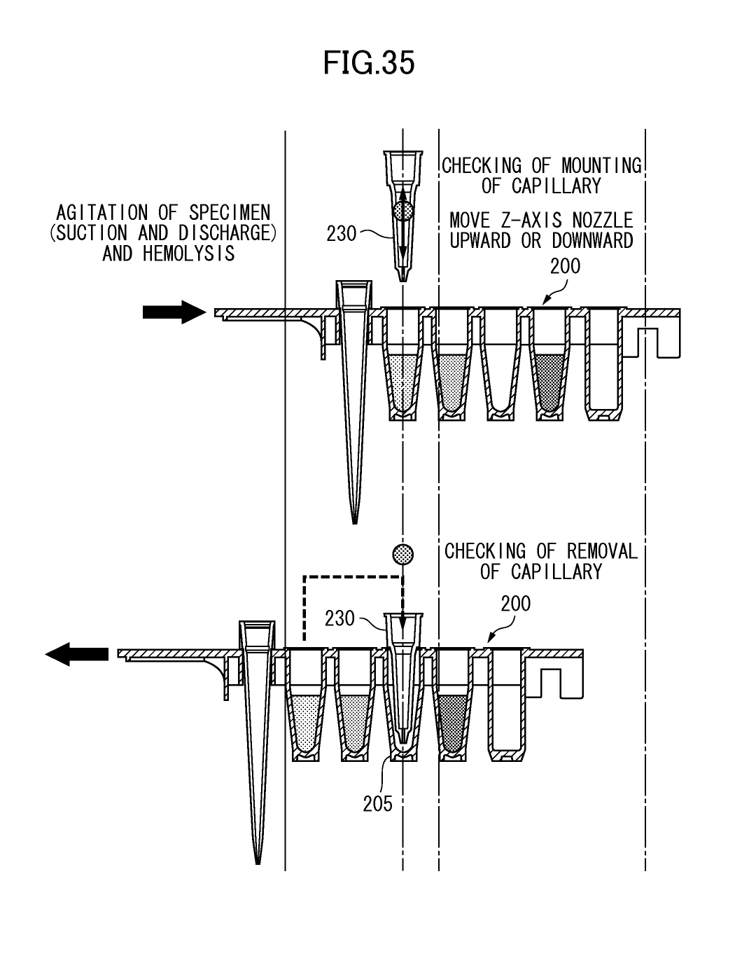

### (5) Pull-in Operation of Test Cartridge (See FIG. 34 and FIG. 35)

Then, the test cartridge 200 set at the test initial position ST1 is pulled into the test stage KT side by the cartridge conveyance mechanism 50 serving as the Y unit.

In this case, the tip presence/absence detector S3 checks the presence/absence of the nozzle tip 210 in the test cartridge 200 pulled into the test stage KT.

In this embodiment, the cartridge conveyance mechanism 50 pulls the test cartridge 200 into the test stage KT so that the specimen cell 203 of the test cartridge 200 stops at the dispensing position BP (see FIG. 35).

### (6) Control Processing of Constant-Temperature Reservoir

The control device 310 performs constant-temperature control by operating the heater 83 of the constant-temperature reservoir 80 at a time when a main power source switch is turned on so as to set the inside of the constant-temperature reservoir 80 at a predetermined temperature (for example, 37° C.).

Further, as described above, the control device 310 performs temperature control processing of the constant-temperature reservoir 80 (temperature setting of the heater 83) and preliminary warming time control of the constant-temperature reservoir 80 (variable setting of preliminary warming time of the heater 83).

### (7) Discharge of Specimen by Capillary (See FIG. 35)

Then, the specimen and reagent dispensing mechanism 70 serving as the Z unit inserts and holds the capillary 230 into the nozzle head 71 at the dispensing position BP, and the presence/absence detector S5 confirms the mounted state of the capillary 230.

After that, the specimen and reagent dispensing mechanism 70 discharges a specimen in the capillary 230 into a diluent in the specimen cell 203 and repeats suction and discharge to agitate the specimen and the diluent.

### (8) Removal of Capillary (See FIG. 35)

Then, the cartridge conveyance mechanism 50 serving as the Y unit moves the empty cell 205 of the test cartridge 200 to the dispensing position BP.

In this state, the specimen and reagent dispensing mechanism 70 serving as the Z unit moves the capillary 230 to the position of the empty cell 205 and removes the capillary 230 from the nozzle head 71 through use of the nozzle remover 74 so as to dispose of the capillary 230 into the empty cell 205. Then, the presence/absence detector S5 confirms a removed state of the capillary 230.

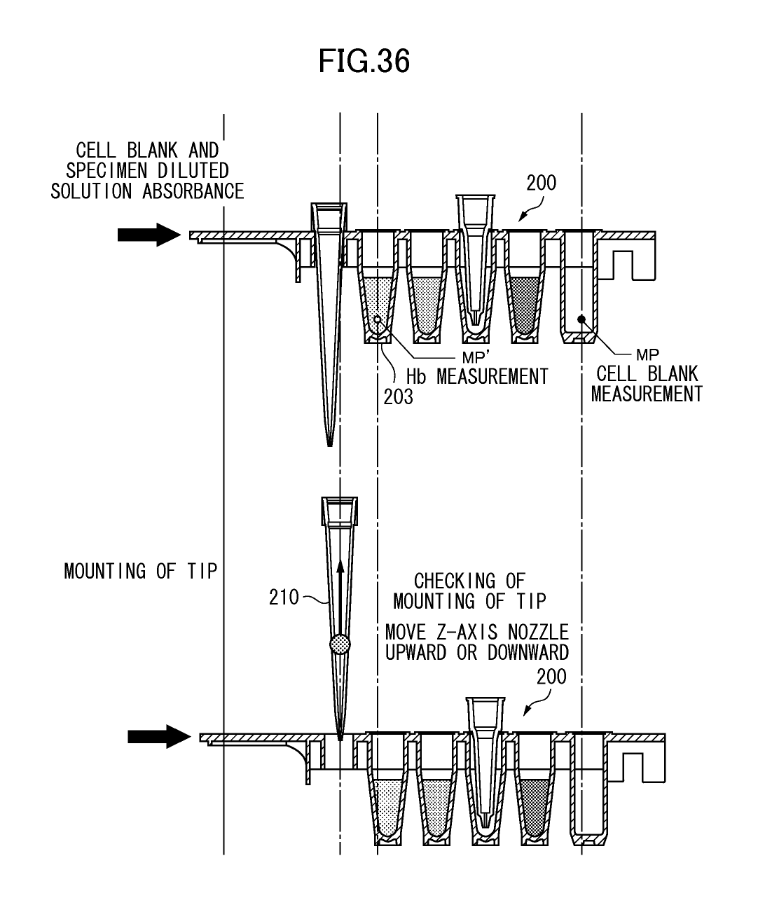

### (9) Cell Blank Measurement and Hb Measurement of Diluted Solution of Specimen (See FIG. 36)

After that, the cartridge conveyance mechanism 50 serving as the Y unit conveys the test cartridge 200 so that the reaction cell 207 and the specimen cell 203 of the test cartridge 200 are positioned at the measurement positions MP and MP′ of the measurement device 100, and measurement by each measurement portion of the measurement device 100 is performed. In this case, blank measurement of the reaction cell 207 is performed at the measurement position MP, and Hb measurement of the diluted solution of the specimen in the specimen cell 203 is performed at the measurement position MP′. Thus, the initial state of the reaction cell 207 and the initial state of the diluted solution of the specimen can be understood.

### (10) Mounting of Nozzle Tip (See FIG. 36)

Then, the cartridge conveyance mechanism 50 serving as the Y unit conveys the test cartridge 200 so that the nozzle tip 210 held by the test cartridge 200 is arranged at the dispensing position BP.

In this state, the specimen and reagent dispensing mechanism 70 serving as the Z unit mounts the nozzle tip 210 on the nozzle head 71, and the presence/absence detector S5 confirms the mounted state of the nozzle tip 210.

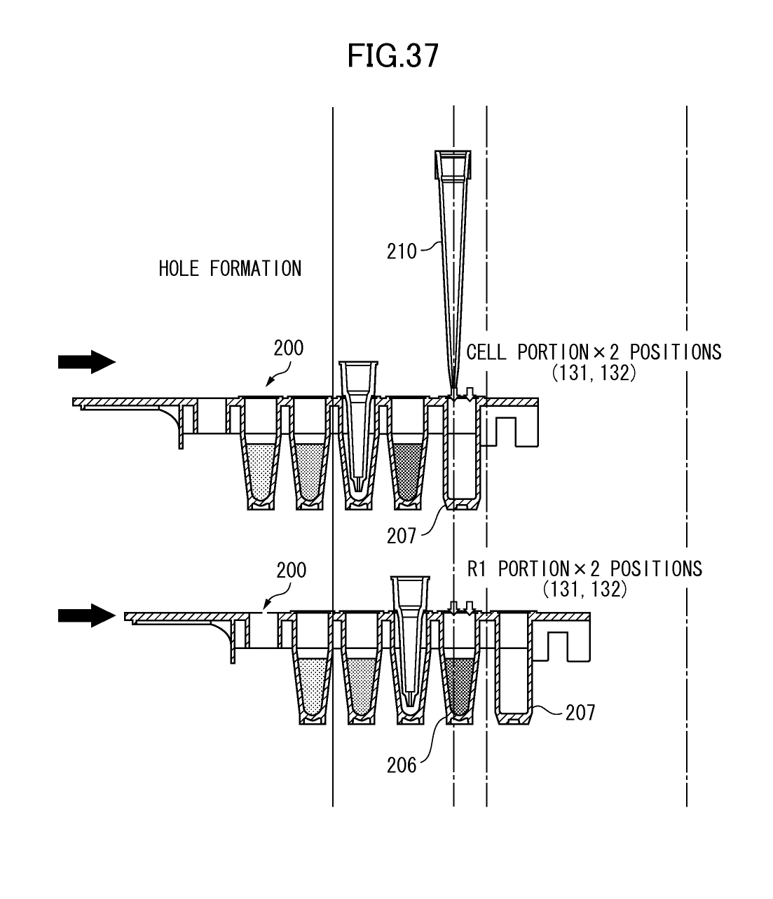

### (11) Air Hole-Forming Operation (See FIG. 37)

Then, the control device 310 causes the specimen and reagent dispensing mechanism 70 serving as the Z unit to be operated as a hole-forming device, and controls the hole-forming device using the specimen and reagent dispensing mechanism 70 to form an air hole in the seal 215 of the test cartridge 200 while controlling the cartridge conveyance mechanism 50 to appropriately move the test cartridge 200 forward or backward.

In this embodiment, the air hole-forming operation involves forming a plurality of (two in this example) air holes 131 and 132 in each of the seal 215 portions corresponding to the cells 202 to be used in the test cartridge 200 (the reagent cell 206 and the reaction cell 207 in this example).

In this case, the size of each of the air holes 131 and 132 may be, for example, about from 1 mm to 2 mm, and it is sufficient that the insertion depth thereof be determined in consideration of a change in outer diameter of the nozzle tip 210.

In particular, in this embodiment, the respective air holes 131 and 132 are formed at positions having an opening center of each of the corresponding cells 202 to be used (the specimen cell 203, the reagent cells 204 and 206, and the reaction cell 207) interposed therebetween, for example, at positions that are substantially point symmetrical.

Note that, a hole is formed in the seal 215 portion corresponding to the specimen cell 203 of the test cartridge 200 at a time of dispensing of a specimen, but it is not clear at which position the hole has been formed by the user operation. Therefore, this embodiment adopts a system of controlling the hole-forming device using the specimen and reagent dispensing mechanism 70 so as to form the plurality of the air holes 131 and 132 also for the seal 215 portion corresponding to the specimen cell 203 in the same way as in the other cells.

As described above, when the plurality of the air holes 131 and 132 are formed in each of the seal 215 portions of the cells 202 to be used, even if the nozzle tip 210 serving as a hole-forming tool is inserted to close one air hole 131, for example, as illustrated in FIG. 37, the other air hole 132 is opened to air. Therefore, the insertion of the nozzle tip 210 does not unnecessarily increase the pressure in the cell 202 to be used to make the suction and discharge operations of a specimen and a reagent by the nozzle tip 210 unstable.

Further, in the case where the nozzle tip 210 serving as the hole-forming tool is inserted into the vicinity of the opening center of the seal 215 portion of the cell 202 to be used, the seal 215 portion of the cell 202 to be used is easily fractured due to the presence of the plurality of the air holes 131 and 132, and the nozzle tip 210 is inserted into the cell 202 to be used in a state of being opened to air.

In particular, in this embodiment, the plurality of the air holes 131 and 132 are formed at the positions having the opening center of each of the cells 202 to be used interposed therebetween. Therefore, even if the insertion position of the nozzle tip 210 is relatively displaced at a time of dispensing of a specimen and a reagent, the seal 215 is fractured reliably at a time of the hole-forming operation by the nozzle tip 210. In this respect, in an aspect in which, for example, the plurality of the air holes 131 and 132 are formed closely to one side with respect to the opening center of the cell 202 to be used, although there is a risk in that the seal 215 is slightly difficult to be fractured when the nozzle tip 210 is inserted into a side on which the air holes 131 and 132 are not formed in the seal 215 portion at a time of dispensing of a specimen and a reagent, the seal 215 is likely to be fractured due to the presence of the plurality of the air holes 131 and 132 compared to the case where only one air hole is formed. Thus, the above-mentioned embodiment is preferred.

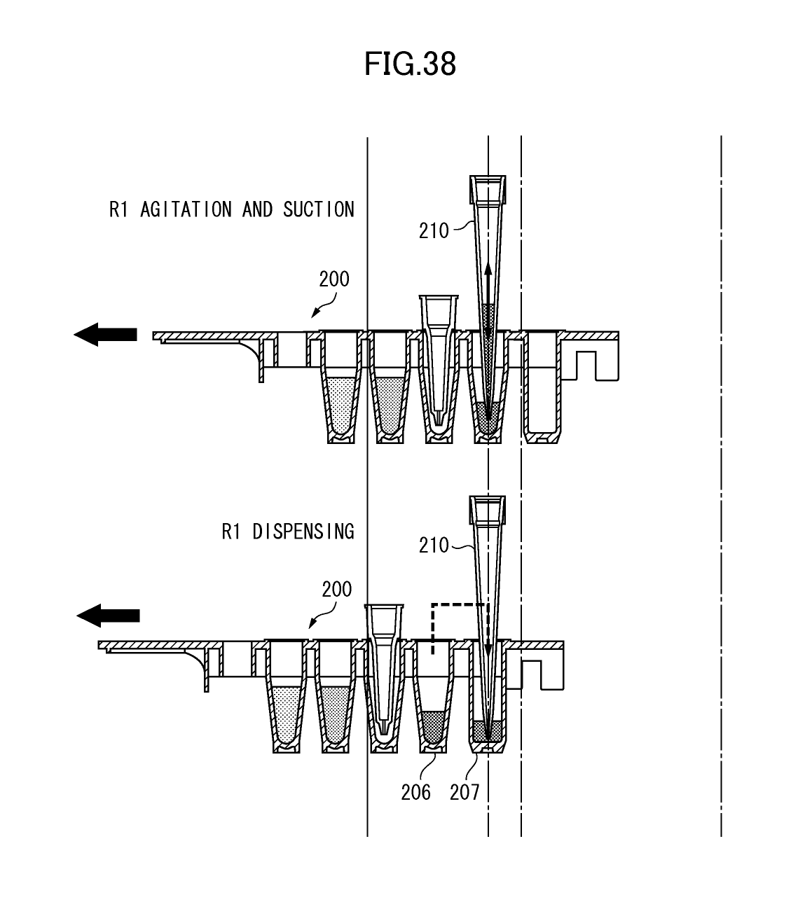

### (12) Dispensing of Reagent R1 (See FIG. 38)

The cartridge conveyance mechanism 50 serving as the Y unit conveys the reagent cell 206 of the test cartridge 200 to the dispensing position BP.

In this state, the specimen and reagent dispensing mechanism 70 serving as the Z unit performs the hole-forming operation with the nozzle tip 210 in the seal 215 portion of the reagent cell 206 in which the holes have been formed, and agitates and sucks the reagent R1 to be dispensed in the reagent cell 206. After that, the specimen and reagent dispensing mechanism 70 moves upward so as to be separated from the reagent cell 206.

Then, the cartridge conveyance mechanism 50 serving as the Y unit conveys the reaction cell 207 of the test cartridge 200 to the dispensing position BP.

In this state, the specimen and reagent dispensing mechanism 70 serving as the Z unit performs the hole-forming operation with the nozzle tip 210 in the seal 215 portion of the reaction cell 207 in which the holes have been formed, and dispenses the reagent R1 in the nozzle tip 210 with respect to the reaction cell 207.

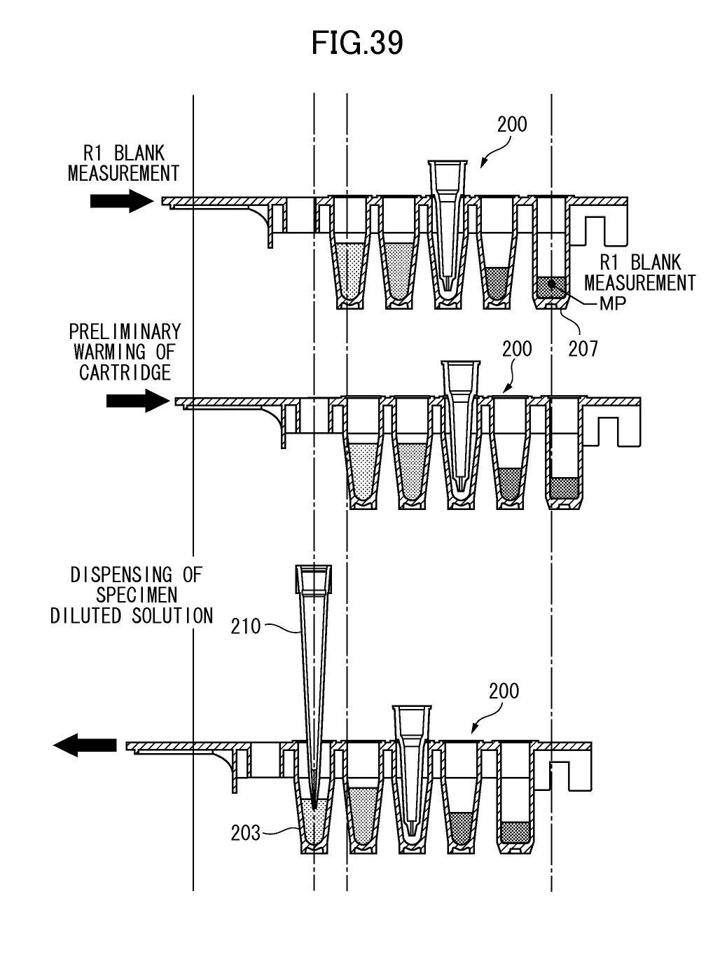

### (13) R1 Blank Measurement (See FIG. 39)

Then, the cartridge conveyance mechanism 50 serving as the Y unit conveys the reaction cell 207 of the test cartridge 200 to the measurement position MP.

After that, the measurement device 100 performs blank measurement of the reagent R1 in the reaction cell 207 at the measurement position MP.

### (14) Preliminary Warming of Cartridge (See FIG. 39)

After that, the cartridge conveyance mechanism 50 serving as the Y unit finely adjusts the position of the test cartridge 200 so that each cell 202 of the test cartridge 200 falls within a heating area of the constant-temperature reservoir 80, and then performs a preliminary warming operation of the heater 83 with the set heating condition.

In this example, although the preliminary warming operation is performed after dispensing of the reagent R1 into the reaction cell 207, needless to say, the preliminary warming operation may be performed before dispensing of the reagent R1.

### (15) Dispensing of Diluted Solution of Specimen (See FIG. 39)

Further, the cartridge conveyance mechanism 50 serving as the Y unit conveys the test cartridge 200 so that the specimen cell 203 of the test cartridge 200 is arranged at the dispensing position BP.

In this state, the specimen and reagent dispensing mechanism 70 serving as the Z unit dispenses the diluted solution of the specimen in the specimen cell 203 with the nozzle tip 210.

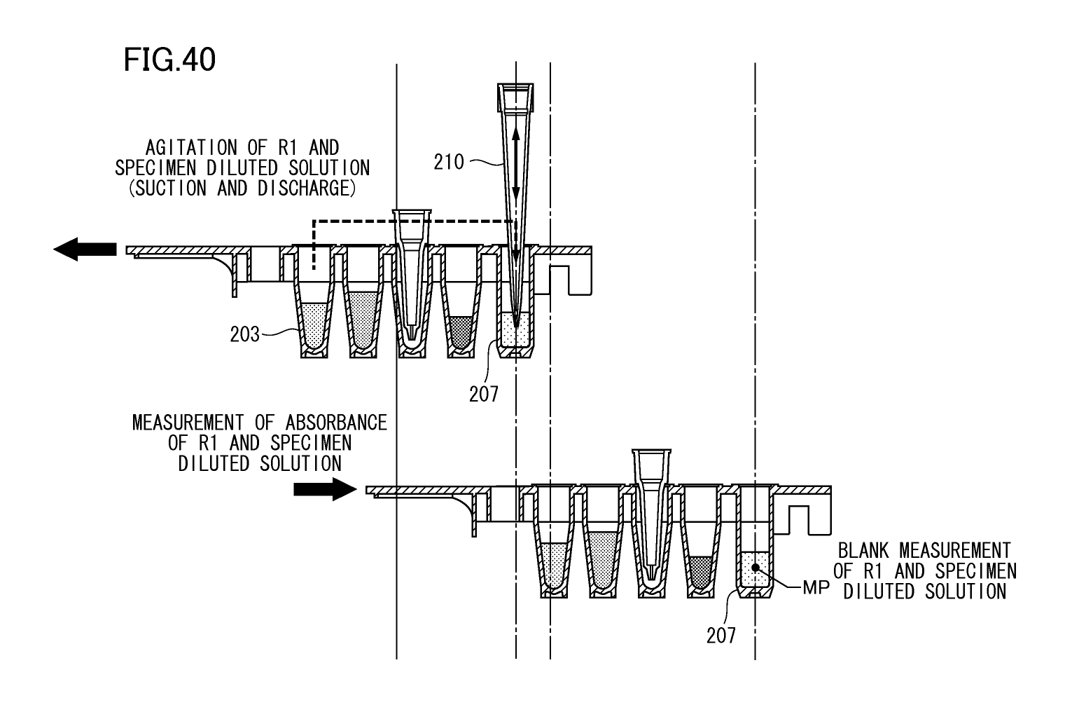

### (16) Agitation of R1 and Diluted Solution of Specimen (See FIG. 40)

Then, after the specimen and reagent dispensing mechanism 70 serving as the Z unit moves upward so as to be separated from the specimen cell 203, the cartridge conveyance mechanism 50 serving as the Y unit conveys the test cartridge 200 so that the reaction cell 207 of the test cartridge 200 is arranged at the dispensing position BP.

In this state, the specimen and reagent dispensing mechanism 70 serving as the Z unit lowers the nozzle tip 210 into the reaction cell 207, and repeats discharge and suction of the dispensed diluted solution of the specimen, thereby agitating the reagent R1 and the diluted solution of the specimen.

### (17) Measurement of Absorbance of R1 and Diluted Solution of Specimen (See FIG. 40)

Further, the cartridge conveyance mechanism 50 serving as the Y unit conveys the test cartridge 200 so that the reaction cell 207 of the test cartridge 200 is arranged at the measurement position MP.

In this state, the measurement device 100 subjects the reagent R1 and the diluted solution of the specimen in the reaction cell 207 to blank measurement of absorbance at the measurement position MP.

### (18) Air Hole-Forming Operation

Then, the control device 310 causes the specimen and reagent dispensing mechanism 70 serving as the Z unit to be operated as a hole-forming device, and controls the hole-forming device using the specimen and reagent dispensing mechanism 70 to form an air hole in the seal 215 of the test cartridge 200 while controlling the cartridge conveyance mechanism 50 to appropriately move the test cartridge 200 forward or backward.

In this embodiment, the air hole-forming operation involves forming a plurality of (two in this example) air holes in the seal 215 portion corresponding to the cell 202 (the reagent cell 204 accommodating the reagent R2 in this example) to be used in the test cartridge 200.

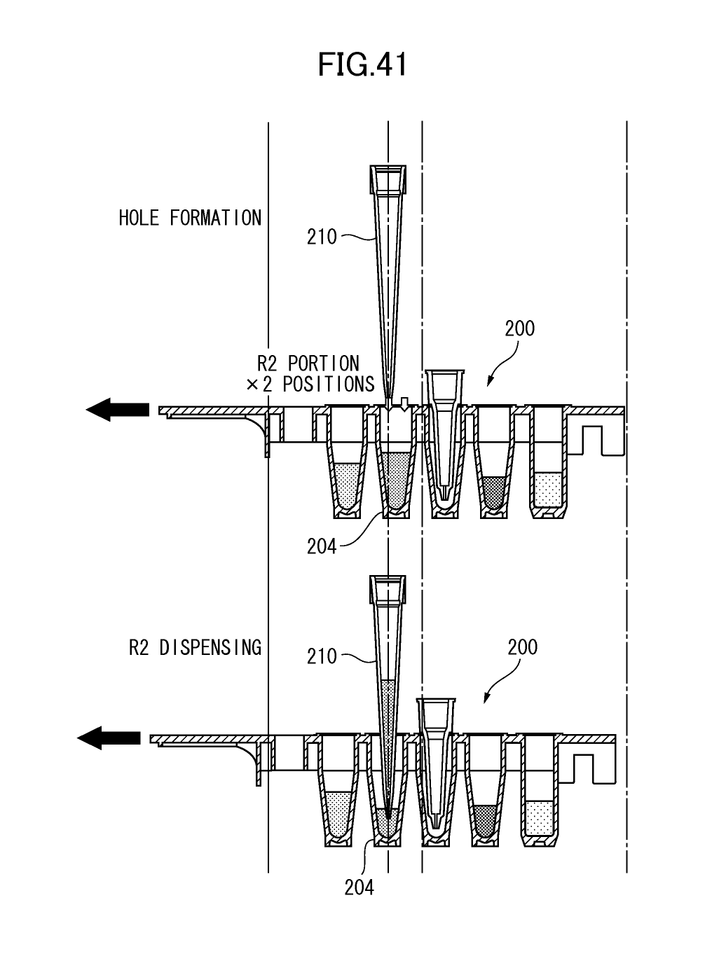

### (19) Dispensing of Reagent R2 (FIG. 41)

Then, the cartridge conveyance mechanism 50 serving as the Y unit conveys the reagent cell 204 (reagent R2) of the test cartridge 200 to the dispensing position BP.

In this state, the specimen and reagent dispensing mechanism 70 serving as the Z unit performs a hole-forming operation with the nozzle tip 210 in the seal 215 portion of the reagent cell 204 in which the holes have been formed, and agitates and sucks the reagent R2 to be dispensed in the reagent cell 204. After that, the specimen and reagent dispensing mechanism 70 moves upward so as to be separated from the reagent cell 204.

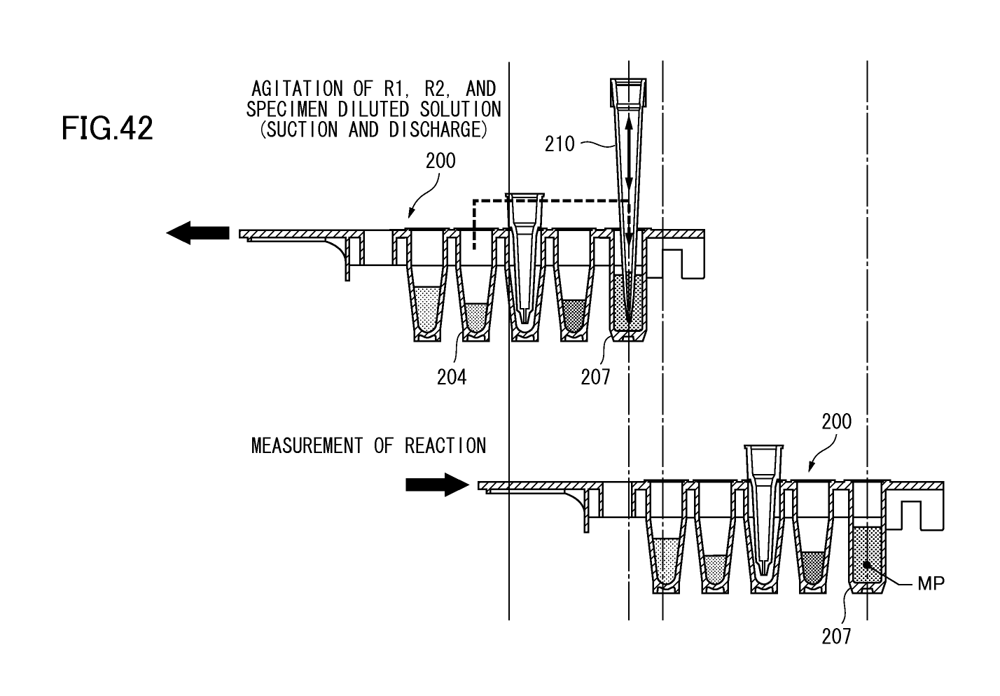

### (20) Agitation of R1, R2, and Diluted Solution of Specimen (See FIG. 42)

The cartridge conveyance mechanism 50 serving as the Y unit conveys the reaction cell 207 of the test cartridge 200 to the dispensing position BP.

In this state, the specimen and reagent dispensing mechanism 70 serving as the Z unit lowers the nozzle tip 210 into the reaction cell 207, and repeats discharge and suction of the dispensed reagent R2, thereby agitating the reagents R1 and R2 and the diluted solution of the specimen. Then, the specimen and reagent dispensing mechanism 70 moves upward so as to be separated from the reaction cell 207.

### (21) Measurement of Reaction (See FIG. 42)

Then, the cartridge conveyance mechanism 50 serving as the Y unit conveys the reaction cell 207 of the test cartridge 200 to the measurement position MP.

In this state, the measurement device 100 measures the reaction between the specimen and the reagents R1 and R2 in the reaction cell 207 at the measurement position MP for a predetermined period of time (for example, from 1 minute to 5 minutes).

In this example, the first measurement portion 101 of the measurement device 100 causes light from the light-emitting element 103 to pass through a mixed solution of the specimen and the reagents in the reaction cell 207. The light-receiving element 104 detects a change in the light, to thereby measure a change in reaction between the specimen and the reagents in the reaction cell 207 with the passage of time.

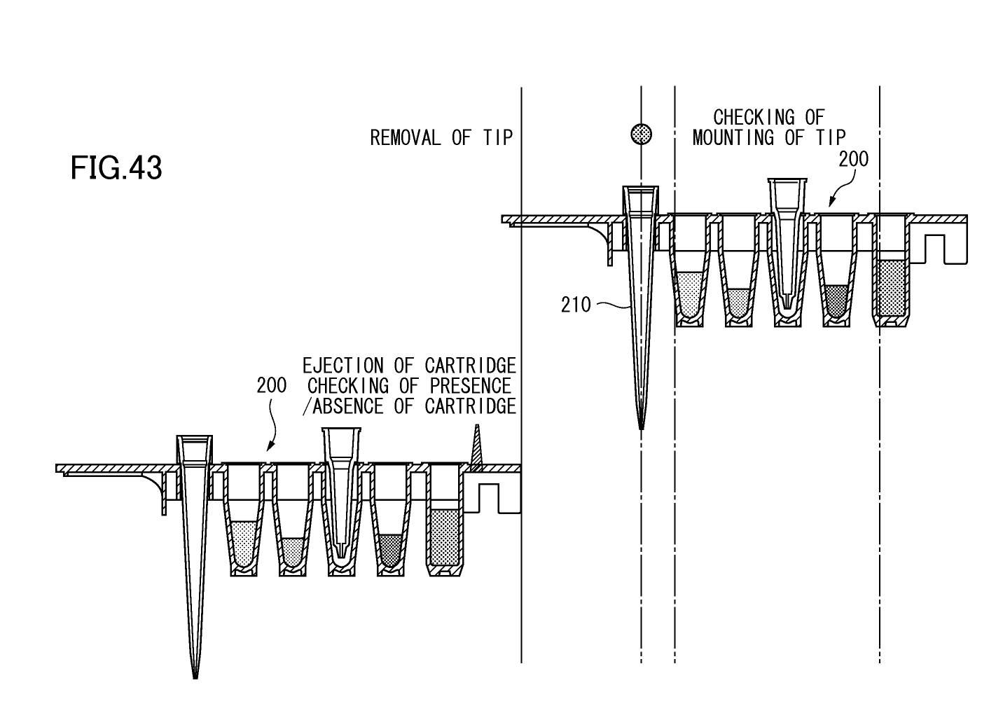

### (22) Removal of Nozzle Tip (See FIG. 43)

After that, the specimen and reagent dispensing mechanism 70 serving as the Z unit is put in a standby state after raising the nozzle tip 210, and the cartridge conveyance mechanism 50 conveys the test cartridge 200 so that the tip holding hole 208 of the test cartridge 200 is positioned at the dispensing position.

In this state, the specimen and reagent dispensing mechanism 70 serving as the Z unit inserts the nozzle tip 210 into the tip holding hole 208 of the test cartridge 200 from above, and cancels the held state of the nozzle tip 210 with the nozzle remover 75, thereby returning the nozzle tip 210 to be disposed of to the original position of the test cartridge 200.

The removal of the nozzle tip 210 is detected by the presence/absence detector S5.

### (23) Ejection of Test Cartridge (See FIG. 43)

After that, the cartridge conveyance mechanism 50 serving as the Y unit returns the tested test cartridge 200 to the set stage ST side.

In this state, the cartridge presence/absence detector S2 determines that the test cartridge 200 has been returned to the set stage ST side.

### (24) Result Printing Operation

The control device 310 prints the measurement results from the measurement device 100 with the printer 25.

In this stage, a predetermined measurement sequence with respect to one test cartridge 200 is completed.

After that, the control device 310 confirms the presence of the unprocessed test cartridges 200 in the set stage ST, and performs a series of measurement sequence with respect to each test cartridge 200.

Note that, the test period of time of the initial test cartridge 200 has elapsed, and hence it is not necessary to subject the second and subsequent test cartridges 200 to the liquid temperature detection processing.

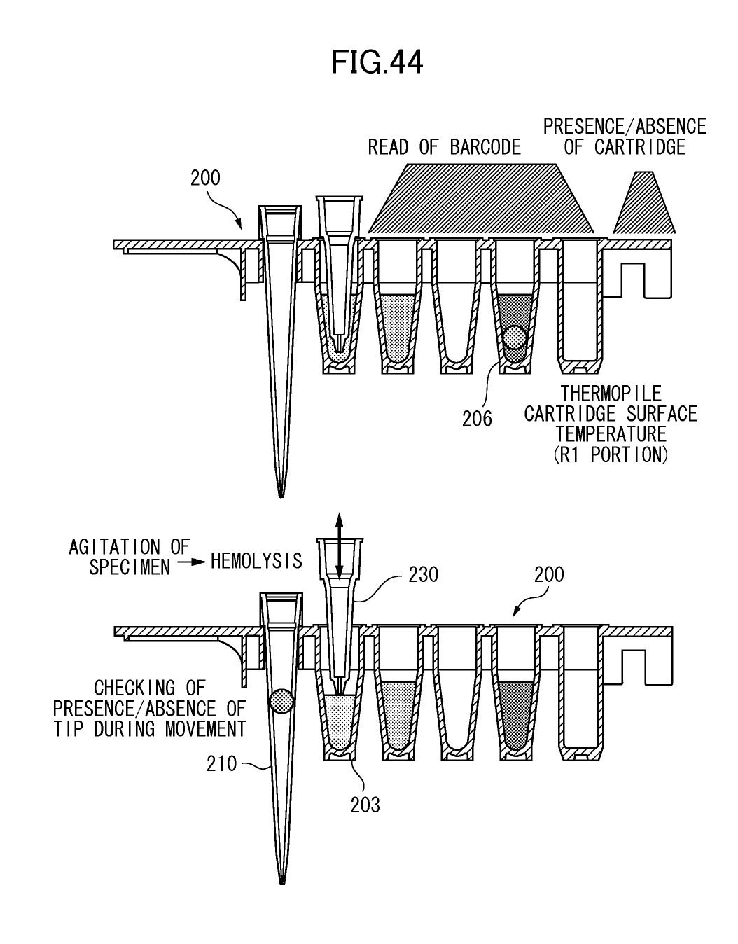

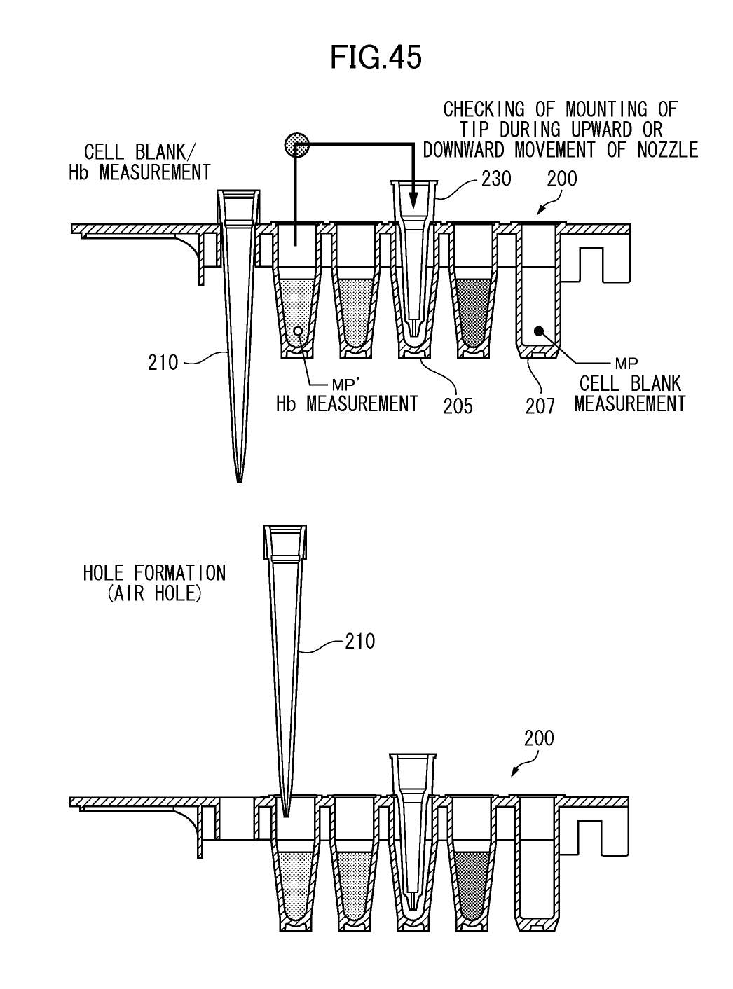

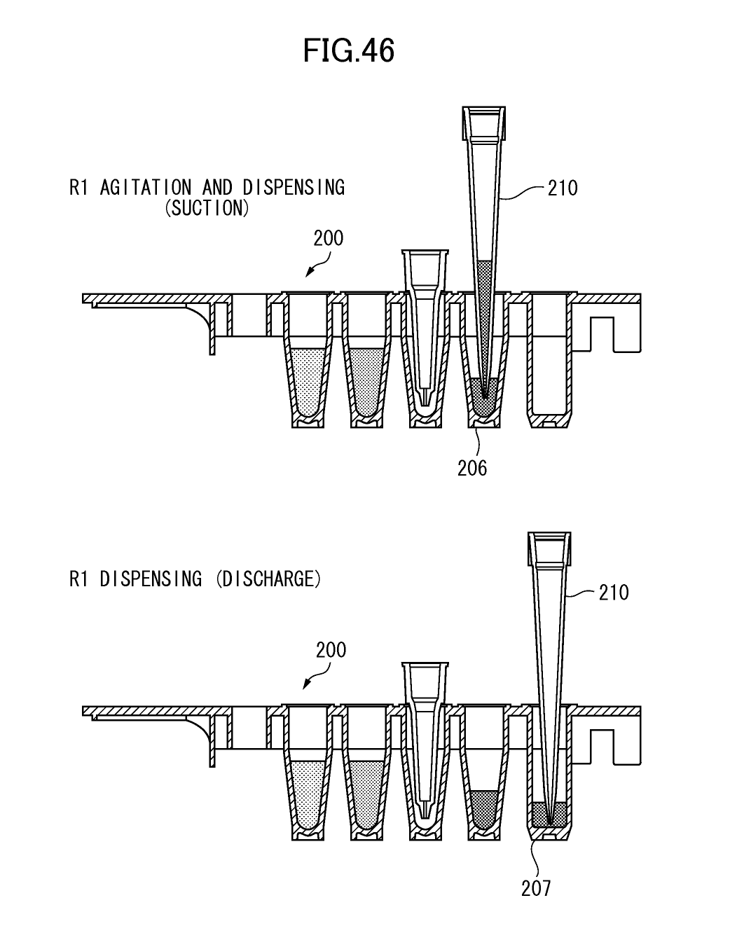

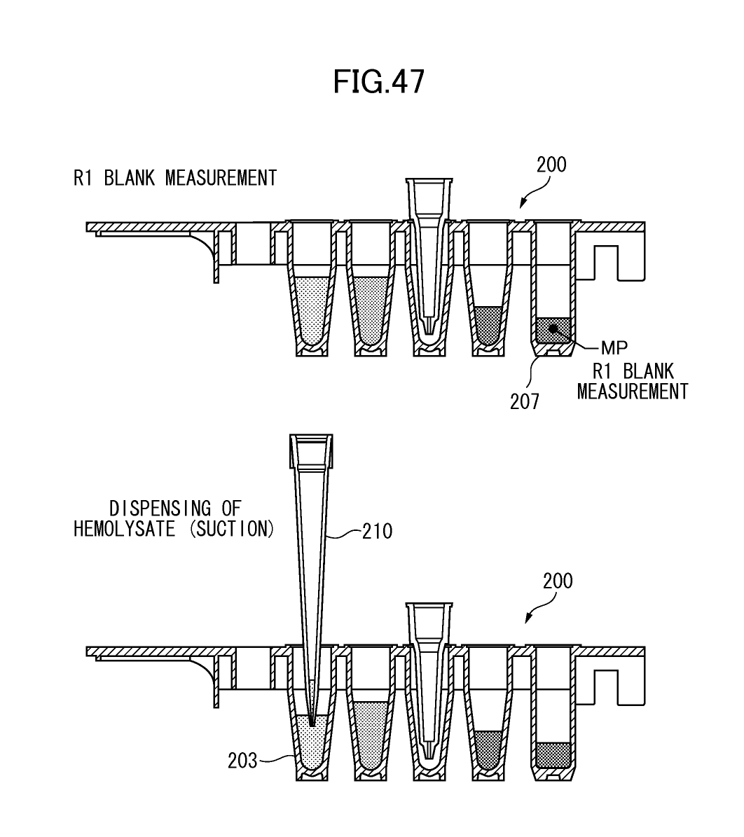

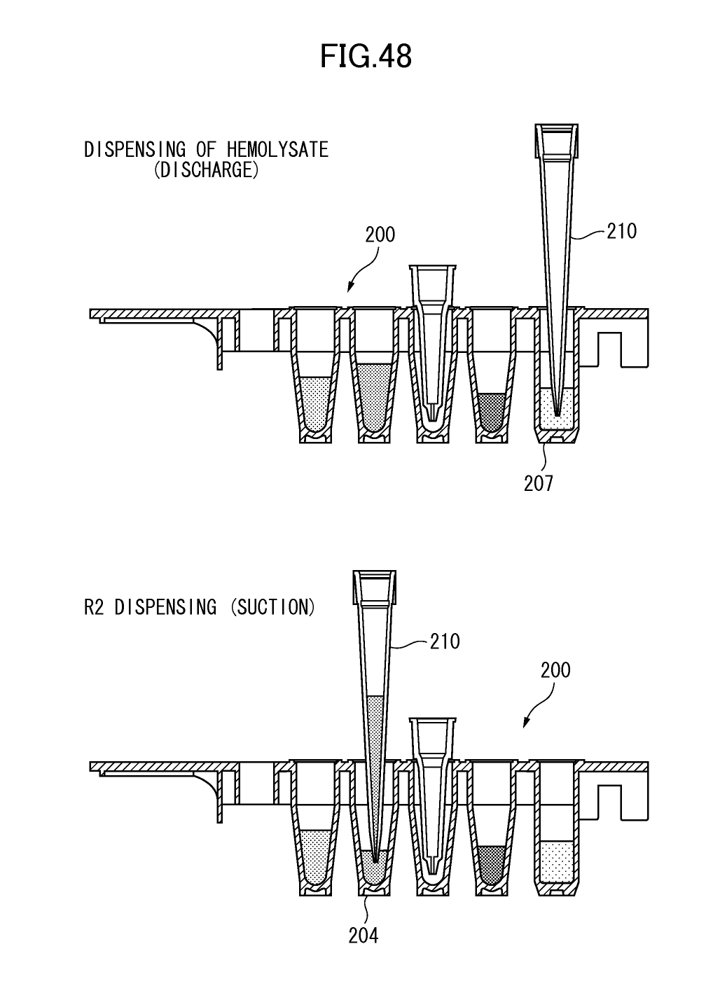

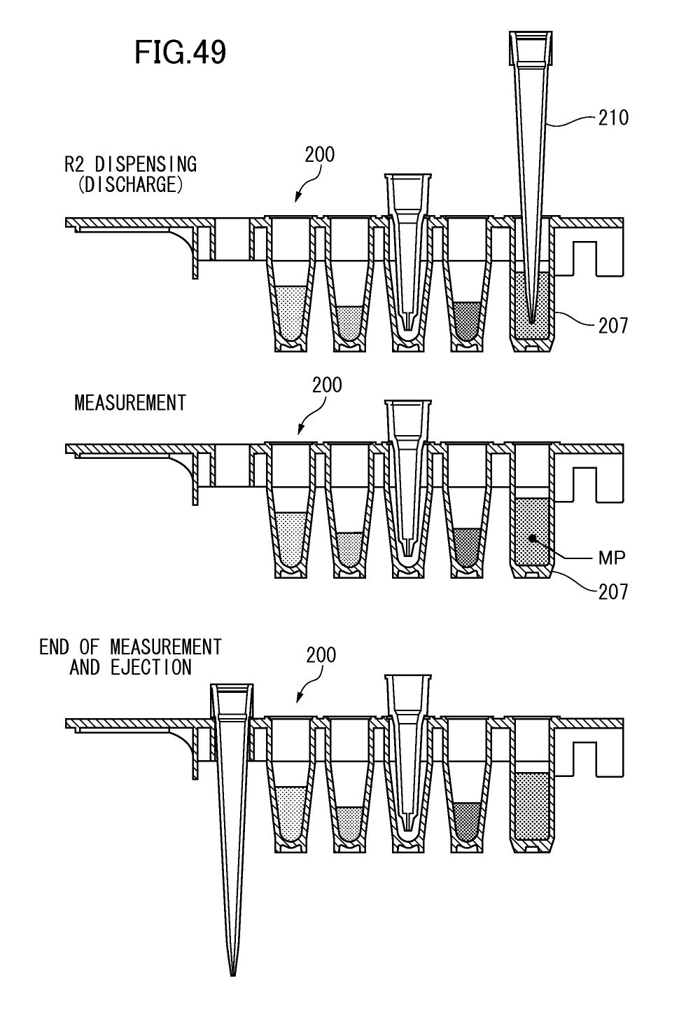

FIG. 44 to FIG. 49 are views for schematically illustrating a processed state of the test cartridge 200 in the above-mentioned series of measurement sequence.

Now, modified embodiments of the automatic analysis device according to this embodiment are described.

### Modified Embodiment 1

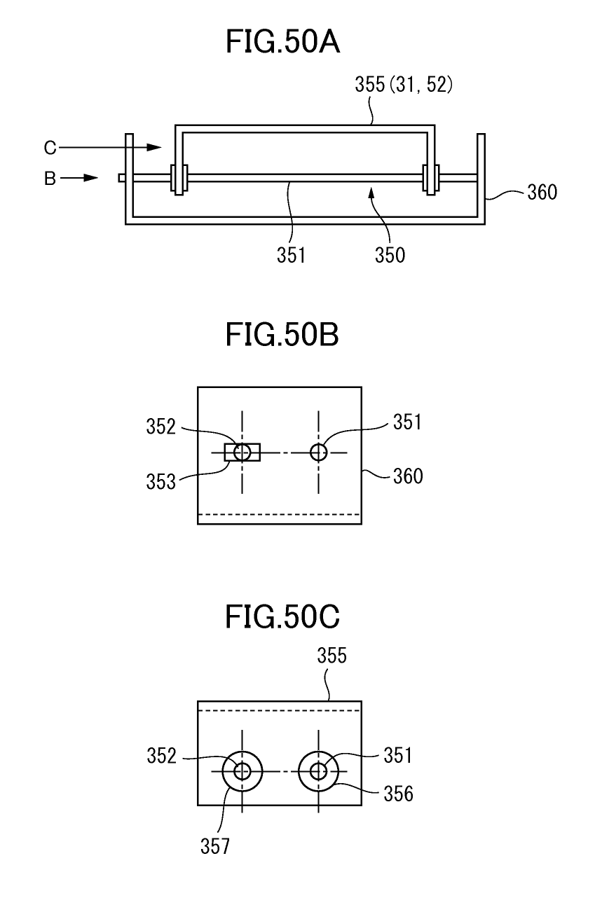

FIG. 50A to FIG. 50C are views for illustrating a guide mechanism of the X-table 31 or the Y-table 52 of the cartridge holding mechanism 30 serving as the X unit or the cartridge conveyance mechanism 50 serving as the Y unit.

In FIG. 50A to FIG. 50C, as a guide mechanism 350, there is given the following configuration. A main shaft 351 and a sub shaft 352 serving as a pair of guide shafts are bridged over a support base 360 having a channel shape in cross section so as to be substantially in parallel to each other. The main shaft 351 is bridged over the support base 360 in a state of being positioned, and the sub shaft 352 is bridged over the support base 360 so as to be movable along a long hole 353 capable of adjusting the pitch between the sub shaft 352 and the main shaft 351. A movable table 355 such as the X-table 31 or the Y-table 52 is slidably supported by the main shaft 351 and the sub shaft 352 through intermediation of molded bearings 356 and 357.

In this example, the positional relationship between the main shaft 351 and the sub shaft 352 serving as the guide shafts having a paired configuration of the guide mechanism 350 is displaced in accordance with the movement of the movable table 355, and hence the movable table 355 moves stably along the main shaft 351 and the sub shaft 352 serving as the guide shafts having a paired configuration.

In this case, in an aspect in which the main shaft 351 and the sub shaft 352 are arranged with respect to the support base 360 in a fixed manner, unless the pitch dimension is uniform between the main shaft 351 and the sub shaft 352, the movable table 355 is not operated smoothly. However, when the configuration in this example is adopted, the movable table 355 is guided smoothly.

### Modified Embodiment 2

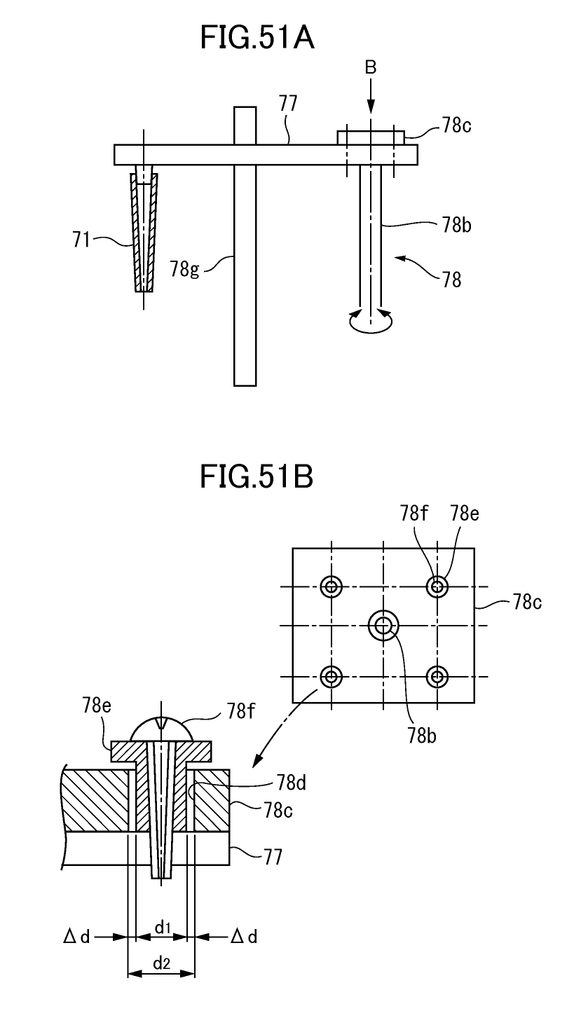

FIG. 51A and FIG. 51B are views for schematically illustrating the drive transmission mechanism of the specimen and reagent dispensing mechanism 70 serving as the Z unit.

In FIG. 51A and FIG. 51B, the nozzle head 71 is fixed to the lifting platform 77, and the lifting platform 77 is arranged so as to be bridged over a linear guide 78g that is an element of the drive transmission mechanism 78 and a ball screw 78b that transmits a drive. When the pitch between the linear guide 78g and the ball screw 78b is not uniform, the lifting platform 77 cannot move smoothly.

In this example, a screw bearing 78c is mounted on the lifting platform 77 in a fixed manner, and one end of the ball screw 78b is engaged with the screw bearing 78c.

In particular, as illustrated in FIG. 51B, the screw bearing 78c has a mounting structure in which a screw 78f serving as a stopper is inserted into a mounting hole 78d of the screw bearing 78c through intermediation of a collar 78e, and one end portion of the ball screw 78b has a play (2Δd=d2−d1) with respect to a bearing portion of the screw bearing 78c.

In this example, the pitch between the ball screw 78b and the linear guide 78g is not uniquely set and follows the movement of the lifting platform 77. Therefore, the upward or downward movement of the lifting platform 77, and further the nozzle head 71 becomes stable.

### Modified Embodiment 3

In the embodiment, the automatic analysis device is disclosed in which one X unit 30 and one YZ unit 260 are mounted on the bottom plate unit 250.

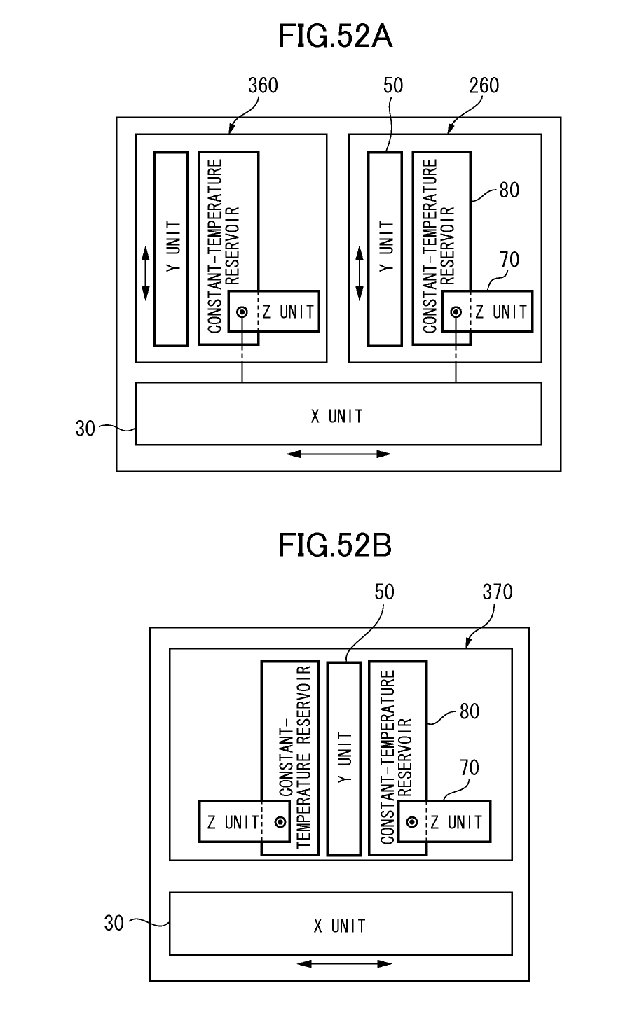

In FIG. 52A, one existing X unit 30 and a plurality of (two in this example) YZ units 260 and 360 are arranged. One of the plurality of the YZ units 260 and 360 is an existing YZ unit and the other is a new YZ unit.

For example, in order to increase test items of the automatic analysis device, it is sufficient that the new YZ unit 360 be added to the existing X unit 30 and the existing YZ unit 260.

This configuration is preferred in that additional designing can be performed easily based on the existing configuration.

Further, in FIG. 52B, one existing X unit 30 and a new YZ unit 370 are arranged.

However, the new YZ unit 370 is obtained merely by including the existing YZ unit 260 and adding an aspect in which a part is excluded from the existing YZ unit 260.

Therefore, even in this embodiment, the new YZ unit 370 can be implemented easily by using a plurality of the existing YZ units 260.

### Modified Embodiment 4

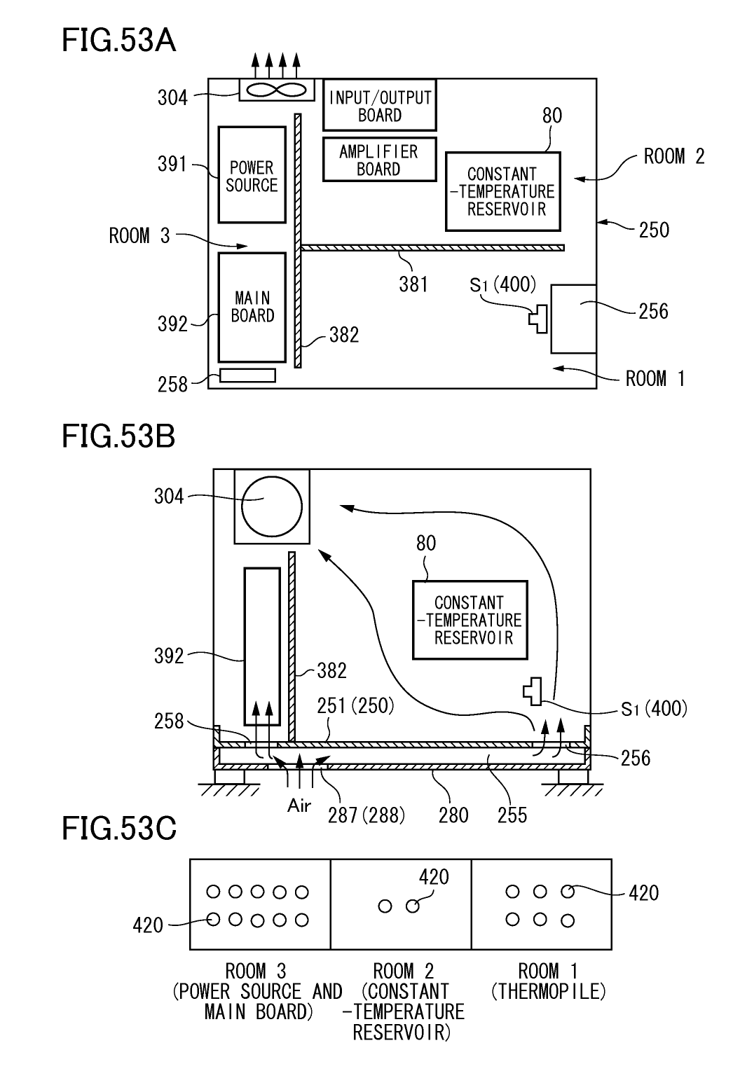

FIG. 53A and FIG. 53B are diagrams for illustrating modified air path design in the device housing of the automatic analysis device according to the embodiment.

In FIG. 53A and FIG. 53B, the device housing 21 includes, on the bottom plate unit 250, a first partition plate 381 that extends in the X-direction so as to partition the set stage ST and the test stage KT, and a second partition plate 382 that is held in abutment against the first partition plate 381 and extends in the Y-direction so as to partition a space portion in which a power source 391 and a main board (control board, etc.) 392 are incorporated. Thus, the device housing 21 is partitioned into a room 1 including the temperature detector S1 (corresponding to the thermopile 400) of the set stage ST, a room 2 including the constant-temperature reservoir 80 of the test stage KT, and a room 3 including the power source and the main board.

In this example, in a portion close to the left in an area on the front side of the bottom wall portion 281 of the undercover 280 of the bottom plate unit 250, the air intake hole 287 having the cleaning filter 288 is formed. In a portion close to the right on an opposite side of the air intake hole 287 on the set stage ST side of the bottom plate base member 251 of the bottom plate unit 250, the air introducing hole 256 is formed. In the vicinity of the air intake hole 287, an air introducing hole 258 smaller than the air introducing hole 256 is formed, and further the fan 304 is mounted in an upper portion close to the left of the back plate 274.

Thus, according to this embodiment, when the fan 304 is operated, external air is taken into the air supply chamber 255 from the air intake hole 287 through the cleaning filter 288 in the bottom plate unit 250, as illustrated in FIG. 53A and FIG. 53B, and the external air taken into the air supply chamber 255 is guided into the device housing 21 through the air introducing holes 256 and 258 of the bottom plate base member 255.

In this state, the air introduced from the air introducing hole 256 passes through the periphery of the temperature detector S1 (corresponding to the thermopile 400) of the set stage ST, and thereafter is attracted to the fan 304 together with warm air moving upward in the room 1.

On the other hand, the air introduced from the air introducing hole 258 is attracted to the fan 304 together with warm air moving upward in the room 3.

In this example, in the room 2 having the constant-temperature reservoir 80 installed thereon, an air introducing hole is not positively formed in the bottom plate base member 251. Therefore, the air from the air supply chamber 255 is less introduced into the room 2, and thus warm air in the room 2 is gradually pulled in by the fan 304.

Therefore, in this example, the air from the air supply chamber 255 is introduced into the rooms 1 and 3, and warm air in the rooms 1 and 3 is attracted to the fan 304 on an air stream. Thus, the internal environmental temperature of the rooms 1 and 3 is kept at a temperature relatively close to that of external air.

Note that, although a predetermined air stream is formed by forming the air introducing holes 256 and 258 in the bottom plate base member 251 in this example, the present invention is not limited thereto, and for example, as illustrated in FIG. 53C, the number and area of passage holes 420 for introducing air into the bottom plate base member 251 corresponding to each of the rooms 1 to 3 may be adjusted in consideration of the heat generation amount and the required temperature characteristics of each of the rooms 1 to 3. In this case, the number of the passage holes 420 is set to be large in the order of the room 3, the room 1, and the room 2.

### Modified Embodiment 5

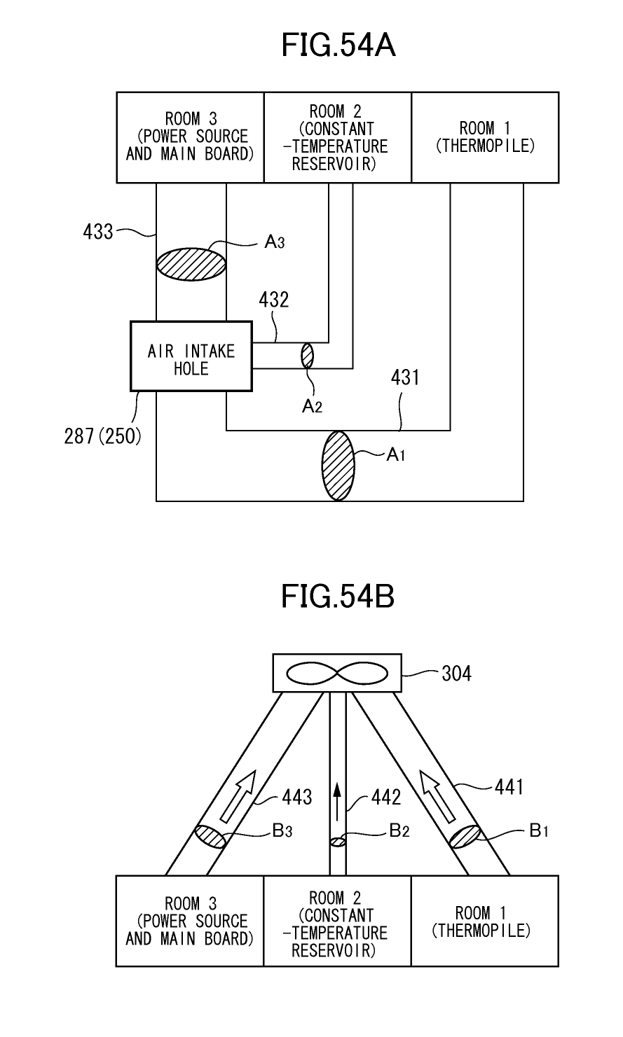

FIG. 54A and FIG. 54B are diagrams for illustrating modified air path designs in the device housing of the automatic analysis device according to the embodiment.

In FIG. 54A, for example, the device housing 21 is partitioned into three rooms (room 1 to room 3), and sectional areas A1 to A3 of air paths 431 to 433 extending from the air intake hole 287 of the bottom plate unit 250 to each of the rooms 1 to 3 are variably set in consideration of the heat generation amount and the required temperature characteristics of each of the rooms 1 to 3.

Further, in FIG. 54B, for example, the device housing 21 is partitioned into three rooms (room 1 to room 3), and sectional areas B1 to B3 of air paths 441 to 443 connecting each of the rooms 1 to 3 to the fan 304 are variably set in consideration of the heat generation amount and the required temperature characteristics of each of the rooms 1 to 3.

According to the above-mentioned designs, the intensity of an air stream from each of the rooms 1 to 3 can be directly adjusted in accordance with the heat generation amount and the required temperature characteristics of each of the rooms 1 to 3.

### Modified Embodiment 6

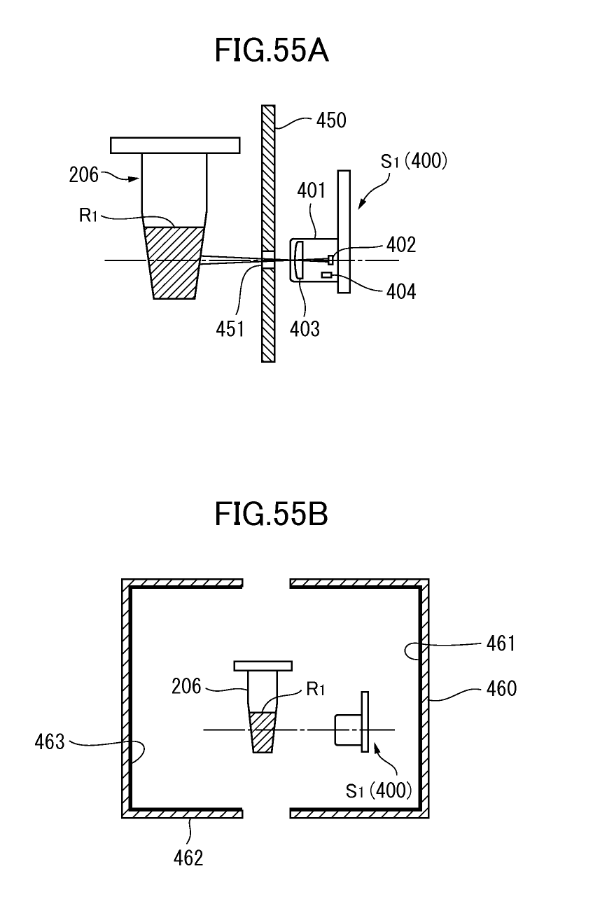

FIG. 55A is a view for illustrating a modified installation structure of the liquid temperature detector S1 (thermopile 400) to be used for detecting a liquid temperature of the test cartridge 200.

In FIG. 55A, the liquid temperature detector S1 detects a liquid temperature of the reagent cell 206 of the test cartridge 200 and targets only a heat ray radiated from the reagent R1 in the reagent cell 206. Therefore, a light-shielding plate 450, in which both surfaces are coated in black, is arranged between the reagent cell 206 and the liquid temperature detector S1, and a through hole 451 is formed in the light-shielding plate 450.

In this example, there is a risk in that a heat ray Bm1 other than the heat ray from the reagent R1 in the reagent cell 206 of the test cartridge 200 may directly enter the thermopile 400 or in that a heat ray Bm2 reflected from the sensor housing 401 of the thermopile 400 may impinge on the reagent R1 in the reagent cell 206 and the thermopile element 402 may measure the heat ray Bm2.

This aspect is preferred in that the heat rays Bm1 and Bm2 other than the heat ray from the reagent R1 are less liable to enter the thermopile element 402.

Further, as another aspect, as illustrated in FIG. 55B, the periphery of an inner wall of a chamber 460 in which the thermopile 400 is installed may be formed as a black coated portion 461. In this case, the unnecessary heat rays Bm1 and Bm2 are absorbed by the black coated portion 461, and thus the unnecessary heat rays are less liable to be directed to the thermopile 400.

Note that, a black coated portion 463 may be formed on the periphery of a chamber 462 surrounding the test cartridge 200.

### Modified Embodiment 7

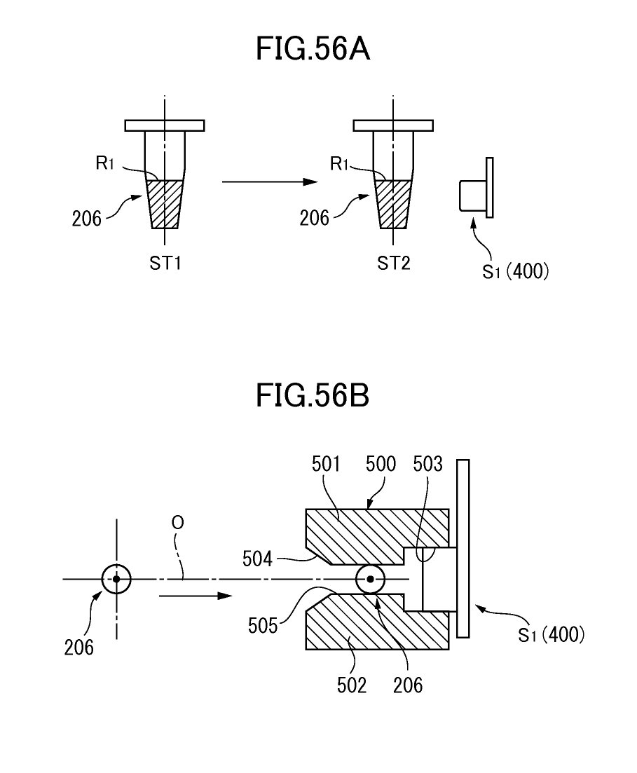

FIG. 56A is a view for illustrating an aspect in which the test cartridge 200 moves between the test initial position ST1 and the liquid temperature detection position ST2.

In this example, between the liquid temperature detector S1 (thermopile 400) and the reagent cell 206 (having a shape of an inverse circular truncated cone in this example) of the test cartridge 200, there is arranged a guide mechanism 500 for guiding the test cartridge 200 along center positions of the liquid temperature detector S1 (thermopile 400) and the reagent cell 206 of the test cartridge 200.

In the guide mechanism 500, guide members 501 and 502 having a paired configuration are arranged symmetrically with respect to a center axis line O, and a positioning recessed portion 503 for positioning the sensor housing 401 is formed on the liquid temperature detector S1 side of the guide members 501 and 502. On the other hand, an inclined guide surface 504 inclined in a direction of being gradually narrowed from an inlet is formed on the reagent cell 206 side of the guide members 501 and 502, and in a region adjacent to the inclined guide surface 504, there is formed a positioning groove 505 for positioning the reagent cell 206 in a state of being centered.

In this example, when the test cartridge 200 moves to the liquid temperature detection position ST2, the reagent cell 206 of the test cartridge 200 is guided to the positioning groove 505 through the inclined guide surface 504 of the guide mechanism 500 and positioned in a state of being centered.

In this case, the positional relationship between the reagent cell 206 and the liquid temperature detector S1 is uniquely determined, and hence the liquid temperature detection accuracy of the liquid temperature detector S1 is kept satisfactory.

### Modified Embodiment 8

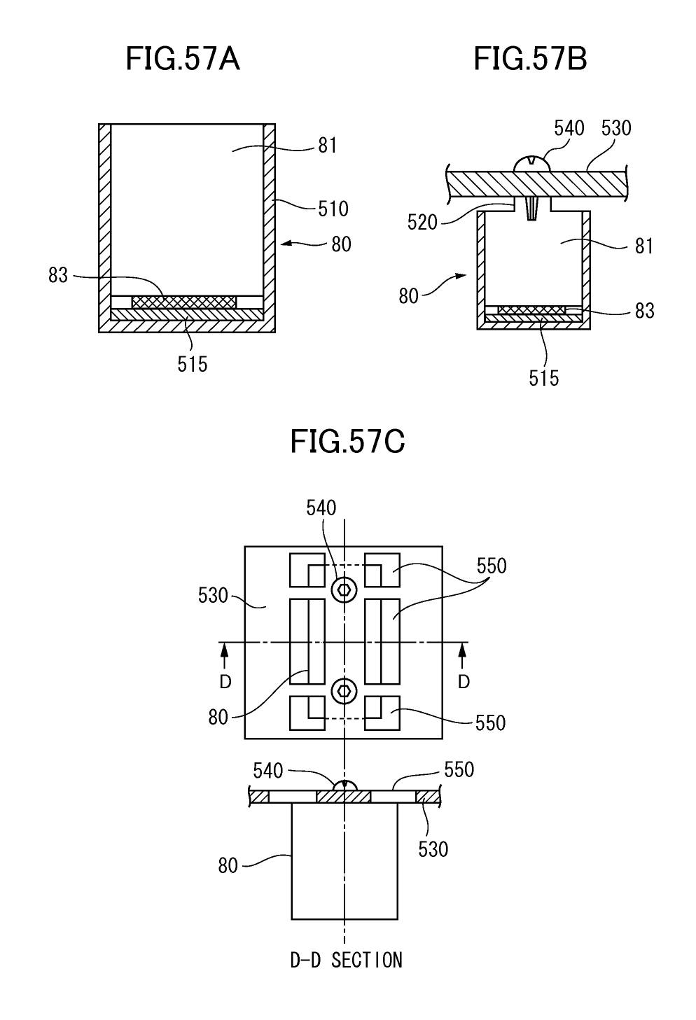

FIG. 57A is a view for illustrating an exemplary aspect of the constant-temperature reservoir 80.

In FIG. 57A, the constant-temperature reservoir 80 includes a heat insulating cover 510 surrounding a bottom portion and a peripheral wall of the constant-temperature block 81. The heater 83 is arranged on a bottom surface of the constant-temperature block 81, and a heat-resistant heat insulating material 515 having a heat insulating effect higher than that of the heat insulating cover 510 is interposed between the heater 83 and the bottom portion of the heat insulating cover 510.

In this aspect, there is a low risk in that the heat from the heater 83 may be radiated to the heat insulating cover 510 side, and the heat from the heater 83 is transmitted effectively to the constant-temperature block 81.

Further, FIG. 57B and FIG. 57C are views for illustrating an exemplary aspect of a mounting structure of the constant-temperature reservoir 80.

In FIG. 57B, the constant-temperature reservoir 80 includes the constant-temperature block 81, and a mounting portion 520 having a small contact surface is formed in a top portion of the constant-temperature block 81. The mounting portion 520 is fixed in contact with a member 530 to be mounted with a stopper 540.

Further, in FIG. 57C, a top portion of the constant-temperature reservoir 80 is fixed to the member 530 to be mounted with the stopper 540, and in an area other than a fixed portion of the member 530 to be mounted with the stopper 540, an appropriate number of cut-out openings 550 are formed.

Therefore, in this aspect, the contact area between the constant-temperature reservoir 80 and the member 530 to be mounted is reduced by an amount corresponding to the cut-out openings 550, and thus the loss of heat that is thermally conducted from the constant-temperature reservoir 80 to the member 530 to be mounted is suppressed.

### Modified Embodiment 9

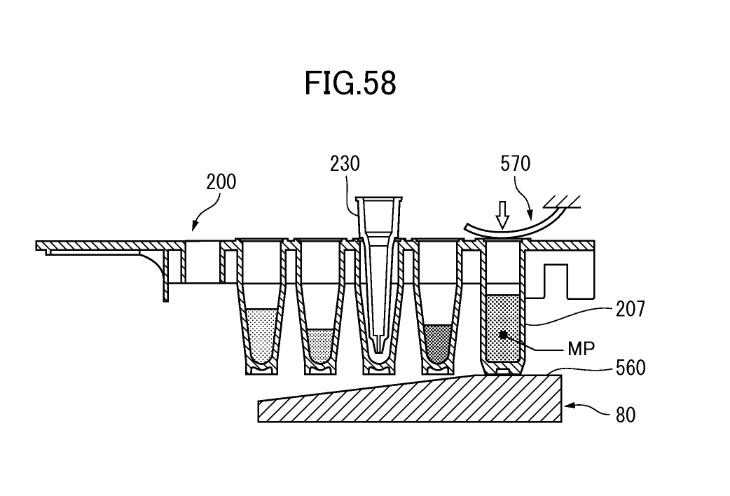

FIG. 58 is a view for illustrating a preferred structure around the test cartridge at the measurement position of the constant-temperature reservoir.

In FIG. 58, the constant-temperature reservoir 80 includes a contact portion 560 with which a bottom portion of the reaction cell 207 of the test cartridge 200 is brought into contact when the reaction cell 207 is conveyed to the measurement position MP.

This configuration is preferred in that the heat from the constant-temperature reservoir 80 is transmitted to the reaction cell 207 through the contact portion 560 at the measurement position MP, and hence the reaction cell 207 is easily adjusted to a constant environmental temperature.

Further, in this example, when the reaction cell 207 of the test cartridge 200 is conveyed to the measurement position MP, the reaction cell 207 is biased toward the contact portion 560 due to a biasing member 570 such as a plate spring arranged in the constant-temperature reservoir 80. With this, the reaction cell 207 is pressed against the contact portion 560.

Therefore, in this example, the contact state between the reaction cell 207 and the contact portion 560 is kept satisfactory, and the heat transmission from the constant-temperature reservoir 80 to the reaction cell 207 is kept satisfactory.

In particular, in this example, the reaction cell 207 is pressed against the contact portion 560 with the biasing member 570. Therefore, the relative positional relationship of the reaction cell 207 with respect to the measurement device 100 becomes uniform, and with this, the measurement accuracy of the measurement device 100 is kept satisfactory.

### EXAMPLES

### Example 1

In this example, the automatic analysis device according to the first embodiment was embodied in such a manner that the test cartridge 200 was pulled into the test stage KT, and then, a period of time taken for the reagent cell 206 to reach a constant condition temperature (37° C. in this example) using the constant-temperature reservoir 80 was measured.

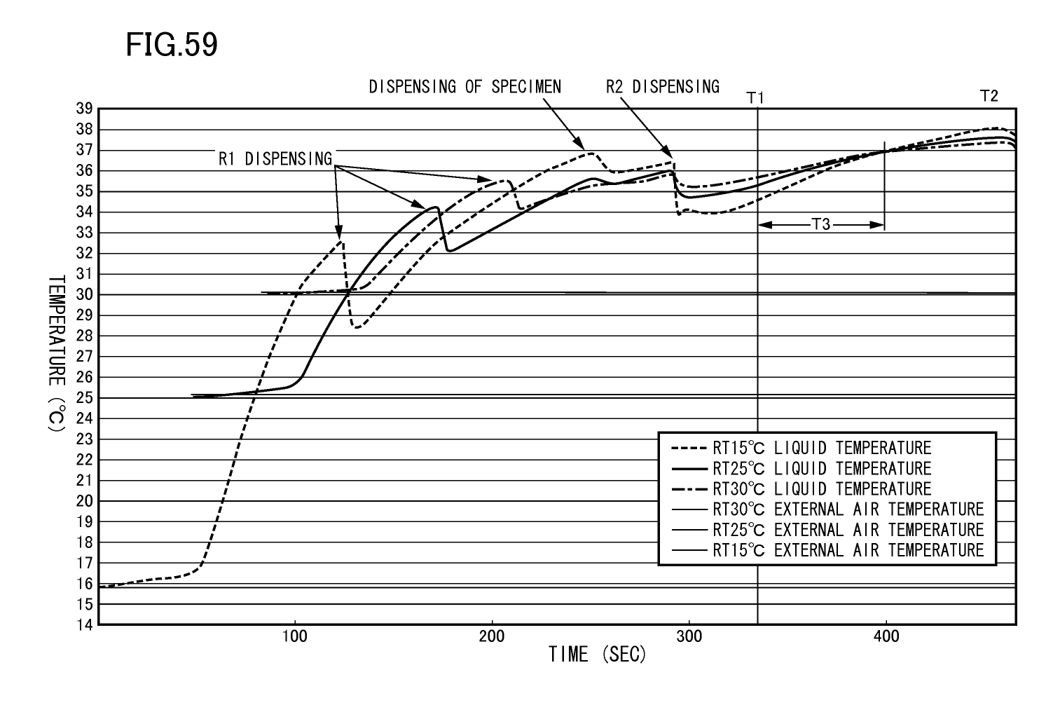

In this example, the heating temperature of the constant-temperature reservoir 80 and the preliminary warming time of the constant-temperature reservoir 80 were variably set in the case of RT15° C., RT25° C., and RT30° C. as an internal environmental temperature, and a series of measurement sequence was performed. The results are shown in FIG. 59.

It is understood from FIG. 59 that, even when the internal environmental temperature varies, the condition of the constant environmental temperature of the reaction cell is substantially the same at the reaction measurement during a period of time from a previously-determined time T1 to a previously-determined time T2 by accurately controlling the heating temperature and the preliminary warming time of the constant-temperature reservoir.

In particular, in this example, for example, at a time having elapsed by a time T3 from the time T1 (about 70 seconds in this example) in the reaction measurement during a period of time from the time T1 to the time T2 (2 minutes in this example), it was confirmed that all the constant environmental temperatures became close to the same temperature.

### Comparative Examples 1 and 2

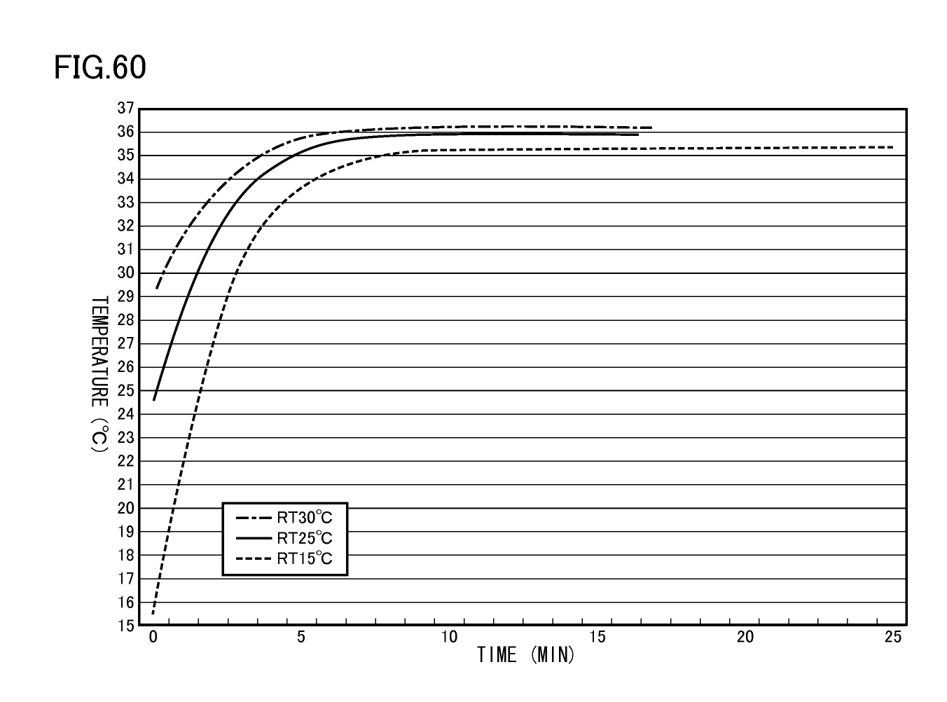

In Comparative Example 1, an automatic analysis device substantially similar to the automatic analysis device according to Example 1 was used. The heating control of a constant-temperature reservoir was set to predetermined temperature control, and 230 μL of water was poured into a reaction cell of a test cartridge. Then, the liquid temperature was measured until the liquid temperature was saturated. The results are shown in FIG. 60.

It is understood from FIG. 60 that the liquid temperature of the reaction cell reaches a substantially constant temperature, but the liquid temperature varies depending on the difference in internal environmental temperature.

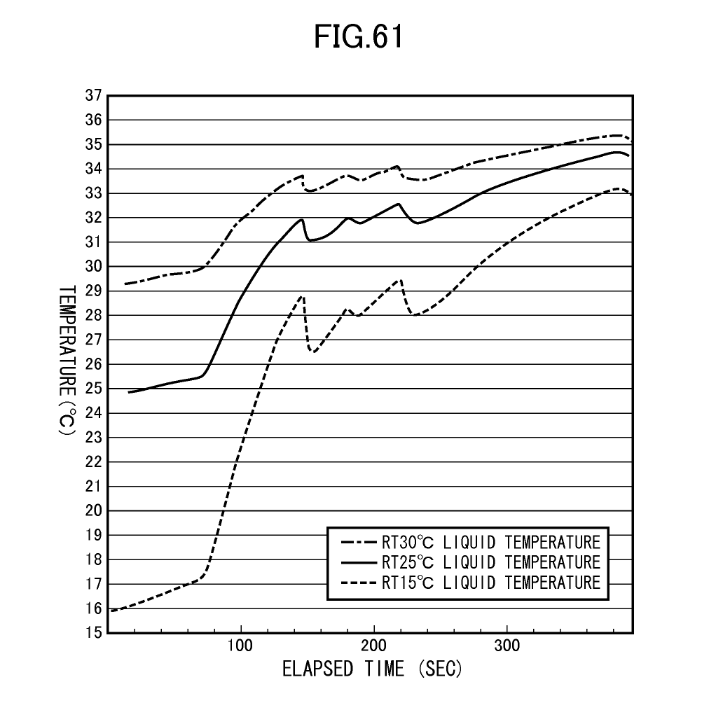

Further, as Comparative Example 2, the heating temperature of the constant-temperature reservoir was controlled based on the difference in internal environmental temperature. 200 μL of water was poured into a specimen cell, a reagent cell (R1), and a reagent cell (R2) of the test cartridge, and the liquid temperature of the reaction cell was measured through a dispensing operation. The results are shown in FIG. 61.

It is understood from FIG. 61 that a difference in liquid temperature is significant depending on the internal environmental temperature, and an accurate reaction cannot be obtained.

### Example 2

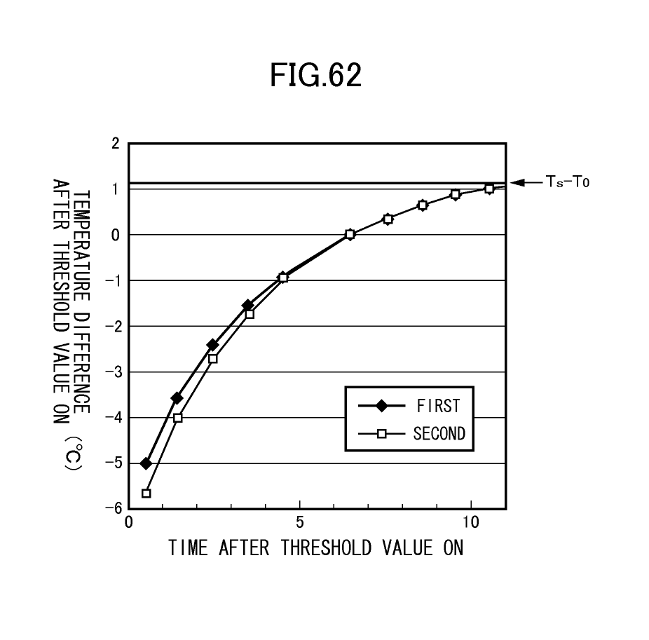

In this example, in checking of a liquid temperature of the test cartridge, a change in temperature difference was checked twice after a difference between the liquid temperature of the reagent cell and the internal environmental temperature fell within a previously-determined threshold value (threshold value=−5° C. in this example) (threshold value: ON). The results are shown in FIG. 62.

It is understood from FIG. 62 that, in checking of a liquid temperature of the test cartridge, a change in temperature difference after the temperature difference falls within the threshold value (threshold value: ON) reaches about 0 in about 6 minutes.

Note that, in FIG. 62, Ts−T0 denotes that a difference between the temperature in the vicinity of the thermopile and the internal environmental temperature (external air temperature) is about 1° C.

What is claimed is:

1. An automatic analysis device for automatically analyzing a reaction between a specimen and a reagent,
the automatic analysis device comprising:
at least one test cartridge including at least a specimen cell for accommodating the specimen, a reagent cell for accommodating the reagent, and a reaction cell for allowing the specimen and the reagent to react with each other, the specimen cell, the reagent cell, and the reaction cell being arranged linearly;
a device housing including a space portion for a set stage, which is previously determined, and a test stage adjacent to the set stage;
cartridge holding means arranged on the set stage and including a cartridge receiving portion for holding the at least one test cartridge;
cartridge conveyance means arranged on the test stage, for linearly conveying a test cartridge held by the cartridge holding means to the test stage and conveying the test cartridge in a longitudinal direction along an arrangement direction of respective cells of the conveyed test cartridge in the test stage, and meanwhile, linearly conveying the tested test cartridge from the test stage to the set stage, thereby returning the tested test cartridge to the cartridge receiving portion of the cartridge holding means;
specimen and reagent dispensing means arranged so as to correspond to a dispensing position set previously in a part of a conveyance path of the test cartridge in the test stage, for dispensing, with respect to the test cartridge in the test stage conveyed by the cartridge conveyance means, the specimen and the reagent in the test cartridge to the reaction cell in a state in which a dispensing target cell of the test cartridge is conveyed to be arranged at the dispensing position;
measurement means arranged so as to correspond to a measurement position set previously in a part of the conveyance path of the test cartridge in the test stage, for measuring the reaction between the specimen and the reagent in the reaction cell dispensed by the specimen and reagent dispensing means in a state in which the reaction cell of the test cartridge in the test stage conveyed by the cartridge conveyance means is conveyed to be arranged at the measurement position;
a constant-temperature reservoir to be heated by a heating source so as to keep a liquid temperature at least in the reaction cell of the test cartridge in the test stage conveyed by the cartridge conveyance means at a constant environmental temperature set previously; and
constant-temperature reservoir control means including a temperature detector capable of detecting an internal environmental temperature of the test stage, for controlling a set temperature of the heating source of the constant-temperature reservoir so that the set temperature of the heating source is higher when the internal environmental temperature is lower than a previously-determined threshold value than when the internal environmental temperature is equal to or higher than the previously-determined threshold value, based on the internal environmental temperature detected by the temperature detector.

2. An automatic analysis device according to claim 1,
wherein the constant-temperature reservoir control means further variably sets a heating time of the heating source so that the liquid temperature in the reaction cell of the test cartridge at a time of start of measurement by the measurement means is a previously-determined temperature, based on the internal environmental temperature detected by the temperature detector.

3. An automatic analysis device according to claim 1,
wherein the constant-temperature reservoir comprises:
a constant-temperature reservoir main body;
a heat insulating cover formed of a heat insulating material covering a periphery of the constant-temperature reservoir main body;
the heating source arranged between the constant-temperature reservoir main body and the heat insulating cover and arranged in contact with the constant-temperature reservoir main body; and
a heat-resistant heat insulating material interposed between the heating source and the heat insulating cover and having a heat insulating effect higher than a heat insulating effect of the heat insulating cover.

4. An automatic analysis device according to claim 1,
wherein the constant-temperature reservoir is installed in a state in which a contact surface between a constant-temperature reservoir main body and a member to be mounted is smaller than a projection plane of the constant-temperature reservoir main body onto the member to be mounted.

5. An automatic analysis device according to claim 1,
wherein the constant-temperature reservoir includes a reservoir temperature detector capable of detecting a temperature in the constant-temperature reservoir, and
wherein the reservoir temperature detector is arranged between the reaction cell of the test cartridge and the heating source of the constant-temperature reservoir.

6. An automatic analysis device according to claim 1,
wherein the constant-temperature reservoir includes a contact portion that is brought into contact with a bottom surface of the reaction cell of the test cartridge at least at the measurement position.

7. An automatic analysis device according to claim 1,
further comprising a biasing member for biasing a bottom surface of the reaction cell of the test cartridge so as to press the bottom surface against the constant-temperature reservoir at the measurement position of the constant-temperature reservoir.

8. An automatic analysis device according to claim 1,
further comprising:
a liquid temperature detector arranged on the set stage, the liquid temperature detector being capable of detecting a liquid temperature of one of the reagent and a diluent for the specimen accommodated in the cell of the test cartridge held by the cartridge holding means;
an environmental temperature detector arranged on the set stage, the environmental temperature detector being capable of detecting an internal environmental temperature in the set stage; and
drive control means for inhibiting, when a detected temperature of the liquid temperature detector is lower than a detected temperature from the environmental temperature detector, a conveyance operation of the test cartridge to the test stage by the cartridge conveyance means until, based on a difference between the detected temperature of the liquid temperature detector and the detected temperature from the environmental temperature detector, the difference between the detected temperatures becomes a previously-determined threshold value or less.

9. An automatic analysis device according to claim 8,
wherein the liquid temperature detector comprises a thermopile element.

10. An automatic analysis device according to claim 9,
wherein the drive control means is used so as to correct the liquid temperature detected by the liquid temperature detector in accordance with the environmental temperature detected by the environmental temperature detector.

11. An automatic analysis device according to claim 9,
wherein the drive control means indirectly corrects the liquid temperature detected by the liquid temperature detector by variably setting the previously-determined threshold value in accordance with the environmental temperature detected by the environmental temperature detector.

12. An automatic analysis device according to claim 9,
wherein the liquid temperature detector is installed at a standby position at which an ambient temperature changes less in the set stage, and
wherein the liquid temperature detector is moved by a moving mechanism capable of moving to a detection position close to the cells of the test cartridge when the test cartridge is held by the cartridge holding means.

13. An automatic analysis device according to claim 9,
wherein the device housing has a configuration capable of introducing external air to a periphery of the liquid temperature detector.

14. An automatic analysis device according to claim 8,
wherein the cartridge holding means includes the cartridge receiving portion capable of holding the at least one test cartridge,
wherein the cartridge holding means moves the cartridge receiving portion in a direction crossing the arrangement direction of the respective cells of the test cartridge, thereby transferring the test cartridge to a previously-determined test initial position in the set stage and transferring the test cartridge, which is to be first subjected to the test of the at least one test cartridge, to a previously-determined liquid temperature detection position in the set stage, and
wherein the automatic analysis device further comprises a guide member capable of guiding the test cartridge so as to keep a positional relationship between the liquid temperature detector and the test cartridge when the test cartridge is transferred to the liquid temperature detection position.

15. An automatic analysis device according to claim 8,
wherein, when the detected temperature of the liquid temperature detector is lower than the detected temperature from the environmental temperature detector, under a condition that, based on the difference between the detected temperatures, the difference between the detected temperatures becomes the previously-determined threshold value or less, the drive control means performs the conveyance operation of the test cartridge to the test stage by the cartridge conveyance means after a previously-determined time period has elapsed.

16. An automatic analysis device according to claim 1,
wherein the device housing includes a base member extending from the set stage to the test stage,
wherein the cartridge holding means is incorporated as a first unit assembly onto the base member of the set stage, and
wherein the cartridge conveyance means, the specimen and reagent dispensing means, and the constant-temperature reservoir are mounted on a common unit base member and incorporated as a second unit assembly onto the base member of the test stage.

17. An automatic analysis device according to claim 16,
further comprising a fan capable of forcibly exhausting air in the set stage and the test stage of the device housing,
the device housing comprising:
a hollow portion formed in a lower portion of the base member;
an air intake port formed in a part of the hollow portion; and
a through hole formed in the base member,
the fan being arranged in an upper corner portion on a back surface side of the device housing,
the through hole being arranged at a diagonal position of the device housing with respect to the fan.

18. An automatic analysis device according to claim 16,
further comprising a fan capable of forcibly exhausting air in the set stage and the test stage of the device housing,
the device housing comprising:
a hollow portion formed in a lower portion of the base member;
an air intake port formed in a part of the hollow portion; and
a through hole formed in the base member in which, in accordance with a heat generation amount from a device element in the set stage and the test stage, an opening area is larger in a portion having a large heat generation amount than in a portion having a small heat generation amount.

19. An automatic analysis device according to claim 16,
further comprising a fan capable of forcibly exhausting air in the set stage and the test stage of the device housing,
the device housing comprising:
a hollow portion formed in a lower portion of the base member;
an air intake port formed in a part of the hollow portion; and
a through hole formed in the base member,
at least one of the air intake port or the through hole having a dust removing filter.

20. An automatic analysis device according to claim 16,
further comprising a fan capable of forcibly exhausting air in the set stage and the test stage of the device housing,
the device housing comprising:
a hollow portion formed in a lower portion of the base member;
an air intake port formed in a part of the hollow portion;
a through hole formed in the base member; and
a partition member for partitioning an interior space portion in accordance with a heat generation amount from a device element in the set stage and the test stage.
